(19) United States
(12) Patent Application Publication
(10) Pub. No.: US 2026/0132332 A1
(43) Pub. Date: May 14, 2026

(54) QUANTUM DOT, OPTICAL MEMBER AND ELECTRONIC APPARATUS INCLUDING THE QUANTUM DOT, AND METHOD FOR PREPARING QUANTUM DOT

(71) Applicant: Samsung Display Co., Ltd., Yongin-si (KR)

(72) Inventors: Juo Nam, Yongin-si (KR); Sungjae Kim, Yongin-si (KR); Youngsik Kim, Yongin-si (KR); Hongrae Kim, Yongin-si (KR); Seungwon Park, Yongin-si (KR); Bitna Yoon, Yongin-si (KR); Taekjoon Lee, Yongin-si (KR); Junehyuk Jung, Yongin-si (KR)

(21) Appl. No.: 19/379,991

(22) Filed: Nov. 5, 2025

(30) Foreign Application Priority Data
Nov. 13, 2024 (KR) 10-2024-0160986
Nov. 3, 2025 (KR) 10-2025-0162912

(51) Int. Cl. C09K 11/62; B82Y 20/00; B82Y 40/00; C01G 15/00; F21V 9/30

(52) U.S. Cl. CPC C09K 11/623; C01G 15/006; F21V 9/30; B82Y 20/00; B82Y 40/00; C01P 2004/64; C01P 2006/60

(57) ABSTRACT

A quantum dot, an optical member including the quantum dot, an electronic apparatus including the quantum dot, and a method of preparing the quantum dot are provided. The quantum dot includes a core including copper (Cu), A¹, and B¹, and a first shell covering the core and including A³ and B², wherein an atomic ratio of silicon (Si) to B¹ included in the core is about 0.001 to about 0.05, A¹ is a Group III element, A³ is a Group II element or Group III element, and B¹ and B² are each independently a Group VI element.

### CROSS-REFERENCE TO RELATED APPLICATIONS

The present application claims priority to and the benefit of Korean Patent Application No. 10-2024-0160986, filed on Nov. 13, 2024, and Korean Patent Application No. 10-2025-0162912, filed on Nov. 3, 2025, in the Korean Intellectual Property Office, the entire disclosure of each of which is incorporated herein by reference.

### BACKGROUND

### 1. Field

One or more embodiments of the present disclosure relate to a quantum dot, an optical member including the quantum dot, an electronic apparatus including the quantum dot, and a method of preparing the quantum dot.

### 2. Description of the Related Art

Quantum dots may be used as a material that performs one or more suitable optical functions (for example, light conversion, light emission, and/or the like) in optical members and one or more suitable electronic apparatuses. The quantum dot is a nano-sized semiconductor nanocrystal that exhibits a quantum confinement effect, and thus by controlling the size, composition, and/or the like of the nanocrystal, the energy band gap of the quantum dot may be suitably adjusted; as a result, the quantum dot may be to emit light with one or more suitable emission wavelengths.

An optical member including such a quantum dot may take the form of a thin film, for example, a thin film patterned for each sub-pixel of the display panel of an electronic apparatus/device. Such an optical member may also be used as a color conversion member in an apparatus including one or more suitable light sources.

Additionally, the quantum dot may be used for one or more suitable purposes in one or more suitable electronic apparatuses. For example, the quantum dot may also be used as an emitter. For instant, the quantum dot may be included in an emission layer of a light-emitting element including a pair of electrodes and an emission layer and may serve as an emitter.

Currently, to realize high-quality optical members and electronic apparatuses, there is a demand and desire for the development of a quantum dot that has enhanced (e.g., excellent or high) photoluminescence quantum yield (PLQY) and does not include cadmium, which is a toxic element.

### SUMMARY

One or more aspects of embodiments of the present disclosure are directed toward a quantum dot, an optical member including the quantum dot, an electronic apparatus including the quantum dot, and a method of preparing the quantum dot.

Additional aspects will be set forth in part in the description which follows and, in part, will be apparent from the description, or may be learned by practice of the presented embodiments of the disclosure.

According to one or more embodiments of the present disclosure, a quantum dot includes:
a core including copper (Cu), A¹, and B¹, and
a first shell covering the core and including A³ and B²,
wherein an atomic ratio of silicon (Si) to B¹ included in the core is about 0.001 to about 0.05,
wherein A¹ is a Group III element,
wherein A³ is a Group II element or a Group III element, and
wherein B¹ and B² are each independently a Group VI element.

According to one or more embodiments of the present disclosure, provided is an optical member including the quantum dot.

According to one or more embodiments of the present disclosure, provided is an electronic apparatus including the quantum dot.

According to one or more embodiments of the present disclosure, provided is a method of preparing a quantum dot, the method including:
preparing a first-1 composition including a copper (Cu)-containing precursor and an A¹-containing precursor;
preparing a core including copper (Cu), A¹, and B¹ by utilizing a first-2 composition including the first-1 composition and a B¹-containing precursor; and
preparing a first shell covering the core and including A³ and B² by utilizing a second composition including the core, an A³-containing precursor, and a B²-containing precursor,
wherein an atomic ratio of Si to B¹ included in the core is about 0.001 to about 0.05, and
the preparing of the core including copper (Cu), A¹, and B¹ utilizing the first-2 composition,
further includes treating the first-2 composition with an inert gas,
wherein A¹ is a Group III element,
wherein A³ is a Group II element, and
wherein B¹ and B² are each independently a Group VI element.

### BRIEF DESCRIPTION OF DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the disclosure will be more apparent from the following description taken in conjunction with the accompanying drawings, in which:

FIG. 1 is a diagram schematically illustrating a cross-section of a quantum dot according to one or more embodiments of the present disclosure;

FIG. 2 is a diagram schematically illustrating a structure of an electronic apparatus according to one or more embodiments of the present disclosure;

FIG. 3 is a diagram schematically illustrating a structure of a light-emitting element according to one or more embodiments of the present disclosure;

FIG. 4 is a diagram schematically illustrating an electronic device including a quantum dot according to one or more embodiments of the present disclosure;

FIG. 5 is a diagram schematically illustrating an exterior of a vehicle as an electronic device including a quantum dot according to one or more embodiments of the present disclosure;

FIG. 6A-FIG. 6C are each a diagram schematically illustrating an interior of a vehicle according to one or more embodiments of the present disclosure; and

FIG. 7A and FIG. 7B are diagrams illustrating optical properties of a quantum dot core with respect to reaction time, according to Comparative Example 2, Comparative Example 3 and Comparative Example 4, and Example 1, Example 3, Example 4 and Example 5, of the present disclosure, respectively.

### DETAILED DESCRIPTION

Reference will now be made in more detail to one or more embodiments, examples of which are illustrated in the accompanying drawings, wherein like reference numerals refer to like elements throughout the disclosure, and duplicative descriptions thereof may not be provided for conciseness. In this regard, the presented embodiments may have different forms and should not be construed as being limited to the descriptions set forth herein. Accordingly, one or more embodiments are merely described in more detail, by referring to the drawings, to explain aspects of the present disclosure. As used herein, the term “and/or” or “or” may include any and all combinations of one or more of the associated listed items. Throughout the disclosure, the expressions such as “at least one of,” “one of,” and “selected from,” when preceding a list of elements, modify the entire list of elements and do not modify the individual elements of the list. For example, “at least one of a, b, or c”, “at least one selected from among a, b, and c”, “at least one selected from among a to c”, and/or the like, may indicate only a, only b, only c, both (e.g., simultaneously) a and b, both (e.g., simultaneously) a and c, both (e.g., simultaneously) b and c, all of a, b, and c, or variations thereof.

Because the disclosure may be modified in one or more suitable ways and may have many embodiments, specific example embodiments will be illustrated in the drawings and described in more detail in the detailed description. The effects and features of the disclosure, and methods of achieving them, will become clear with reference to one or more embodiments described in more detail together with the drawings. However, the disclosure is not limited to one or more embodiments described herein and may be implemented in one or more suitable forms.

In the present disclosure, the terms “first,” “second,” and/or the like may be utilized to describe one or more elements, components, regions, and/or layers, these elements, components, regions, and/or layers should not be limited by these terms. These terms are only utilized to distinguish one component from another component.

As used herein, singular expressions include plural expressions unless the context clearly indicates otherwise. For example, the singular forms “a,” “an,” “one,” and “the” are intended to include the plural forms as well, unless the context clearly indicates otherwise.

As used herein, the terms “comprise(s)/comprising,” “include(s)/including,” or “have/has/having,” and/or the like indicate the presence of features or components disclosed in the disclosure and do not preclude the possibility of adding one or more additional features or components. For example, the terms “comprise(s)/comprising,” “include(s)/including,” or “have/has/having,” and/or the like, unless otherwise defined, may refer to both (e.g., simultaneously) cases where a feature or a component disclosed in the disclose consists only of or consisting essentially of the listed features or components and cases where additional components may be included. For example, the terms “comprise(s)/comprising,” “include(s)/including,” “have/has/having”, or other similar terms include or support the terms “consisting of” and “consisting essentially of,” indicating the presence of stated features, numbers, steps, operations, elements, and/or components, without or essentially without the presence of other features, numbers, steps, operations, elements, components, and/or groups thereof. Further, the use of “may” when describing embodiments of the present disclosure refers to “one or more embodiments of the present disclosure”.

As used herein, “Group I” may include a Group IA element and a Group IB element on the IUPAC periodic table, and a Group I element may include, for example, silver (Ag), copper (Cu), and/or the like.

As used herein, “Group II” may include a Group IIA element and a Group IIB element on the IUPAC periodic table, and a Group II element may include, for example, magnesium (Mg), calcium (Ca), zinc (Zn), cadmium (Cd), mercury (Hg), and/or the like.

As used herein, “Group III” may include a Group IIIA element and a Group IIIB element on the IUPAC periodic table, and a Group III element may include, for example, aluminum (Al), gallium (Ga), indium (In), thallium (Tl), nihonium (Nh), and/or the like.

As used herein, “Group IV” may include a Group IVA element and a Group IVB element on the IUPAC periodic table, and a Group IV element may include, for example, silicon (Si), germanium (Ge), and/or the like.

As used herein, “Group V” may include a Group VA element and a Group VB element on the IUPAC periodic table, and a Group V element may include, for example, nitrogen (N), phosphorus (P), arsenic (As), antimony (Sb), and/or the like.

As used herein, “Group VI” may include a Group VIA element and a Group VIB element on the IUPAC periodic table, and a Group VI element may include, for example, oxygen (O), sulfur (S), selenium (Se), tellurium (Te), and/or the like.

As used herein, “quantum yield” and “luminescence efficiency” may be used with substantially the same meaning.

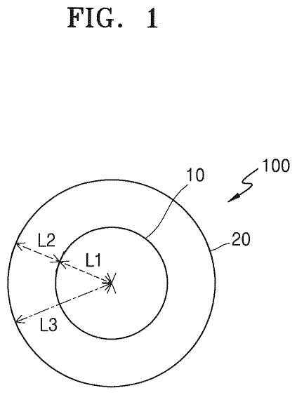

Hereinafter, with reference to FIG. 1, a quantum dot 100 according to one or more embodiments of the present disclosure and its preparation method will be described.

### Description of FIG. 1

FIG. 1 is a diagram schematically illustrating a cross-section of a quantum dot 100 according to one or more embodiments. The quantum dot 100 includes a core 10 and a first shell 20.

### Quantum Dot 100

The quantum dot 100 of FIG. 1 may include a core 10 including copper (Cu), A¹, and B¹; and
a first shell 20 covering the core and including A³ and B²
wherein an atomic ratio of Si to B¹ included in the core may be about 0.001 to about 0.05,
wherein A¹ may be a Group III element,
wherein A³ may be a Group II element or a Group III element, and
wherein B¹ and B² may each independently be a Group VI element.

According to one or more embodiments, the atomic ratio of Si to B¹ included in the core may be about 0.003 to about 0.03. For example, in one or more embodiments, the atomic ratio of Si to B¹ included in the core may be about 0.005 to about 0.02, but embodiments of the present disclosure are not limited thereto.

In this regard, the “atomic ratio of Si to B¹ included in the core” refers to the atomic ratio of Si included in the core relative to the atomic ratio of B¹ included in the core, which is taken as a reference value of 1. In other words, the “atomic ratio of Si to B¹ included in the core” refers to a ratio of the number of Si atoms included in the core to the number of B¹ atoms included in the core.

According to one or more embodiments, the core may further include A², and A² may be a Group III element.

According to one or more embodiments, A¹ may be aluminum (Al), gallium (Ga), indium (In), thallium (Tl), nihonium (Nh), or any combination thereof.

According to one or more embodiments, A² may be aluminum (Al), gallium (Ga), indium (In), thallium (Tl), nihonium (Nh), or any combination thereof.

According to one or more embodiments, A³ may be aluminum (Al), gallium (Ga), indium (In), thallium (Tl), nihonium (Nh), magnesium (Mg), calcium (Ca), zinc (Zn), cadmium (Cd), mercury (Hg), or any combination thereof.

According to one or more embodiments, A¹ to A³ may be the same as or different from one another.

According to one or more embodiments, B¹ may be oxygen (O), sulfur (S), selenium (Se), tellurium (Te), or any combination thereof.

According to one or more embodiments, B² may be oxygen (O), sulfur (S), selenium (Se), tellurium (Te), or any combination thereof.

According to one or more embodiments, B¹ and B² may be the same as or different from each other.

According to one or more embodiments, A¹ may be gallium (Ga) or indium (In); A² may be gallium (Ga) or indium (In); A³ may be gallium (Ga) or zinc (Zn); B¹ may be sulfur (S) or selenium (Se); and B² may be sulfur (S) or selenium (Se), for example, in one or more embodiments, A¹ may be indium (In), A² may be gallium (Ga), A³ may be zinc (Zn), B¹ may be sulfur (S), and B² may be sulfur (S), but embodiments of the present disclosure are not limited thereto.

According to one or more embodiments, the core may include a quaternary compound.

According to one or more embodiments, the core may include a Group I-III-VI semiconductor compound.

According to one or more embodiments, non-limiting examples of the Group I-III-VI semiconductor compound may include a ternary compound such as CuInS, CuInS₂, CuInSe₂, CuGaS₂, CuGaSe₂, CuGaO₂, and/or the like; a quaternary compound such as CuInGaS₂, CuInGaSe₂, and/or the like; or any combination thereof.

According to one or more embodiments, the core may include copper (Cu), indium (In), gallium (Ga), and sulfur (S).

According to one or more embodiments, the core may include CuInGaS₂ and, for example, may be represented by Formula 1:

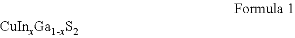

Here, x may be a real number of about 0 to about 1.

According to one or more embodiments, the atomic ratio of copper (Cu) relative to sulfur (1.00) included in the core may be about 0.20 to about 0.25.

According to one or more embodiments, the atomic ratio of indium (In) relative to sulfur (1.00) included in the core may be about 0 to about 0.18 or about 0.28 to about 0.5.

According to one or more embodiments, the atomic ratio of gallium (Ga) relative to sulfur (1.00) included in the core may be about 0.6 to about 0.8. For example, in one or more embodiments, the atomic ratio of gallium (Ga) relative to sulfur (1.00) included in the core may be about 0.62 to about 0.76.

According to one or more embodiments, the atomic ratio of gallium (Ga) relative to indium (In) included in the core may be about 0.05 to about 20.

According to one or more embodiments, the atomic ratio of gallium (Ga) relative to indium (In) included in the core may be greater than 1.

According to one or more embodiments, the first shell 20 may include a Group II-VI semiconductor compound, and the Group II-VI semiconductor compound may be CdS, CdSe, CdTe, ZnS, ZnSe, ZnTe, ZnO, ZnMgO, HgS, HgSe, HgTe, MgSe, MgS, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, CdZnSeS, CdZnSeTe, CdZnSTe, CdHgSeS, CdHgSeTe, CdHgSTe, HgZnSeS, HgZnSeTe, HgZnSTe, or any combination thereof.

According to one or more embodiments, the first shell 20 may include zinc (Zn) and sulfur (S) and, for example, may include ZnS.

According to one or more embodiments, copper (Cu) within the core 10 may be present in a substantially uniform concentration or a non-uniform concentration.

According to one or more embodiments, A¹ within the core 10 may be present in a substantially uniform concentration or a non-uniform concentration.

According to one or more embodiments, A² within the core 10 may be present in a substantially uniform concentration or a non-uniform concentration.

According to one or more embodiments, B¹ within the core 10 may be present in a substantially uniform concentration or a non-uniform concentration.

According to one or more embodiments, A³ within the first shell 20 may be present in a substantially uniform concentration or a non-uniform concentration.

According to one or more embodiments, B² within the first shell 20 may be present in a substantially uniform concentration or a non-uniform concentration.

According to one or more embodiments, the sum of a radius L1 of the core of the quantum dot 100 and a thickness L2 of the first shell may represent a radius L3 of the quantum dot 100.

According to one or more embodiments, the radius L3 of the quantum dot 100 may be about 1 nanometer (nm) to about 5 nm.

The “radius L1 of the core” refers to the distance from a center of the quantum dot to at interface between the core and the first shell.

The “thickness L2 of the first shell” refers to the distance from the interface between the core 10 and the first shell 20 to a surface of the first shell 20, which corresponds to the value obtained by subtracting the radius L1 of the core from the radius L3 from the center of the quantum dot to the surface of the first shell.

According to one or more embodiments, the quantum dot 100 may further include a second shell covering the first shell 20. For example, the second shell may apply all the descriptions applicable to the first shell 20.

According to one or more embodiments, a shape of the quantum dot 100 may be specifically a spherical nanoparticle, a pyramidal nanoparticle, a multi-arm nanoparticle, a cubic nanoparticle, a nano-tube, a nano-wire, a nano-fiber, a nano-platelet, and/or the like.

According to one or more embodiments, the quantum dot 100 may be spherical.

According to one or more embodiments, a maximum emission wavelength (i.e., the wavelength at the maximum emission intensity or peak emission wavelength) of a photoluminescence (PL) spectrum of the quantum dot 100 may be about 600 nm to about 650 nm.

According to one or more embodiments, a quantum yield (QY) of the quantum dot 100 may be about 80% to about 98%, about 85% to about 97%, or about 90% to about 95%.

According to one or more embodiments, the quantum dot 100 may have a full width at half maximum (FWHM) of the emission spectrum (i.e., photoluminescence spectrum) of 50 nm or less, and in this range, color purity or color reproduction of the quantum dot may be improved. Additionally, light emitted through these quantum dots is emitted in all directions, which may improve the viewing angle. For example, in one or more embodiments, the quantum dot 100 may have a FWHM of about 30 nm to about 50 nm, about 35 nm to about 50 nm, about 40 nm to about 50 nm, or about 43 nm to about 47 nm.

According to one or more embodiments, the absorbance of blue light at 450 nm by the quantum dot 100 may be 0.6 or more, for example, 0.65 or more.

Accordingly, if (e.g., when) the semiconductor nanoparticles are applied to the light conversion layer of a light-emitting apparatus, the absorption rate for blue light from a light source is high, enabling highly efficient light conversion and the realization of high color purity green.

According to one or more embodiments, a uniformity of the quantum dot 100 may be about 5% to about 10%.

The uniformity was calculated by measuring a particle area using a program in an image of the quantum dot obtained through transmission electron microscopy (TEM) analysis, calculating the diameter, and calculating the uniformity as the dispersion in diameter.

According to one or more embodiments, the quantum dot 100 may be prepared by a method of preparing a quantum dot described herein.

According to one or more embodiments, the quantum dot 100 is prepared by a method of preparing a quantum dot described in more detail.

The quantum dot 100 may be synthesized by a wet chemical process, a metal organic chemical vapor deposition process, a molecular beam epitaxy process, or similar processes.

The wet chemical process is a method of growing a quantum dot particle crystal by mixing an organic solvent and a precursor material of the quantum dot. During crystal growth, the organic solvent naturally acts as a dispersing agent coordinated to the surface of the quantum dot crystal and controls the growth of the crystal, so the growth of the quantum dot particle may be controlled or selected through a process that is easier and less expensive than vapor deposition methods such as metal organic chemical vapor deposition (MOCVD) or molecular beam epitaxy (MBE), and/or the like.

In one or more embodiments, the quantum dot 100 may further include a Group II-VI semiconductor compound; a Group III-V semiconductor compound; a Group III-VI semiconductor compound; a Group I-III-VI semiconductor compound; a Group IV-VI semiconductor compound; a Group IV element or compound; or any combination thereof.

Non-limiting example of the Group II-VI semiconductor compound may include a binary compound such as CdS, CdSe, CdTe, ZnS, ZnSe, ZnTe, ZnO, HgS, HgSe, HgTe, MgSe, MgS, and/or the like; a ternary compound such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and/or the like; a quaternary compound such as CdZnSeS, CdZnSeTe, CdZnSTe, CdHgSeS, CdHgSeTe, CdHgSTe, HgZnSeS, HgZnSeTe, HgZnSTe, and/or the like; or any combination thereof.

Non-limiting examples of the Group III-V semiconductor compound may include a binary compound such as GaN, GaP, GaAs, GaSb, AlN, AlP, AlAs, AlSb, InN, InP, InAs, InSb, and/or the like; a ternary compound such as GaNP, GaNAs, GaNSb, GaPAs, GaPSb, AlNP, AlNAs, AlNSb, AlPAs, AlPSb, InGaP, InNP, InAlP, InNAs, InNSb, InPAs, InPSb, GaAlNP, and/or the like; a quaternary compound such as GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and/or the like; or any combination thereof. In one or more embodiments, the Group III-V semiconductor compound may further include a Group II element. Non-limiting examples of the Group III-V semiconductor compound further including the Group II element may include InZnP, InGaZnP, InAlZnP, and/or the like.

Non-limiting examples of the Group III-VI semiconductor compound may include a binary compound such as GaS, GaSe, Ga₂Se₃, GaTe, InS, InSe, In₂S₃, In₂Se₃, InTe, and/or the like; a ternary compound such as InGaS₃, InGaSe₃, and/or the like; or any combination thereof.

Non-limiting examples of the Group I-III-VI semiconductor compound may include a ternary compound such as AgInS, AgInS₂, AgInSe₂, AgGaS, AgGaS₂, AgGaSe₂, CuInS, CuInS₂, CuInSe₂, CuGaS₂, CuGaSe₂, CuGaO₂, AgGaO₂, AgAlO₂, and/or the like; a quaternary compound such as AgInGaS₂, AgInGaSe₂, CuInGaS₂, CuInGaSe₂, and/or the like; or any combination thereof.

Non-limiting examples of the Group IV-VI semiconductor compound may include a binary compound such as SnS, SnSe, SnTe, PbS, PbSe, PbTe, and/or the like; a ternary compound such as SnSeS, SnSeTe, SnSTe, PbSeS, PbSeTe, PbSTe, SnPbS, SnPbSe, SnPbTe, and/or the like; a quaternary compound such as SnPbSSe, SnPbSeTe, SnPbSTe, and/or the like; or any combination thereof.

The Group IV element or compound may include a single-element compound such as Si, Ge, and/or the like; a binary compound such as SiC, SiGe, and/or the like; or any combination thereof.

Each element included in the multi-element compound, such as a binary compound, a ternary compound, and a quaternary compound, may exist within the particle in a substantially uniform concentration or non-uniform concentration. For example, in the present disclosure, the formula refers to the type (kind) of elements included in the compound, and an element ratio within the compound may vary. For example, AgInGaS₂ may refer to AgInₓGa₁₋ₓS₂ (where x is a real number between about 0 and about 1).

The shell 20 of the quantum dot may serve as a protective layer to maintain semiconductor properties by preventing or reducing chemical modification of the core and/or as a charging layer to impart electrophoretic properties to the quantum dot. The shell 20 may be single-layered or multi-layered. In one or more embodiments, the interface between the core and the shell may have a concentration gradient in which the concentration of elements present in the shell decreases toward the center.

The shell 20 of the quantum dot may further include an oxide of metals, metalloids, or non-metals, a semiconductor compound, or one or more (e.g., any suitable) combinations thereof, and/or the like. Non-limiting examples of the oxide of metals, metalloids, or non-metals may include a binary compound such as SiO₂, Al₂O₃, TiO₂, ZnO, MnO, Mn₂O₃, Mn₃O₄, CuO, FeO, Fe₂O₃, Fe₃O₄, CoO, Co₃O₄, NiO, and/or the like; a ternary compound such as MgAl₂O₄, CoFe₂O₄, NiFe₂O₄, CoMn₂O₄, and/or the like; or any combination thereof. Non-limiting examples of the semiconductor compound may include the Group II-VI semiconductor compound; the Group III-V semiconductor compound; the Group III-VI semiconductor compound; the Group I-III-VI semiconductor compound; the Group IV-VI semiconductor compound; or any combination thereof, as disclosed herein. For example, the semiconductor compound suitable as a shell may include CdS, CdSe, CdTe, ZnS, ZnSe, ZnTe, ZnSeS, ZnTeS, GaAs, GaP, GaS, GaSe, AgGaS, AgGaS₂, GaSb, HgS, HgSe, HgTe, InAs, InP, InGaP, InSb, AlAs, AlP, AlSb, or any combination thereof.

By adjusting the size of the quantum dot 100, the energy band gap of the quantum dot 100 may be controlled or selected, so that light of one or more suitable wavelengths may be obtained from a quantum dot emission layer. Therefore, by using the quantum dot of different sizes, a light-emitting element that emit light of different wavelengths may be implemented. For example, the size of the quantum dots may be selected to enable the quantum dots to emit red, green, and/or blue light. Furthermore, the size of the quantum dots may be configured such that light of one or more suitable colors is combined to emit white light.

### Method of Preparing Quantum Dot

### First Embodiment

The method of preparing the quantum dot 100 may include:
preparing a first-1 composition including a copper (Cu)-containing precursor and an A¹-containing precursor;
preparing a core including copper (Cu), A¹, and B¹ by utilizing a first-2 composition including the first-1 composition and a B¹-containing precursor; and
preparing a first shell covering the core and including A³ and B² by utilizing a second composition including the core, an A³-containing precursor, and a B²-containing precursor,
wherein an atomic ratio of Si to B¹ included in the core may be about 0.001 to about 0.05,
and the preparing of the core including copper (Cu), A¹, and B¹ utilizing the first-2 composition,
may further include treating the first-2 composition with an inert gas,
wherein A¹ may be a Group III element,
wherein A³ may be a Group II element, and
wherein B¹ and B² may each independently be a Group VI element.

According to one or more embodiments, the first-1 composition may further include an A²-containing precursor. For example, in one or more embodiments, the first-1 composition may include a copper (Cu)-containing precursor, an A¹-containing precursor, and an A²-containing precursor.

According to one or more embodiments, the preparing of the first-1 composition including the copper (Cu)-containing precursor and the A¹-containing precursor may include preparing a mixture including the copper (Cu)-containing precursor and the A¹-containing precursor; and heat-treating the mixture to prepare the first-1 composition.

The heat-treating of the mixture including the copper (Cu)-containing precursor and the A¹-containing precursor may be performed at a temperature of about 100° C. to about 150° C. Additionally, it may be performed over a period of about 30 minutes to about 100 minutes.

According to one or more embodiments, the preparing of the core including copper (Cu), A¹, and B¹ utilizing the first-2 composition including the first-1 composition and a B¹-containing precursor may include preparing the first-2 composition including the first-1 composition and the B¹-containing precursor; and heat-treating the first-2 composition.

The heat-treating of the first-2 composition may include a first heat-treating and a second heat-treating.

The first heat-treating may be performed at a temperature of about 270° C. to about 350° C. Additionally, it may be performed over a period of about 20 minutes to about 100 minutes.

The second heat-treating may be performed at a temperature of about 220° C. to about 270° C. Additionally, it may be performed over a period of about 20 minutes to about 100 minutes.

According to one or more embodiments, the treating of the first-2 composition with the inert gas may be performed between preparing the first-2 composition including the first-1 composition and the B1-containing precursor and heat-treating the first-2 composition, but embodiments of the present disclosure are not limited thereto.

### Second Embodiment

According to one or more embodiments, the Second Embodiment refers to the First Embodiment, wherein
the preparing of the first-1 composition including the copper (Cu)-containing precursor and the A¹-containing precursor may further include
preparing a first-1-1 composition including the copper (Cu)-containing precursor and preparing a first-1-2 composition including the A¹-containing precursor.

According to this embodiment, before preparing the first-1 composition including the copper (Cu)-containing precursor and the A¹-containing precursor in the First Embodiment, preparing the first-1-1 composition including the copper (Cu)-containing precursor and preparing the first-1-2 composition including the A¹-containing precursor may be further included.

According to one or more embodiments, the order of preparing the first-1-1 composition including the copper (Cu)-containing precursor and preparing the first-1-2 composition including the A¹-containing precursor may be interchanged. For example, preparing the first-1-1 composition including the copper (Cu)-containing precursor may be performed first, followed by preparing the first-1-2 composition including the A¹-containing precursor, or preparing the first-1-2 composition including the A¹-containing precursor may be performed first, followed by preparing the first-1-1 composition including the copper (Cu)-containing precursor.

Therefore, in one or more embodiments, the second Embodiment may include:
preparing a first-1-1 composition including a copper (Cu)-containing precursor;
preparing a first-1-2 composition including an A¹-containing precursor;
preparing a first-1 composition including the copper (Cu)-containing precursor and the A¹-containing precursor;
preparing a core including copper (Cu), A¹, and B¹ by utilizing a first-2 composition including the first-1 composition and a B¹-containing precursor; and
preparing a first shell covering the core and including A³ and B² by utilizing a second composition including the core, an A³-containing precursor, and a B²-containing precursor,
wherein an atomic ratio of Si to B¹ included in the core may be about 0.001 to about 0.05,
and the preparing of the core including copper (Cu), A¹, and B¹ utilizing the first-2 composition,
may further includes treating the first-2 composition with an inert gas,
wherein A¹ may be a Group III element,
wherein A³ may be a Group II element, and
wherein B¹ and B² may each independently be a Group VI element.

According to one or more embodiments, the preparing of the first-1 composition including the copper (Cu)-containing precursor and the A¹-containing precursor in the second Embodiment may be replaced by
preparing the first-1-1 composition including the copper (Cu)-containing precursor; and preparing the first-1-2 composition including the A¹-containing precursor.

For example, in one or more embodiments, the second Embodiment may include
preparing a first-1-1 composition including a copper (Cu)-containing precursor;
preparing a first-1-2 composition including an A¹-containing precursor;
preparing a core including copper (Cu), A¹, and B¹ by utilizing a first-2 composition including the first-1-1 composition, the first-1-2 composition, and a B¹-containing precursor; and
preparing a first shell covering the core and including A³ and B² by utilizing a second composition including the core, an A³-containing precursor, and a B²-containing precursor,
wherein an atomic ratio of Si to B¹ included in the core is about 0.001 to about 0.05, and
the preparing of the core including copper (Cu), A¹, and B¹ utilizing the first-2 composition,
may further includes treating the first-2 composition with an inert gas,
wherein A¹ may be a Group III element,
wherein A³ may be a Group II element, and
wherein B¹ and B² may each independently be a Group VI element.

According to one or more embodiments, the first-1-2 composition may further include an A²-containing precursor. For example, in one or more embodiments, the first-1-2 composition may include the A¹-containing precursor and the A²-containing precursor.

According to one or more embodiments, the preparing of the first-1-1 composition including the copper (Cu)-containing precursor includes preparing a mixture including the copper (Cu)-containing precursor; and heat-treating the mixture to prepare the first-1-1 composition.

The heat-treating of the mixture including the copper (Cu)-containing precursor may be performed at a temperature of about 100° C. to about 150° C. Additionally, it may be performed over a period of about 30 minutes to about 100 minutes.

According to one or more embodiments, the preparing of the first-1-2 composition including the A¹-containing precursor includes preparing a mixture including the A¹-containing precursor; and heat-treating the mixture to prepare the first-1-2 composition.

The heat-treating of the mixture including the A¹-containing precursor may be performed at a temperature of about 100° C. to about 150° C. Additionally, it may be performed over a period of about 30 minutes to about 100 minutes.

According to one or more embodiments, the preparing of a core including copper (Cu), A¹, and B¹ utilizing the first-2 composition includes preparing the first-2 composition including the first-1 composition and the B¹-containing precursor (typically, including the first-1-1 composition, the first-1-2 composition, and the B¹-containing precursor); and heat-treating the first-2 composition.

The heat-treating of the first-2 composition including the first-1 composition and the B¹-containing precursor (typically, including the first-1-1 composition, the first-1-2 composition, and the B¹-containing precursor) may include a first heat-treating and a second heat-treating.

The first heat-treating may be performed at a temperature of about 270° C. to about 350° C. Additionally, it may be performed over a period of about 20 minutes to about 100 minutes.

The second heat-treating may be performed at a temperature of about 220° C. to about 270° C. Additionally, it may be performed over a period of about 20 minutes to about 100 minutes.

According to one or more embodiments, treating the first-2 composition with the inert gas may be performed between preparing the first-2 composition including the first-1 composition and the B¹-containing precursor (typically, including the first-1-1 composition, the first-1-2 composition, and the B¹-containing precursor) and heat-treating the first-2 composition, but embodiments of the present disclosure are not limited thereto.

The following content and description may be applied to both (e.g., simultaneously) the First embodiment and the Second embodiment. In addition, because all of the content and descriptions regarding the quantum dot 100 are applied to the quantum dot preparation method, only the different parts will be described.

According to one or more embodiments, treating the first-2 composition with an inert gas may be to treat the first-2 composition with the inert gas and then discharging the first-2 composition to the outside of a reactor. Therefore, by discharging the residual trimethylsilyl (TMS) together with the inert gas discharged to the outside, the substantially uniform core formation and side reaction reduction effects may be excellent or suitable.

According to one or more embodiments, the inert gas may be nitrogen (N₂), helium (He), or argon (Ar). For example, in one or more embodiments, the inert gas may be nitrogen (N₂).

As used herein, the wordings “X-containing precursor” may be, for example, X, an X-containing halide, an X-containing carbonate, an X-containing nitrate, an X-containing nitrite, an X-containing oxide, an X-containing sulfide, an X-containing organic compound, or any combination thereof.

For example, a “copper (Cu)-containing precursor” may be, for example, copper, a copper-containing halide (for example, CuBr, CuI, and/or the like), a copper-containing carbonate (for example, Cu₂CO₃, and/or the like), a copper-containing nitrate compound (for example, CuNO₃, and/or the like), a copper-containing nitrate, a copper-containing oxide (for example, Cu₂O, and/or the like), a copper-containing sulfide (for example, Cu₂S, and/or the like), a copper-containing organic compound (for example, Cu(C₂H₃O₂), and/or the like), or any combination thereof.

For example, as an example of the “A¹-containing precursor,” an “indium-containing precursor” may be, for example, indium, an indium-containing halide (for example, InBr₃, InI₃, and/or the like), an indium-containing carbonate (for example, In₂(CO₃)₃, and/or the like), an indium-containing nitrate (for example, In(NO₃)₃, and/or the like), an indium-containing nitrate compound, an indium-containing oxide (for example, In₂O₃, and/or the like), an indium-containing sulfide (for example, In₂S₃, and/or the like), an indium-containing organic compound (for example, In(C₂H₃O₂)₃, and/or the like), or any combination thereof.

For example, as an example of the “B¹-containing precursor”, a “sulfur (S)-containing precursor” may be, for example, sulfur, a sulfur-containing organic acid salt, a sulfur-containing halogen salt, a sulfur-containing carbonate, a sulfur-containing nitrate, a sulfur-containing nitrate compound, a sulfur-containing oxide, a sulfur-containing sulfide, a sulfur-containing acetate, a sulfur-containing organic compound (for example, a sulfur-containing oleylamine (S-(oleylamine)), a sulfur-containing dodecanethiol (S-(1-dodecanethiol)), a sulfur-containing octanethiol (S-(1-octanethiol)), a sulfur-containing tributylphosphate (TBP-S), a sulfur-containing trioctylphosphate (TOP-S), a sulfur-containing oleic acid (S-(oleic acid)), a sulfur-containing octadecene (S-(1-octadecene)), and/or the like), a bis(trimethylsilyl)sulfide ((TMS)₂S), or any combination thereof.

According to one or more embodiments, the “B¹-containing precursor” may be a sulfur-containing dodecanethiol (S-(1-dodecanethiol), a dodecanethiol, a bis(trimethylsilyl)sulfide ((TMS)₂S), and any combination thereof.

According to one or more embodiments, reference may also be made to the description for the “A²-containing precursor”, the “A³-containing precursor”, and the “B²-containing precursor.” In other words, the descriptions of the “A²-containing precursor”, the “A³-containing precursor”, and the “B²-containing precursor” may refer to the above descriptions accordingly.

According to one or more embodiments, the composition may include a solvent. For example, the composition including a solvent may be the first-1 composition, the first-2 composition, the second composition, the first-1-1 composition, and/or the first-1-2 composition.

The solvent may be oleylamine, octadecene, or any combination thereof.

### Method of Preparing First Shell

According to one or more embodiments, the method may further include washing after preparing the core, and may include preparing the first shell after washing.

According to one or more embodiments, the preparing of the first shell covering the core and including A³ and B² using the second composition including the core, the A³-containing precursor, and the B²-containing precursor may include preparing a mixture including the A³-containing precursor and the B²-containing precursor; and heat-treating the mixture including the A³-containing precursor and the B²-containing precursor.

The quantum dot and the method of preparing the same according to the disclosure may introduce bis(trimethylsilyl)sulfide ((TMS)₂S) as the “B¹-containing precursor” when forming the quantum dot. Furthermore, the inert gas treatment may be performed when forming the core of the quantum dot of the disclosure.

Because the bis(trimethylsilyl)sulfide has rapid reactivity and the inert gas may remove the residual TMS after the reaction of the bis(trimethylsilyl)sulfide, the quantum dot preparation method according to the disclosure and the quantum dot prepared thereby may have excellent or suitable effects of substantially uniform core formation and reduction of side reactions.

Accordingly, the quantum dot according to one or more embodiments may provide a quantum dot with improved chemical stability and PL characteristics by achieving excellent or suitable quantum yield (QY) based on the FWHM.

Therefore, a high-quality optical member and an electronic apparatus may be provided using the quantum dot.

### Optical Member

The quantum dot may be used in one or more suitable optical members. Therefore, according to one or more embodiments of the present disclosure, provided is an optical member including the quantum dot.

According to one or more embodiments, the optical member may be an element of light control.

According to one or more embodiments, the optical member may be a color filter, a color conversion member, a capping layer, a light extraction efficiency enhancement layer, a selective light absorption layer, or a polarization layer.

### Apparatus

The quantum dot may be used in one or more suitable electronic apparatuses. Therefore, according to one or more embodiments of the present disclosure, provided is an electronic apparatus including the quantum dot.

According to one or more embodiments, the electronic apparatus may include a light source; and a color conversion member arranged in a path of light emitted from the light source; wherein the quantum dot is included in the color conversion member.

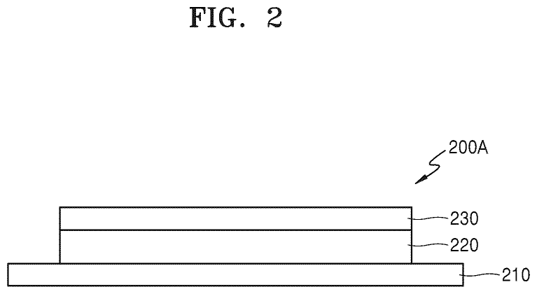

FIG. 2 is a diagram schematically illustrating a structure of an electronic apparatus 200A according to one or more embodiments of the present disclosure. The electronic apparatus 200A of FIG. 2 may include a substrate 210; a light source 220 on (e.g., arranged on) the substrate; and a color conversion member 230 on (e.g., arranged on) the light source 220.

For example, in one or more embodiments, the light source 220 may be a back light unit (BLU) used in a liquid crystal display (LCD), a fluorescent lamp, a light-emitting element, an organic light-emitting element, or a quantum dot light-emitting element (QLED), or any combination thereof. The color conversion member 230 may be arranged in at least one propagation direction of the light emitted from the light source 220.

At least one region of the color conversion member 230 of the electronic apparatus 200A may include the quantum dot, and the at least one region may be to absorb light emitted from the light source and emit light with a maximum emission wavelength in the range of about 500 nm to about 650 nm.

In this case, the fact that the color conversion member 230 is arranged on at least one propagation direction of the light emitted from the light source 220 does not exclude that other elements may be included between the color conversion member 230 and the light source 220.

For example, in one or more embodiments, a polarizer, a liquid crystal layer, a light guide plate, a diffusion plate, a prism sheet, a microlens sheet, a brightness enhancement sheet, a reflective film, a color filter, or any combination thereof may be additionally arranged between the light source 220 and the color conversion member 230.

In one or more embodiments, a polarizer, a liquid crystal layer, a light guide plate, a diffusion plate, a prism sheet, a microlens sheet, a brightness enhancement sheet, a reflective film, a color filter, or any combination thereof may be additionally arranged on the color conversion member 230.

The electronic apparatus 200A shown in FIG. 2 is an example of an apparatus according to one or more embodiments and may take one or more suitable forms, further including one or more suitable configurations as necessary.

In one or more embodiments, the electronic apparatus may include a structure in which a light source, a light guide plate, a color conversion member, a first polarizer, a liquid crystal layer, a color filter, and a second polarizer are sequentially arranged (e.g., in the stated order).

In one or more embodiments, the electronic apparatus may include a structure in which a light source, a light guide plate, a first polarizer, a liquid crystal layer, a second polarizer, and a color conversion member are sequentially arranged (e.g., in the stated order).

In one or more embodiments, the color filter may include a pigment and/or a dye. In one or more embodiments, one selected from among the first polarizer and the second polarizer may be a vertical polarizer, and the other may be a horizontal polarizer.

In one or more embodiments, the quantum dot as disclosed herein may be used as an emitter. Accordingly, according to one or more embodiments, an electronic apparatus may be provided and include a light-emitting element including: a first electrode; a second electrode opposite to the first electrode; and an emission layer between (e.g., arranged between) the first electrode and the second electrode; wherein the quantum dot is included in the light-emitting element (for example, in the emission layer of the light-emitting element). The light-emitting element may further include a hole transport region between (e.g., arranged between) the first electrode and the emission layer, an electron transport region between (e.g., arranged between) the emission layer and the second electrode, or a (e.g., any suitable) combination thereof.

### Light-Emitting Element

In one or more embodiments, the quantum dot as disclosed herein may be used as an emitter. Accordingly, according to one or more embodiments, an electronic apparatus may be provided and include a light-emitting element including: a first electrode; a second electrode opposite to the first electrode; and an intermediate layer between (e.g., arranged between) the first electrode and the second electrode including an emission layer; wherein the quantum dot is included in the light-emitting element (for example, in the emission layer of the light-emitting element). The intermediate layer of light-emitting element may further include a hole transport region between (e.g., arranged between) the first electrode and the emission layer, an electron transport region between (e.g., arranged between) the emission layer and the second electrode, or a (e.g., any suitable) combination thereof.

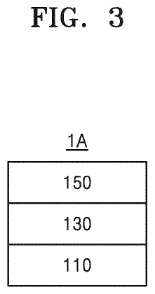

### Description of FIG. 3

FIG. 3 is a diagram schematically illustrating a cross-sectional view of a light-emitting element 1A according to one or more embodiments of the present disclosure.

The light-emitting element 1A may include: a first electrode 110; a second electrode 150 opposite the first electrode 110; and an emission layer 130 between (e.g., arranged between) the first electrode 110 and the second electrode 150, wherein the emission layer includes a quantum dot. Below, each layer of the light-emitting element 1A will be described in more detail.

At least one of the quantum dot of the present disclosure may be used in a light-emitting element (for example, an organic light-emitting element). Accordingly, provided is a light-emitting element, which includes a first electrode; a second electrode opposite the first electrode; an intermediate layer between (e.g., arranged between) the first electrode and the second electrode and including an emission layer; and the quantum dot as disclosed herein.

According to one or more embodiments,
the first electrode of the light-emitting element is an anode,
the second electrode of the light-emitting element is a cathode,
the intermediate layer further includes a hole transport region between (e.g., arranged between) the first electrode and the emission layer, and an electron transport region between (e.g., arranged between) the emission layer and the second electrode,
the hole transport region includes a hole injection layer, a hole transport layer, an emission auxiliary layer, an electron blocking layer, or any combination thereof, and
the electron transport region may include a buffer layer, a hole blocking layer, an electron control layer, an electron transport layer, an electron injection layer, or any combination thereof.

According to one or more embodiments, the quantum dot may be included between the first electrode and the second electrode of the light-emitting element. Accordingly, the quantum dot may be included in the intermediate layer of the light-emitting element, for example, in the emission layer of the intermediate layer.

According to one or more embodiments, the emission layer in the intermediate layer of the light-emitting element may include a dopant and a host, and the host may include the quantum dot. For example, the quantum dot may serve as the host. The emission layer may be to emit red light, green light, blue light, and/or white light. For example, the emission layer may be to emit orange/red light. The orange/red light may have a maximum emission wavelength in a range of, for example, about 600 nm to about 700 nm.

According to one or more embodiments, the emission layer in the intermediate layer of the light-emitting element includes a dopant and a host, the host includes the quantum dot, and the dopant may be to emit blue light or red light. For example, the dopant may include a transition metal and m ligands, wherein m is an integer from 1 to 6, the m ligands may be the same as or different from one another, at least one ligand in the m ligands and the transition metal are connected to each other through a carbon-transition metal bond, and the carbon-transition metal bond may be a coordinate bond. For example, in one or more embodiments, at least one ligand of the m ligands may be a carbene ligand (for example, Ir(pmp)₃, and/or the like). The transition metal may be, for example, iridium, platinum, osmium, palladium, rhodium, gold, and/or the like. A more detailed description of the emission layer and dopant, refers to the description herein.

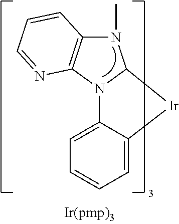

According to one or more embodiments, the light-emitting element may include a capping layer on (e.g., arranged on the outer side of) the first electrode or on (e.g., arranged on the outer side of) the second electrode.

For example, in one or more embodiments, the light-emitting element may further include at least one of a first capping layer on (e.g., arranged on the outer side of) the first electrode or a second capping layer on (e.g., arranged on the outer side of) the second electrode, wherein at least one of the first capping layer or the second capping layer may include the quantum dot. A more detailed description of the first capping layer and/or the second capping layer, refers to the description herein.

According to one or more embodiments, the light-emitting element may include:
a first capping layer on (e.g., arranged on the outer side of) the first electrode and including the quantum dot;
a second capping layer on (e.g., arranged on the outer side of) the second electrode and including the quantum dot; or
both (e.g., simultaneously) the first capping layer and the second capping layer.

As used herein, “(intermediate layer and/or capping layer) includes the quantum dot” may be interpreted as “(intermediate layer and/or capping layer) may include the quantum dot or two or more different types (kinds) of quantum dots.”

As used herein, “intermediate layer” is a term referring to all single and/or multiple layers between (e.g., arranged between) the first electrode and the second electrode in the light-emitting element.

According to one or more embodiments, provided are an apparatus including the quantum dot and/or light-emitting element as described above, and an electronic apparatus including the quantum dot and/or light-emitting element as described above. The electronic apparatus may further include a thin-film transistor. For example, in one or more embodiments, the electronic apparatus may further include a thin-film transistor including a source electrode and a drain electrode, wherein the first electrode of the light-emitting element may be electrically connected to the source electrode or the drain electrode. In one or more embodiments, the electronic apparatus may further include a color filter, a color conversion layer, a touch screen layer, a polarizing layer, or any combination thereof. A more detailed description of the electronic apparatus may be referred to the descriptions provided herein.

Hereinafter, with reference to FIG. 3, the structure and preparation method of the light-emitting element 1A according to one or more embodiments will be described.

FIG. 3 is a diagram schematically illustrating a cross-sectional view of a light-emitting element 1A according to one or more embodiments. The light-emitting element 1A includes a first electrode 110, an intermediate layer 130, and a second electrode 150.

### First Electrode 110

In one or more embodiments, a substrate may be additionally provided and arranged below the first electrode 110 and/or on top of the second electrode 150 of FIG. 3. As the substrate, a glass substrate or a plastic substrate may be used. In one or more embodiments, the substrate may be a flexible substrate, which may include a plastic (e.g., a polymer material) with excellent or suitable heat resistance and durability, such as, for example, polyimide, polyethylene terephthalate (PET), polycarbonate, polyethylene naphthalate, polyarylate (PAR), polyetherimide, or any combination thereof.

The first electrode 110 may be formed, for example, by providing a first electrode material on an upper portion of the substrate using a deposition method or a sputtering method, and/or the like. When the first electrode 110 is an anode, a high work function material facilitating hole injection may be used as the first electrode material.

The first electrode 110 may be a reflective electrode, a semi-transflective electrode, a transflective electrode, or a transmissive electrode. In order to form the first electrode 110, which is a transflective electrode or a transmissive electrode, indium tin oxide (ITO), indium zinc oxide (IZO), tin oxide (SnO₂), zinc oxide (ZnO), or any combination thereof may be used as a material for the first electrode. In one or more embodiments, to form the first electrode 110, which is a semi-transflective electrode, a transflective electrode, or a reflective electrode, magnesium (Mg), silver (Ag), aluminum (Al), aluminum-lithium (Al—Li), calcium (Ca), magnesium-indium (Mg—In), magnesium-silver (Mg—Ag), or any combination thereof may be used as the material for the first electrode.

The first electrode 110 may have a single-layer structure including (e.g., consisting of) a single layer or a multi-layer structure including multiple layers. For example, in one or more embodiments, the first electrode 110 may have a three-layer structure of ITO/Ag/ITO.

### Intermediate Layer 130

The intermediate layer 130 may be arranged on top of the first electrode 110. The intermediate layer 130 includes an emission layer.

The intermediate layer 130 may further include a hole transport region between (e.g., arranged between) the first electrode 110 and the emission layer, and an electron transport region between (e.g., arranged between) the emission layer and the second electrode 150.

In one or more embodiments, the intermediate layer 130 may further include, in addition to one or more suitable organic materials, metal-containing compounds such as metal organic compounds, and inorganic materials such as a quantum dot, and/or the like.

In one or more embodiments, the intermediate layer 130 may include i) two or more emitting units sequentially stacked between the first electrode 110 and the second electrode 150, and ii) a charge generation layer arranged between adjacent two emitting units among the two or more emitting units. When the intermediate layer 130 includes the two or more emitting units and the charge generation layer as described herein, the light-emitting element 1A may be a tandem light-emitting element.

### Hole Transport Region in Intermediate Layer 130

The hole transport region may have i) a single-layer structure including (e.g., consisting of) a single layer including (e.g., consisting of) a single material, ii) a single-layer structure including (e.g., consisting of) a single layer including a plurality of different materials, or iii) a multi-layer structure including a plurality of layers including a plurality of different materials.

The hole transport region may include a hole injection layer, a hole transport layer, an emission auxiliary layer, an electron blocking layer, or any combination thereof.

For example, in one or more embodiments, the hole transport region may have a multi-layer structure such as a hole injection layer/hole transport layer structure, a hole injection layer/hole transport layer/emission auxiliary layer structure, a hole injection layer/emission auxiliary layer structure, a hole transport layer/emission auxiliary layer structure, or a hole injection layer/hole transport layer/electron blocking layer structure, wherein constituent layers in each structure are sequentially stacked from the first electrode 110 in the stated order.

In one or more embodiments, the hole transport region may include a compound represented by Formula 201, a compound represented by Formula 202, or any combination thereof:

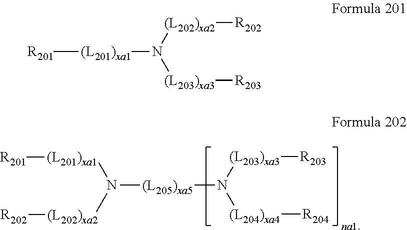

In Formulae 201 and 202,
L₂₀₁ to L₂₀₄ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
L₂₀₅ may be *—O—*′, *—S*′, *—N(Q₂₀₁)-*′, a C₁-C₂₀ alkylene group substituted or unsubstituted with at least one R₁₀ₐ, a C₂-C₂₀ alkenylene group substituted or unsubstituted with at least one R₁₀ₐ, a C₃-C₆₀ carbocyclic group substituted or unsubstituted with at least one R₁₀ₐ, or a C₁-C₆₀ heterocyclic group substituted or unsubstituted with at least one R₁₀ₐ,
xa1 to xa4 may each independently be an integer from about 0 to about 5,
xa5 may be an integer from about 1 to about 10,
R₂₀₁ to R₂₀₄ and Q₂₀₁ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
R₂₀₁ and R₂₀₂ may be optionally linked to each other via a single bond, a C₁-C₅ alkylene group substituted or unsubstituted with at least one R₁₀ₐ, or a C₂-C₅ alkenylene group substituted or unsubstituted with at least one R₁₀ₐ to form a C₈-C₆₀ polycyclic group (for example, a carbazole group and/or the like) substituted or unsubstituted with at least one R₁₀ₐ (see, for example, compound HT16 and/or the like).

R₂₀₃ and R₂₀₄ may be optionally linked to each other via a single bond, a C₁-C₅ alkylene group substituted or unsubstituted with at least one R₁₀ₐ, or a C₂-C₅ alkenylene group substituted or unsubstituted with at least one R₁₀ₐ to form a C₈-C₆₀ polycyclic group substituted or unsubstituted with at least one R₁₀ₐ,
na1 may be an integer from about 1 to about 4.

In one or more embodiments, each of Formulae 201 and 202 may include at least one selected from among groups represented by Formulae CY201 to CY217:

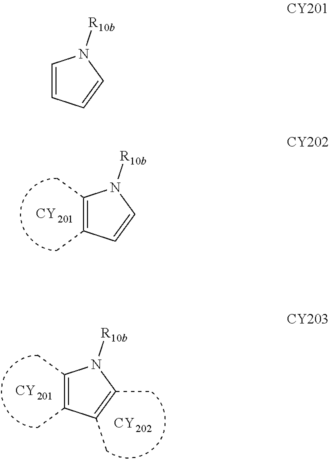

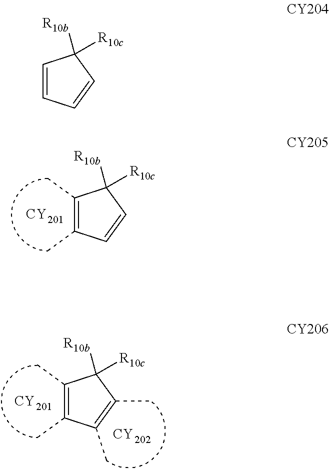

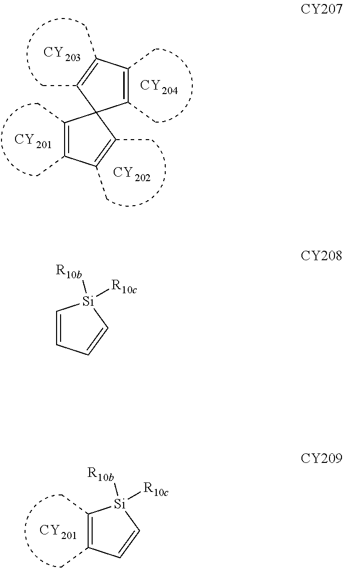

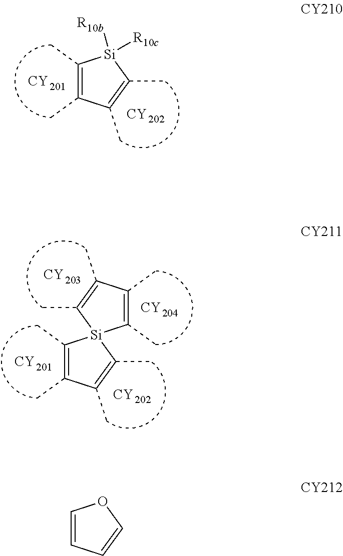

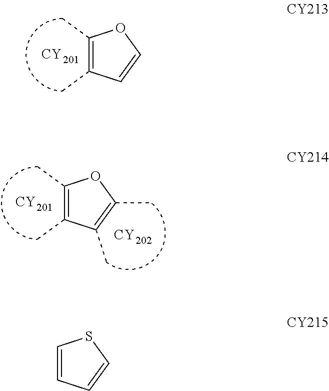

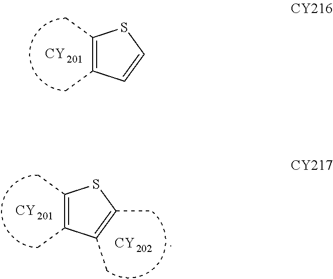

In Formulae CY201 to CY217, the descriptions of R_{10b} and R_{10c} may refer to the description of R₁₀ₐ as provided herein, respectively, and the rings CY201 to CY₂₀₄ may each independently be a C₃-C₂₀ carbocyclic group or a C₁-C₂₀ heterocyclic group, and at least one hydrogen in Formulae CY201 to CY217 may be or substituted or unsubstituted with R₁₀ₐ as disclosed herein.

According to one or more embodiments, in Formulae CY201 to CY217, rings CY201 to CY₂₀₄ may each independently be, a benzene group, a naphthalene group, a phenanthrene group, or an anthracene group.

According to one or more embodiments, each of Formulae 201 and 202 may include at least one selected from among the groups represented by Formulae CY201 to CY203.

According to one or more embodiments, Formula 201 may include at least one selected from among the groups represented by Formulae CY201 to CY203 and at least one selected from among the groups represented by Formulae CY204 to CY217.

According to one or more embodiments, in Formula 201, xa1 may be 1, R₂₀₁ may be a group represented by any one selected from among Formulae CY201 to CY203, xa2 may be 0, and R₂₀₂ may be a group represented by any one selected from among Formulae CY204 to CY207.

According to one or more embodiments, each of Formulae 201 and 202 may not include (e.g., may exclude) any of the groups represented by Formulae CY201 to CY203.

According to one or more embodiments, each of Formulae 201 and 202 may not include (e.g., may exclude) any of the groups represented by Formulae CY201 to CY203 and may include at least one selected from among the groups represented by Formulae CY204 to CY217.

According to one or more embodiments, each of Formulae 201 and 202 may not include (e.g., may exclude) any of the groups represented by Formulae CY201 to CY217.

In one or more embodiments, the hole transport region may include at least one selected from among compounds HT1 to HT46, 4,4′,4″-[tris(3-methylphenyl)phenylamino]triphenylamine (m-MTDATA), 4,4′,4″-tris(N,N-diphenylamino)triphenylamine (TDATA), 4,4′,4″-tris[N-(2-naphthyl)-N-phenylamino]-triphenylamine (2-TNATA), N,N′-di(naphthalen-1-yl)-N,N′-diphenyl-benzidine (NPB (NPD)), β-NPB, N,N′-bis(3-methylphenyl)-N,N′-diphenyl-[1,1′-biphenyl]-4,4′-diamine (TPD), Spiro-TPD, Spiro-NPB, methylated-NPB, 4,4′-cyclohexylidene bis[N,N-bis(4-methylphenyl)benzenamine](TAPC), 4,4′-bis[N,N′-(3-tolyl)amino]-3,3′-dimethylbiphenyl (HMTPD), 4,4′,4″-tris(N-carbazolyl)triphenylamine (TCTA), Polyaniline/Dodecylbenzenesulfonic acid (Pani/DBSA), Poly(3,4-ethylenedioxythiophene)/Poly(4-styrenesulfonate) (PEDOT/PSS), Polyaniline/Camphor sulfonic acid (Pani/CSA), Polyaniline/Poly(4-styrenesulfonate) (PANI/PSS), or any combination thereof:

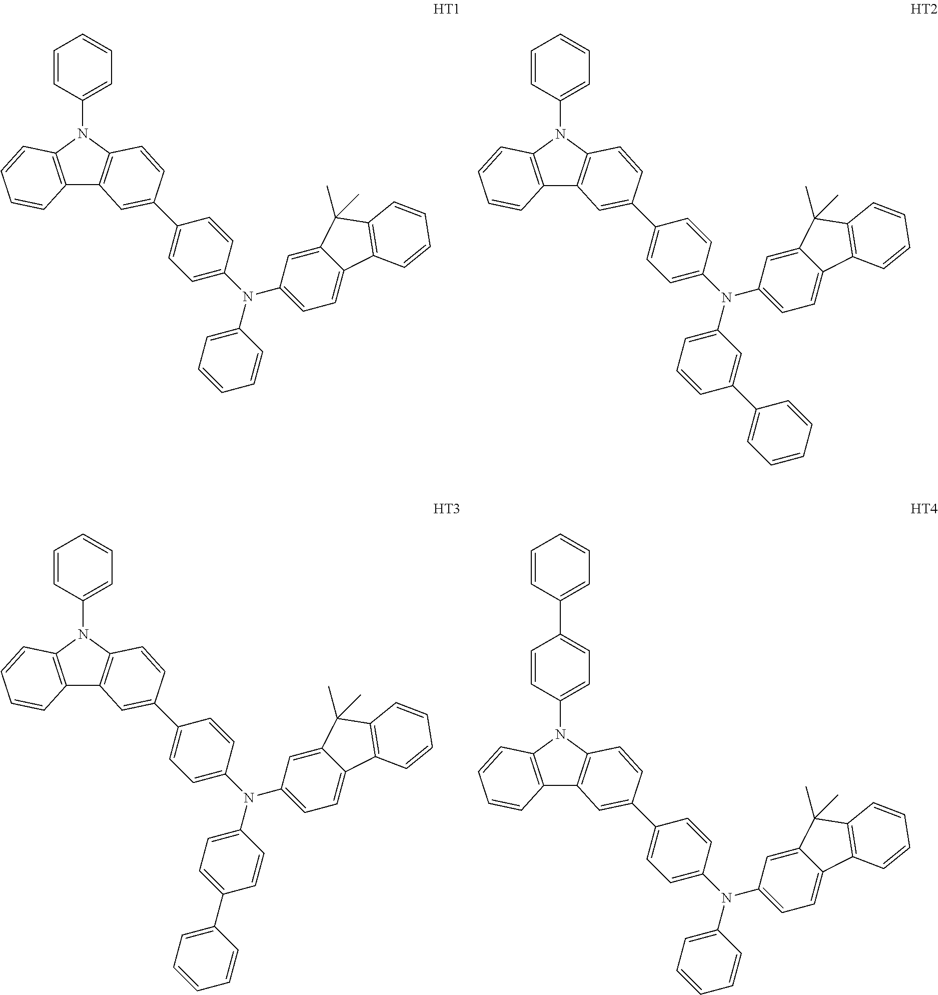 [SMILES: CC1(C)c2ccccc2-c2ccc(N(c3ccccc3)c3ccc(-c4ccc5c(c4)c4ccccc4n5-c4ccccc4)cc3)cc21 ; CC1(C)c2ccccc2-c2ccc(N(c3ccc(-c4ccc5c(c4)c4ccccc4n5-c4ccccc4)cc3)c3cccc(-c4ccccc4)c3)cc21 ; CC1(C)c2ccccc2-c2ccc(N(c3ccc(-c4ccccc4)cc3)c3ccc(-c4ccc5c(c4)c4ccccc4n5-c4ccccc4)cc3)cc21 ; CC1(C)c2ccccc2-c2ccc(N(c3ccccc3)c3ccc(-c4ccc5c(c4)c4ccccc4n5-c4ccc(-c5ccccc5)cc4)cc3)cc21]

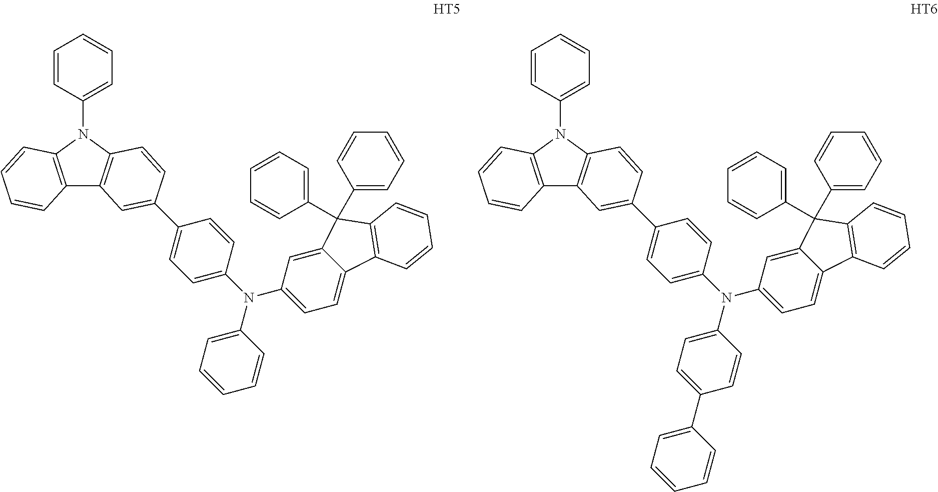 [SMILES: c1ccc(N(c2ccc(-c3ccc4c(c3)c3ccccc3n4-c3ccccc3)cc2)c2ccc3c(c2)C(c2ccccc2)(c2ccccc2)c2ccccc2-3)cc1 ; c1ccc(-c2ccc(N(c3ccc(-c4ccc5c(c4)c4ccccc4n5-c4ccccc4)cc3)c3ccc4c(c3)C(c3ccccc3)(c3ccccc3)c3ccccc3-4)cc2)cc1]

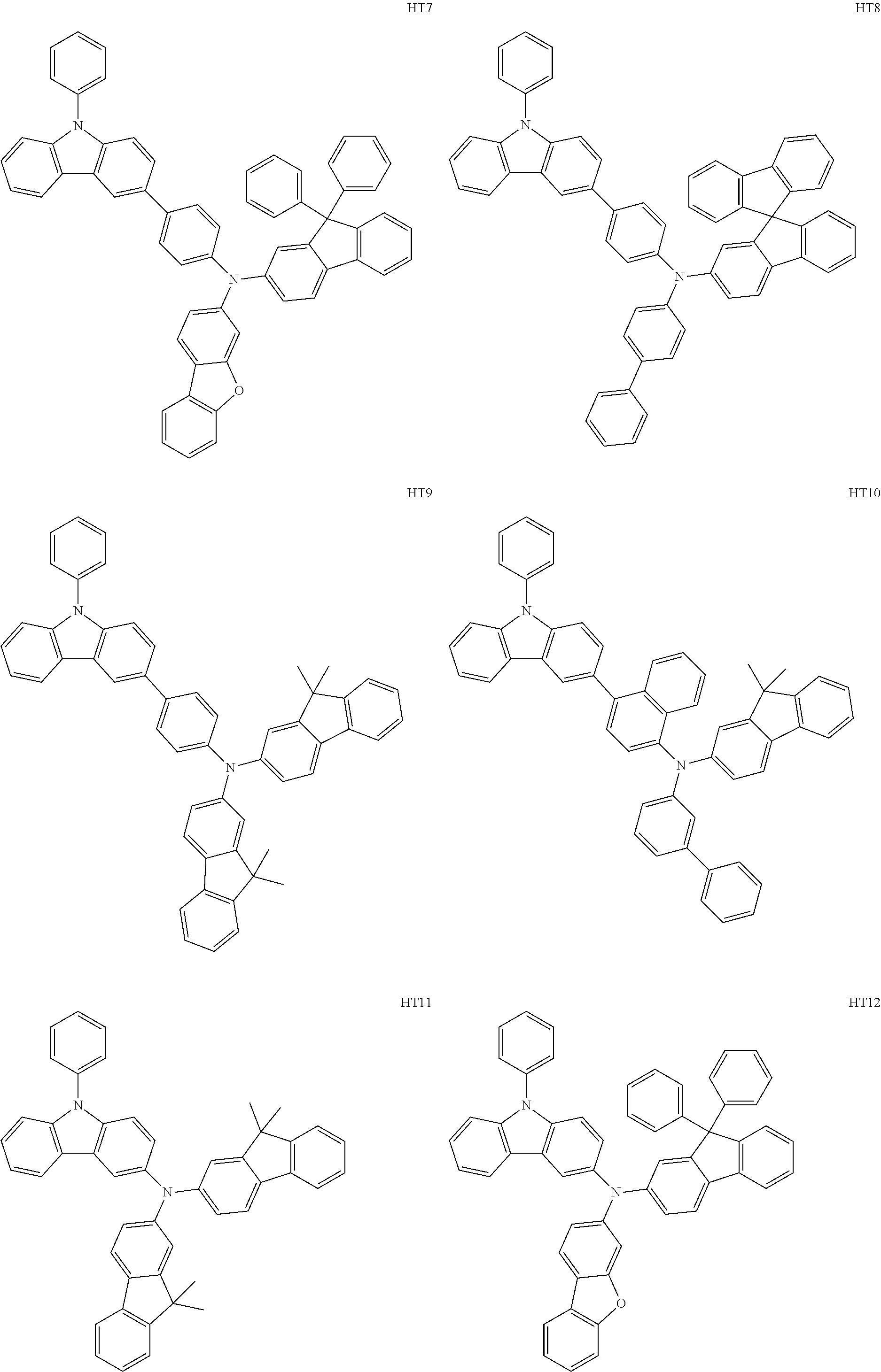

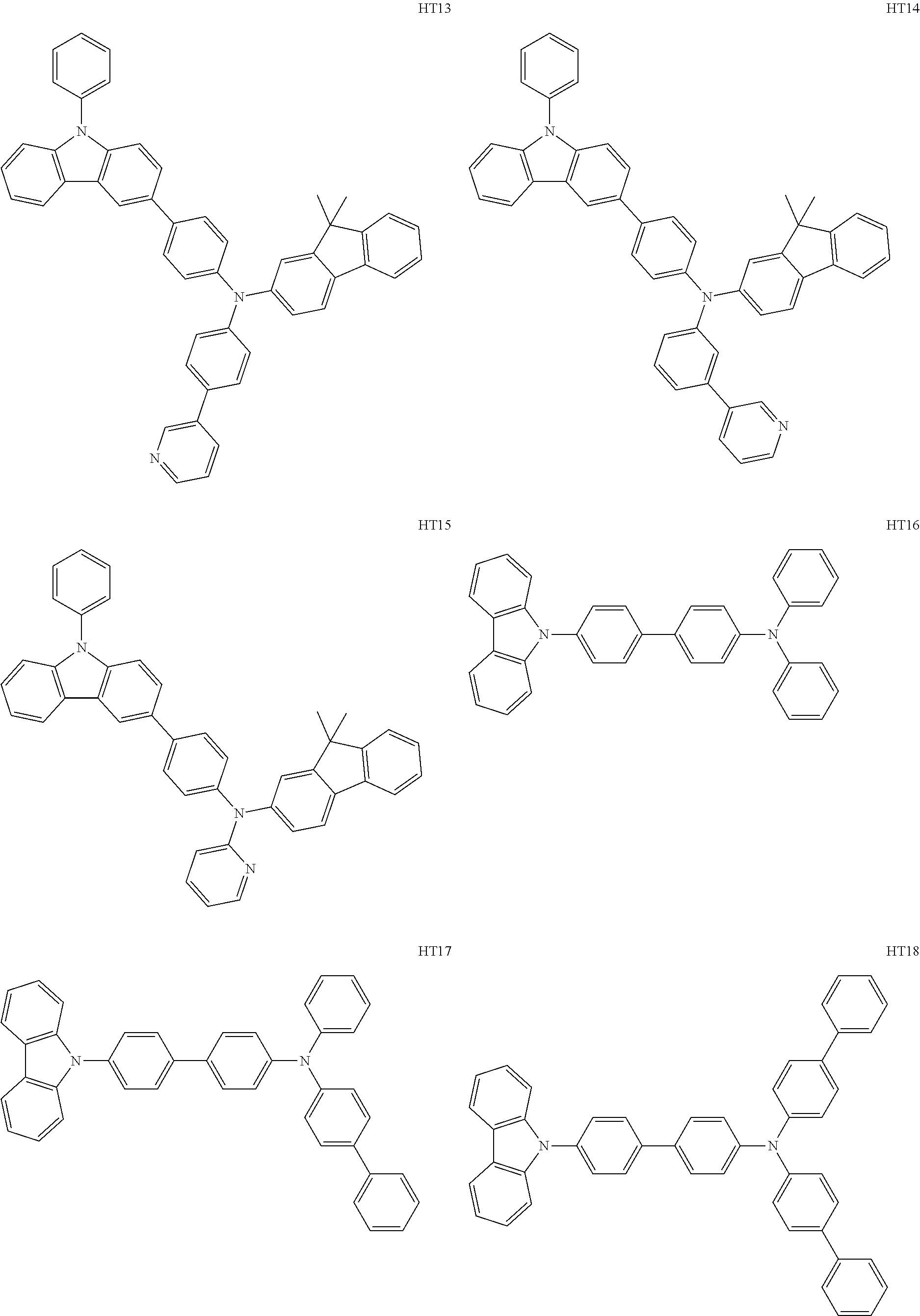 [SMILES: CC1(C)c2ccccc2-c2ccc(N(c3ccc(-c4cccnc4)cc3)c3ccc(-c4ccc5c(c4)c4ccccc4n5-c4ccccc4)cc3)cc21 ; CC1(C)c2ccccc2-c2ccc(N(c3ccc(-c4ccc5c(c4)c4ccccc4n5-c4ccccc4)cc3)c3cccc(-c4cccnc4)c3)cc21 ; CC1(C)c2ccccc2-c2ccc(N(c3ccc(-c4ccc5c(c4)c4ccccc4n5-c4ccccc4)cc3)c3ccccn3)cc21 ; c1ccc(N(c2ccccc2)c2ccc(-c3ccc(-n4c5ccccc5c5ccccc54)cc3)cc2)cc1 ; c1ccc(-c2ccc(N(c3ccccc3)c3ccc(-c4ccc(-n5c6ccccc6c6ccccc65)cc4)cc3)cc2)cc1 ; c1ccc(-c2ccc(N(c3ccc(-c4ccccc4)cc3)c3ccc(-c4ccc(-n5c6ccccc6c6ccccc65)cc4)cc3)cc2)cc1]

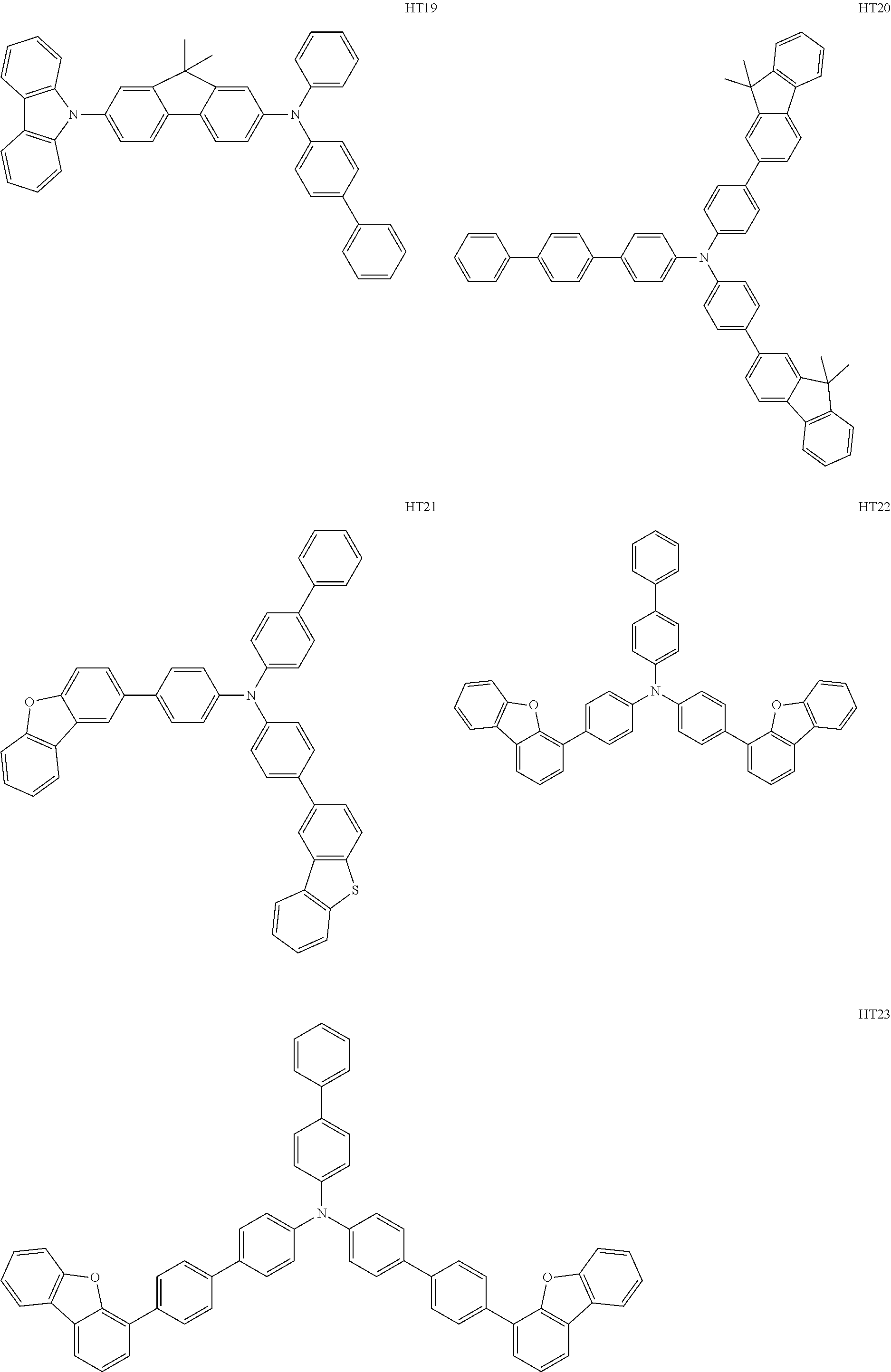 [SMILES: CC1(C)c2cc(N(c3ccccc3)c3ccc(-c4ccccc4)cc3)ccc2-c2ccc(-n3c4ccccc4c4ccccc43)cc21 ; CC1(C)c2ccccc2-c2ccc(-c3ccc(N(c4ccc(-c5ccc(-c6ccccc6)cc5)cc4)c4ccc(-c5ccc6c(c5)C(C)(C)c5ccccc5-6)cc4)cc3)cc21 ; c1ccc(-c2ccc(N(c3ccc(-c4ccc5oc6ccccc6c5c4)cc3)c3ccc(-c4ccc5sc6ccccc6c5c4)cc3)cc2)cc1 ; c1ccc(-c2ccc(N(c3ccc(-c4cccc5c4oc4ccccc45)cc3)c3ccc(-c4cccc5c4oc4ccccc45)cc3)cc2)cc1 ; c1ccc(-c2ccc(N(c3ccc(-c4ccc(-c5cccc6c5oc5ccccc56)cc4)cc3)c3ccc(-c4ccc(-c5cccc6c5oc5ccccc56)cc4)cc3)cc2)cc1]

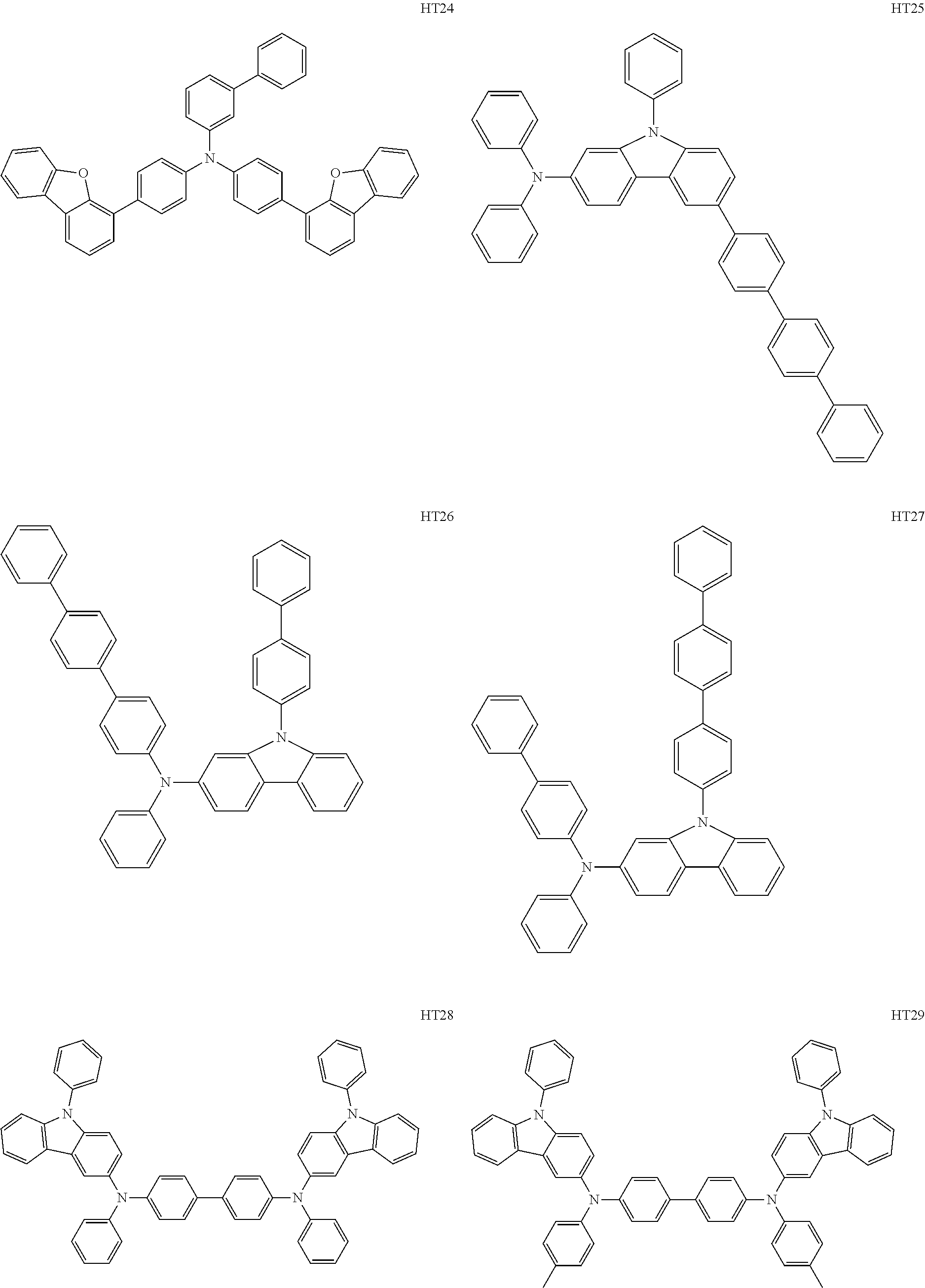

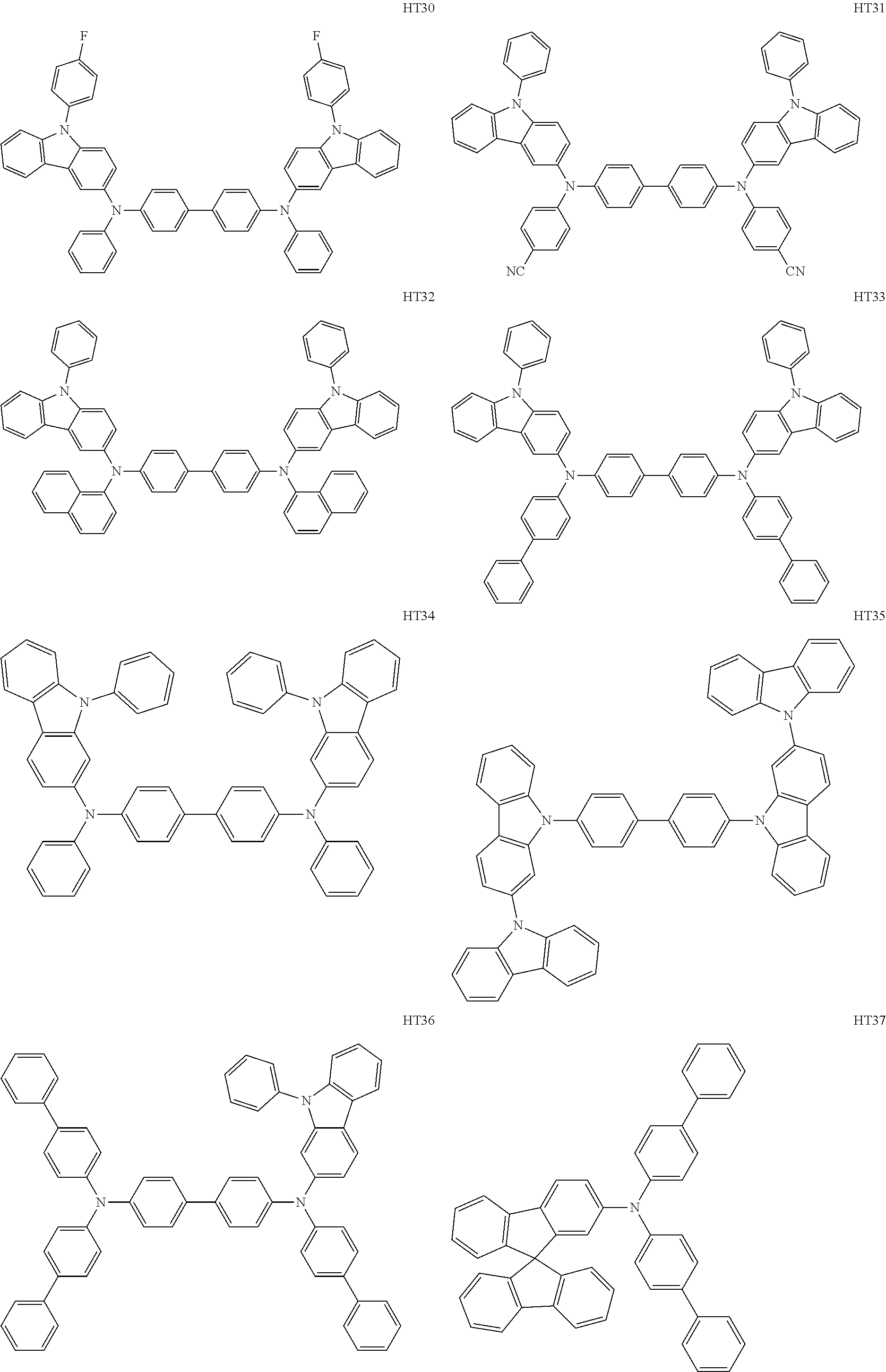

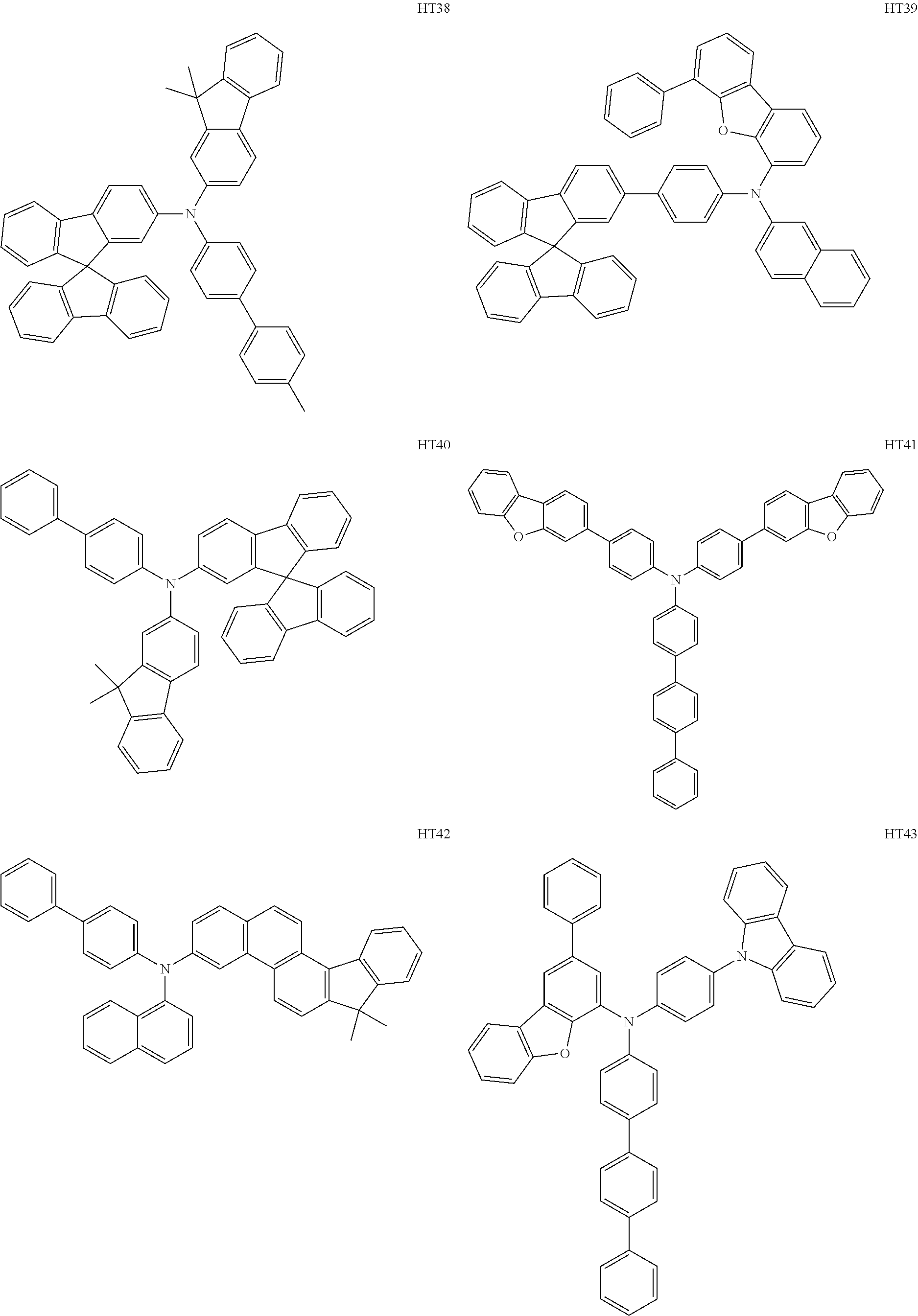

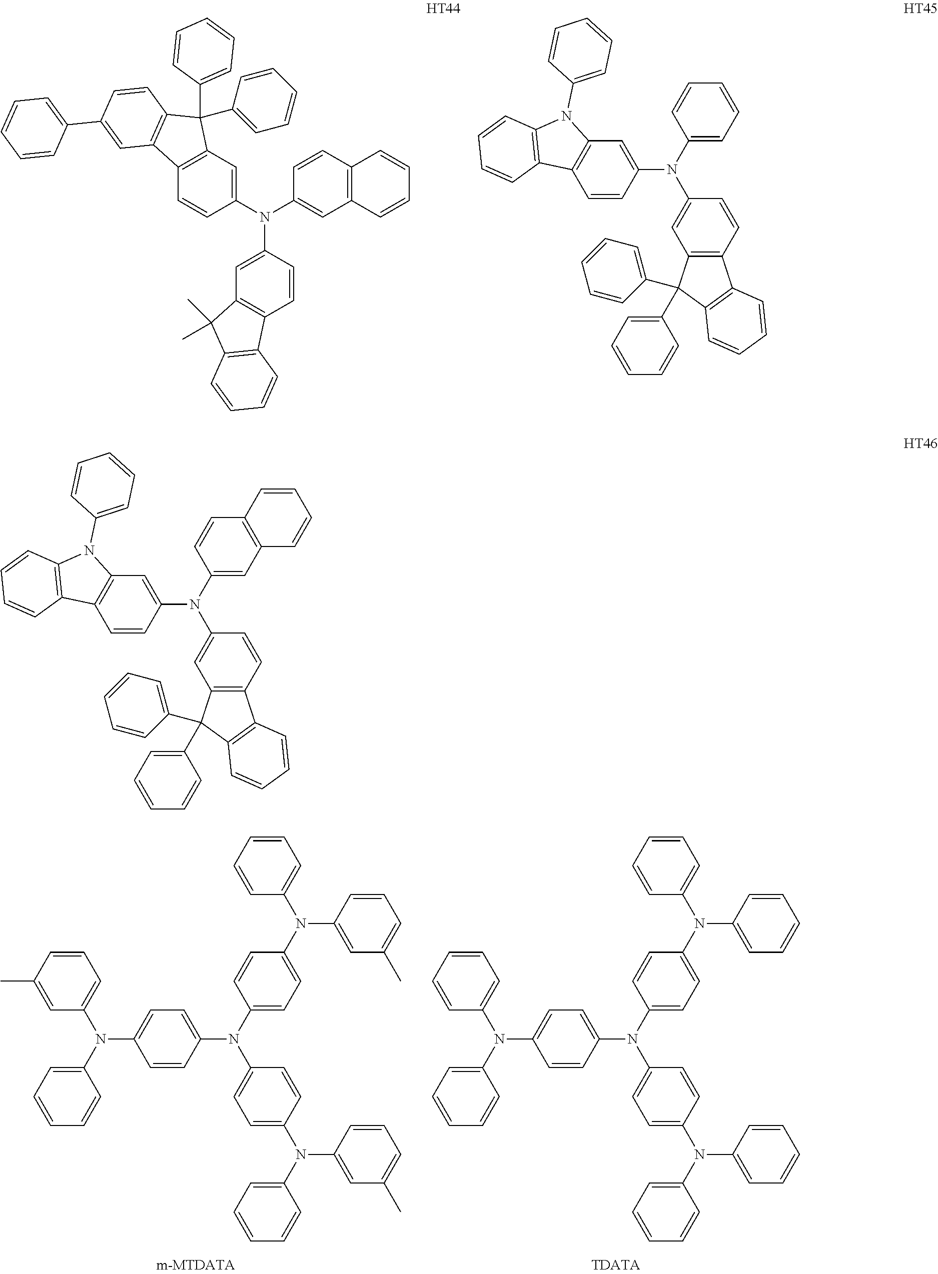

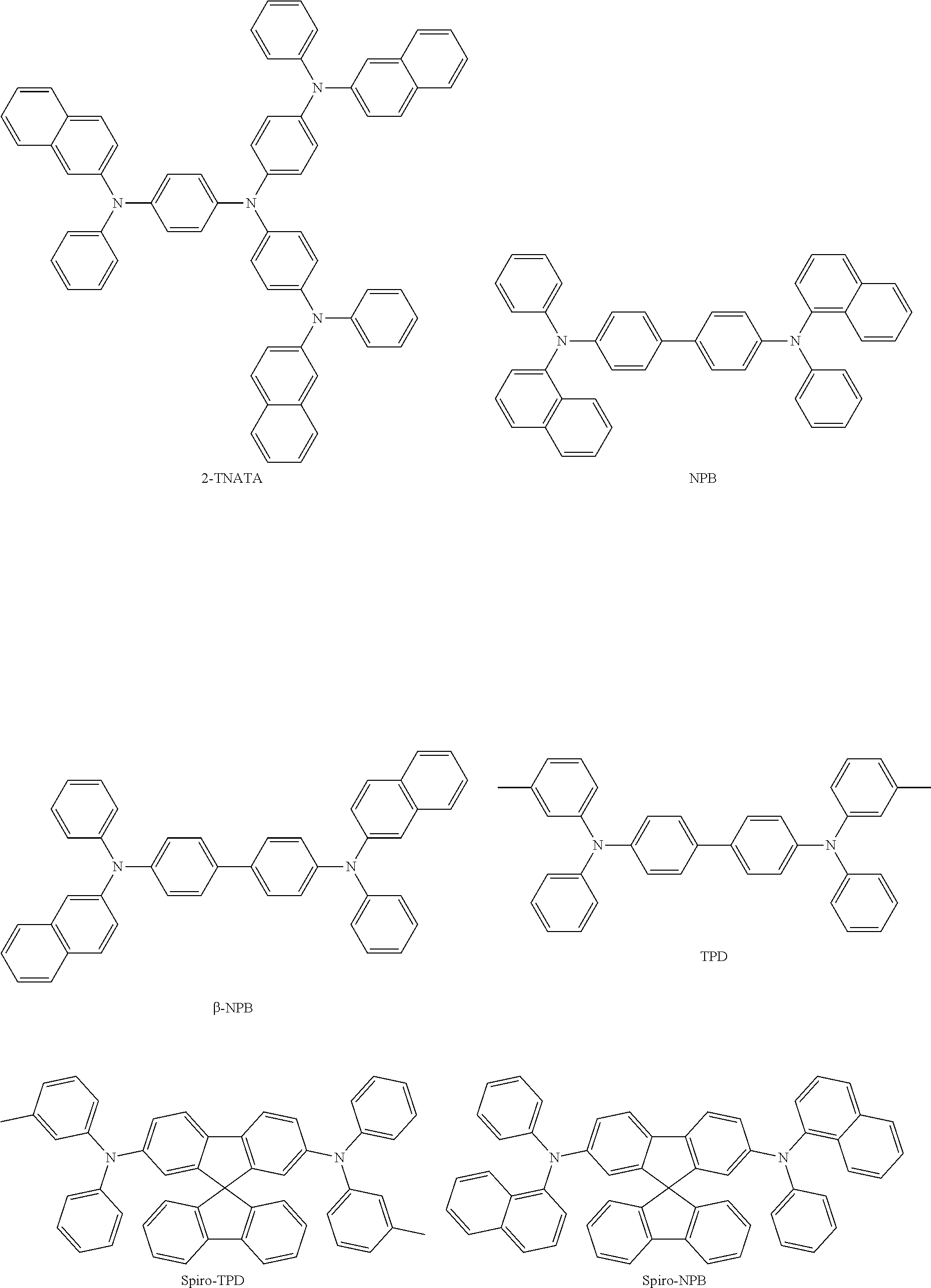

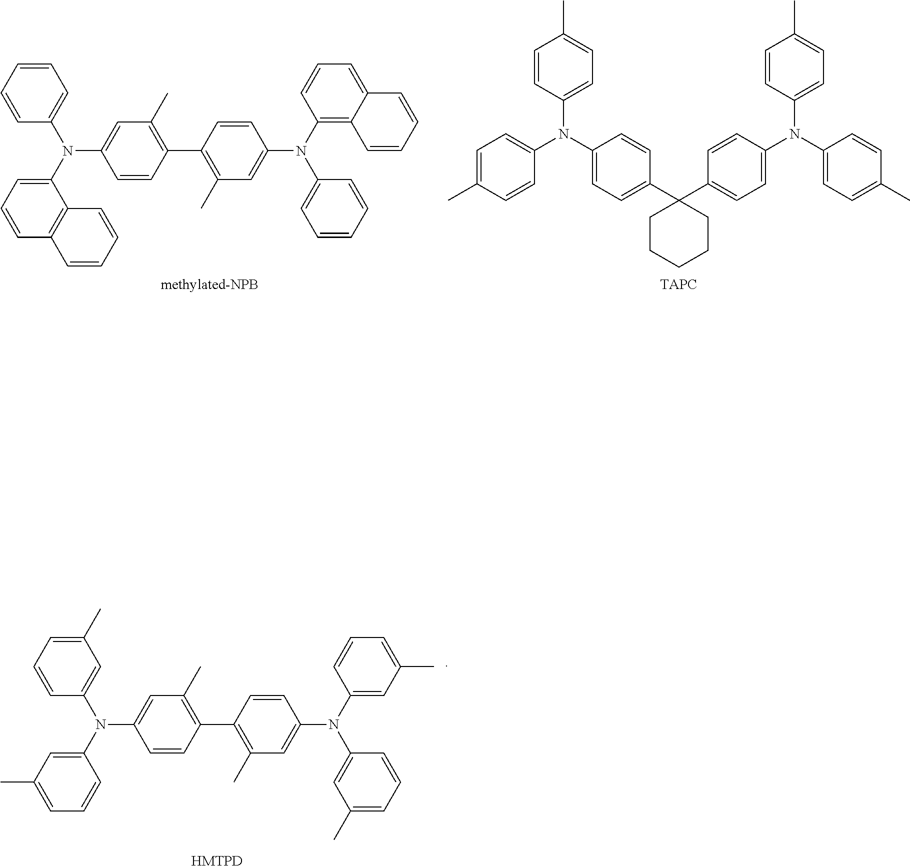

A thickness of the hole transport region may be from about 50 Angstroms (Å) to about 10000 Å, for example, from about 100 Å to about 4000 Å. When the hole transport region includes a hole injection layer, a hole transport layer, or any combination thereof, a thickness of the hole injection layer may be from about 100 Å to about 9000 Å, for example, from about 100 Å to about 1000 Å, and a thickness of the hole transport layer may be from about 50 Å to about 2000 Å, for example, from about 100 Å to about 1500 Å. When the thicknesses of the hole transport region, the hole injection layer, and the hole transport layer satisfy the aforementioned ranges, satisfactory hole transport characteristics may be obtained without a substantial increase in driving voltage.

The emission auxiliary layer is a layer that serves to increase light emission efficiency by compensating for the optical resonance distance according to the wavelength of light emitted from the emission layer, and the electron blocking layer is a layer that serves to prevent or reduce electron leakage from the emission layer to the hole transport region. A material that may be included in the hole transport region described above may be included in the emission auxiliary layer and the electron blocking layer.

p-Dopant

In one or more embodiments, the hole transport region may include a charge-generating material in addition to one or more of the materials described above to improve conductivity. The charge-generating material may be uniformly (e.g., substantially uniformly) or non-uniformly dispersed (for example, in a form of a single-layer including (e.g., consisting of) the charge-generating material) within the hole transport region.

The charge-generating material may be, for example, a p-dopant.

For example, in one or more embodiments, the lowest unoccupied molecular orbital (LUMO) energy level of the p-dopant may be −3.5 eV or less.

According to one or more embodiments, the p-dopant may include a quinone derivative, a cyano group-containing compound, an element EL1 and an element EL2-containing compound, or any combination thereof.

Non-limiting examples of the quinone derivatives may include tetracyanoquinodimethane (TCNQ), 2,3,5,6-tetrafluoro-7,7,8,8-tetracyanoquinodimethane (F4-TCNQ), and/or the like.

Non-limiting examples of the cyano group-containing compounds may include dipyrazino[2,3-f: 2′,3′-h]quinoxaline-2,3,6,7,10,11-hexacarbonitrile (HAT-CN), a compound represented by Formula 221, and/or the like.

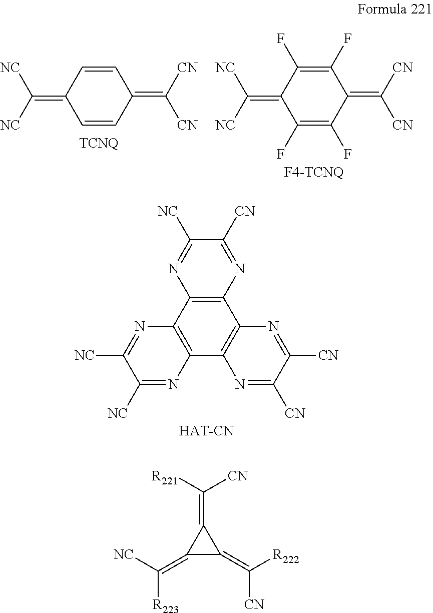

In Formula 221,
R₂₂₁ to R₂₂₃ may each independently be a C₃-C₆₀ carbocyclic group substituted or unsubstituted with at least one R₁₀ₐ or a C₁-C₆₀ heterocyclic group substituted or unsubstituted with at least one R₁₀ₐ, and
at least one selected from among the R₂₂₁ to R₂₂₃ may each independently be a C₃-C₆₀ carbocyclic group or a C₁-C₆₀ heterocyclic group substituted with a cyano group; —F; —CI; —Br; —I; a C₁-C₂₀ alkyl group substituted with a cyano group, —F, —Cl, —Br, —I, or any combination thereof; or any combination thereof.

In the element EL1 and element EL2-containing compounds, element EL1 may be a metal, a metalloid, or a (e.g., any suitable) combination thereof, and element EL2 may be a non-metal, a metalloid, or a (e.g., any suitable) combination thereof.

Non-limiting examples of the metal may include an alkali metal (for example, lithium (Li), sodium (Na), potassium (K), rubidium (Rb), cesium (Cs), and/or the like); an alkaline earth metal (for example, beryllium (Be), magnesium (Mg), calcium (Ca), strontium (Sr), barium (Ba), and/or the like); a transition metal (for example, titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), and/or the like); a post-transition metal (for example, zinc (Zn), indium (In), tin (Sn), and/or the like); a lanthanide metal (for example, lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and/or the like); and/or the like.

Non-limiting examples of the metalloid may include silicon (Si), antimony (Sb), tellurium (Te), and/or the like.

Non-limiting examples of the non-metal may include an oxygen (O), a halogen (for example, F, Cl, Br, I, and/or the like), and/or the like.

For example, the element EL1 and element EL2-containing compound may include a metal oxide, a metal halide (for example, a metal fluoride, a metal chloride, a metal bromide, a metal iodide, and/or the like), a metalloid halide (for example, a metalloid fluoride, a metalloid chloride, a metalloid bromide, a metalloid iodide, and/or the like), a metal telluride, or any combination thereof.

Non-limiting examples of the metal oxide may include a tungsten oxide (for example, WO, W₂O₃, WO₂, WO₃, W₂O₅, and/or the like), a vanadium oxide (for example, VO, V₂O₃, VO₂, V₂O₅, and/or the like), a molybdenum oxide (MoO, Mo₂O₃, MoO₂, MoO₃, Mo₂O₅, and/or the like), a rhenium oxide (for example, ReO₃, and/or the like), and/or the like.

Non-limiting examples of the metal halide may include an alkali metal halide, an alkaline earth metal halide, a transition metal halide, a post-transition metal halide, a lanthanide metal halide, and/or the like.

Non-limiting examples of the alkali metal halide may include LiF, NaF, KF, RbF, CsF, LiCl, NaCl, KCl, RbCl, CsCl, LiBr, NaBr, KBr, RbBr, CsBr, LiI, NaI, KI, RbI, CsI, and/or the like.

Non-limiting examples of the alkaline earth metal halide may include BeF₂, MgF₂, CaF₂, SrF₂, BaF₂, BeCl₂, MgCl₂, CaCl₂), SrCl₂, BaCl₂, BeBr₂, MgBr₂, CaBr₂, SrBr₂, BaBr₂, BeI₂, MgI₂, CaI₂, SrI₂, BaI₂, and/or the like.

Non-limiting examples of the transition metal halide may include a titanium halide (for example, TiF₄, TiCl₄, TiBr₄, TiI₄, and/or the like), a zirconium halide (for example, ZrF₄, ZrCl₄, ZrBr₄, ZrI₄, and/or the like), a hafnium halide (for example, HfF₄, HfCl₄, HfBr₄, HfI₄, and/or the like), a vanadium halide (for example, VF₃, VCl₃, VBr₃, VI₃, and/or the like, a niobium halide (for example, NbF₃, NbCl₃, NbBr₃, NbI₃, and/or the like), a tantalum halide (for example, TaF₃, TaCl₃, TaBr₃, TaI₃, and/or the like), a chromium halide (for example, CrF₃, CrCl₃, CrBr₃, CrI₃, and/or the like), a molybdenum halide (for example, MoF₃, MoCl₃, MoBr₃, MoI₃, and/or the like), a tungsten halide (for example, WF₃, WCl₃, WBr₃, WI₃, and/or the like), a manganese halide (for example, MnF₂, MnCl₂, MnBr₂, MnI₂, and/or the like), a technetium halide (for example, TcF₂, TcCl₂, TcBr₂, TcI₂, and/or the like), a rhenium halide (for example, ReF₂, ReCl₂, ReBr₂, ReI₂, and/or the like), an iron(II) halide (for example, FeF₂, FeCl₂, FeBr₂, FeI₂, and/or the like), a ruthenium halide (for example, RuF₂, RuCl₂, RuBr₂, RuI₂, and/or the like), an osmium halide (for example, OsF₂, OsCl₂, OsBr₂, OsI₂, and/or the like), a cobalt halide (for example, CoF₂, CoCl₂, CoBr₂, CoI₂, and/or the like), a rhodium halide (for example, RhF₂, RhCl₂, RhBr₂, RhI₂, and/or the like), an iridium halide (for example, IrF₂, IrCl₂, IrBr₂, IrI₂, and/or the like), a nickel halide (for example, NiF₂, NiCl₂, NiBr₂, NiI₂, and/or the like), a palladium halide (for example, PdF₂, PdCl₂, PdBr₂, PdI₂, and/or the like), a platinum halide (for example, PtF₂, PtCl₂, PtBr₂, PtI₂, and/or the like), a copper(I) halide (for example, CuF, CuCl, CuBr, CuI, and/or the like), a silver halide (for example, AgF, AgCl, AgBr, Agl, and/or the like), a gold halide (for example, AuF, AuCl, AuBr, Aul, and/or the like), and/or the like.

Non-limiting examples of the post-transition metal halide may include a zinc halide (for example, ZnF₂, ZnCl₂, ZnBr₂, ZnI₂, and/or the like), an indium halide (for example, InI₃, and/or the like), a tin halide (for example, SnI₂, and/or the like), and/or the like.

Non-limiting examples of the lanthanide metal halide may include YbF, YbF₂, YbF₃, SmF₃, YbCl, YbCl₂, YbCl₃, SmCl₃, YbBr, YbBr₂, YbBr₃, SmBr₃, YbI, YbI₂, YbI₃, SmI₃, and/or the like.

Non-limiting examples of the metalloid halide may include an antimony halide (for example, SbCl₅, and/or the like), and/or the like.

Non-limiting examples of the metal telluride may include an alkali metal telluride (for example, Li₂Te, Na₂Te, K₂Te, Rb₂Te, Cs₂Te, and/or the like), an alkaline earth metal telluride (for example, BeTe, MgTe, CaTe, SrTe, BaTe, and/or the like), a transition metal telluride (for example, TiTe₂, ZrTe₂, HfTe₂, V₂Te₃, Nb₂Te₃, Ta₂Te₃, Cr₂Te₃, Mo₂Te₃, W₂Te₃, MnTe, TcTe, ReTe, FeTe, RuTe, OsTe, CoTe, RhTe, IrTe, NiTe, PdTe, PtTe, Cu₂Te, CuTe, Ag₂Te, AgTe, Au₂Te, and/or the like), a post-transition metal telluride (for example, ZnTe, and/or the like), a lanthanide metal telluride (for example, LaTe, CeTe, PrTe, NdTe, PmTe, EuTe, GdTe, TbTe, DyTe, HoTe, ErTe, TmTe, YbTe, LuTe, and/or the like), and/or the like.

### Emission Layer in Intermediate Layer 130

When the light-emitting element 1A is a full-color light-emitting element, the emission layer may be patterned into a red emission layer, a green emission layer, and/or a blue emission layer for each individual sub-pixel. In one or more embodiments, the emission layer may have a structure in which two or more layers selected from among a red emission layer, a green emission layer, and a blue emission layer are stacked in contact with or spaced and/or apart (e.g., spaced apart or separated) from each other, or a structure in which two or more materials selected from among a red light-emitting material, a green light-emitting material, and a blue light-emitting material are mixed without layer distinction, thereby emitting white light (e.g., combined white light).

The emission layer may include a quantum dot, for example, the quantum dot of present disclosure.

As used herein, the quantum dot refers to a crystal of a semiconductor compound and may include any material that may be to emit light of one or more suitable emission wavelengths depending on the size of the crystal. The quantum dot may be to emit light of one or more suitable emission wavelengths by controlling an element ratio in the quantum dot compound.

The diameter of the quantum dot may be, for example, about 1 nm to about 10 nm.

The quantum dot may be synthesized by a wet chemical process, a metal organic chemical vapor deposition process, a molecular beam epitaxy process, or a similar process.

The wet chemical process is a method of growing a quantum dot particle crystal by mixing an organic solvent and a precursor material of the quantum dot.

During crystal growth, the organic solvent naturally acts as a dispersing agent coordinated to the surface of the quantum dot crystal and controls the growth of the crystal, so the growth of the quantum dot particle may be controlled or selected through a process that is easier and less expensive than vapor deposition methods such as metal organic chemical vapor deposition (MOCVD) or molecular beam epitaxy (MBE), and/or the like.

The quantum dot may include a Group II-VI semiconductor compound; a Group III-V semiconductor compound; a Group III-VI semiconductor compound; a Group I-III-VI semiconductor compound; a Group IV-VI semiconductor compound; a Group IV element or compound; or any combination thereof.

Non-limiting examples of the Group II-VI semiconductor compound may include a binary compound such as CdS, CdSe, CdTe, ZnS, ZnSe, ZnTe, ZnO, HgS, HgSe, HgTe, MgSe, MgS, and/or the like; a ternary compound such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and/or the like; a quaternary compound such as CdZnSeS, CdZnSeTe, CdZnSTe, CdHgSeS, CdHgSeTe, CdHgSTe, HgZnSeS, HgZnSeTe, HgZnSTe, and/or the like; or any combination thereof.

Non-limiting examples of the Group III-V semiconductor compound may include a binary compound such as GaN, GaP, GaAs, GaSb, AlN, AlP, AlAs, AlSb, InN, InP, InAs, InSb, and/or the like; a ternary compound such as GaNP, GaNAs, GaNSb, GaPAs, GaPSb, AlNP, AlNAs, AlNSb, AlPAs, AlPSb, InGaP, InNP, InAlP, InNAs, InNSb, InPAs, InPSb, GaAlNP, and/or the like; a quaternary compound such as GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and/or the like; or any combination thereof. In one or more embodiments, the Group III-V semiconductor compound may further include a Group II element. Non-limiting examples of the Group III-V semiconductor compound further including the Group II element may include InZnP, InGaZnP, InAlZnP, and/or the like.

Non-limiting examples of the Group III-VI semiconductor compound may include a binary compound such as GaS, GaSe, Ga₂Se₃, GaTe, InS, InSe, In₂S₃, In₂Se₃, InTe, and/or the like; a ternary compound such as InGaS₃, InGaSe₃, and/or the like; or any combination thereof.

Non-limiting examples of the Group I-III-VI semiconductor compound may include a ternary compound such as AgInS, AgInS₂, AgInSe₂, AgGaS, AgGaS₂, AgGaSe₂, CuInS, CuInS₂, CuInSe₂, CuGaS₂, CuGaSe₂, CuGaO₂, AgGaO₂, AgAlO₂, and/or the like; a quaternary compound such as AgInGaS₂, AgInGaSe₂, CuInGaS₂, CuInGaSe₂, and/or the like; or any combination thereof.

Non-limiting examples of the Group IV-VI semiconductor compound may include a binary compound such as SnS, SnSe, SnTe, PbS, PbSe, PbTe, and/or the like; a ternary compound such as SnSeS, SnSeTe, SnSTe, PbSeS, PbSeTe, PbSTe, SnPbS, SnPbSe, SnPbTe, and/or the like; a quaternary compound such as SnPbSSe, SnPbSeTe, SnPbSTe, and/or the like; or any combination thereof.

Non-limiting examples of the Group IV element or compound may include a single-element compound such as Si, Ge, and/or the like; a binary compound such as SiC, SiGe, and/or the like; or any combination thereof.

Each element included in the multi-element compound, such as a binary compound, a ternary compound, and a quaternary compound, may exist within the particle in a substantially uniform concentration or non-uniform concentration. For example, the formula refers to the type (kind) of elements included in the compound, and an element ratio within the compound may vary. For example, AgInGaS₂ may refer to AgInₓGa₁₋ₓS₂ (where x is a real number between about 0 and about 1). Furthermore, CuInGaS₂ may refer to CuInₓGa₁₋ₓS₂ (where x is a real number between about 0 and about 1).

In one or more embodiments, the quantum dot may have a single structure in which the concentration of each element included in the corresponding quantum dot is substantially uniform or a core-shell dual structure. For example, a material included in the core and a material included in the shell may be different from each other.

The shell of the quantum dot may serve as a protective layer to maintain semiconductor properties by preventing or reducing chemical modification of the core and/or as a charging layer to impart electrophoretic properties to the quantum dot. The shell may be a single layer or multiple layers. In one or more embodiments, an interface between the core and the shell may have a concentration gradient in which the concentration of elements present in the shell decreases toward the center.

Examples of the shell of the quantum dot may be an oxide of metals, semimetals, or non-metals, a semiconductor compound, or one or more (e.g., any suitable) combinations thereof, and/or the like. Non-limiting examples of the oxide of metals, semimetals, or non-metals may include a binary compound such as SiO₂, Al₂O₃, TiO₂, ZnO, MnO, Mn₂O₃, Mn₃O₄, CuO, FeO, Fe₂O₃, Fe₃O₄, CoO, Co₃O₄, NiO, and/or the like; a ternary compound such as MgAl₂O₄, CoFe₂O₄, NiFe₂O₄, CoMn₂O₄, and/or the like; or any combination thereof. Examples of the semiconductor compound may include the Group II-VI semiconductor compound; the Group III-V semiconductor compound; the Group III-VI semiconductor compound; the Group I-III-VI semiconductor compound; the Group IV-VI semiconductor compound; or any combination thereof, as disclosed herein. For example, the semiconductor compound suitable as a shell may include CdS, CdSe, CdTe, ZnS, ZnSe, ZnTe, ZnSeS, ZnTeS, GaAs, GaP, GaSb, HgS, HgSe, HgTe, InAs, InP, InGaP, InSb, AlAs, AlP, AlSb, or any combination thereof.

Each element included in the multi-element compound, such as a binary compound, a ternary compound, may exist within the particle in a substantially uniform concentration or non-uniform concentration. For example, the formula refers to the type (kind) of elements included in the compound, and the element ratio within the compound may vary.

The quantum dot may have a full width at half maximum (FWHM) of an emission spectrum of about 45 nm or less, about 40 nm or less, or about 30 nm or less, and color purity or color reproduction of the quantum dot may be improved in this range. Additionally, light emitted through these quantum dots is emitted in all directions, which may improve the viewing angle.

In one or more embodiments, a shape of the quantum dot may be a spherical nanoparticle, a pyramidal nanoparticle, a multi-arm nanoparticle, a cubic nanoparticle, a nano-tube, a nano-wire, a nano-fiber, a nano-platelet, and/or the like.

By adjusting the size of the quantum dot, the energy band gap of the quantum dot may be controlled or selected, so that light of one or more suitable wavelengths may be obtained from a quantum dot emission layer. Therefore, by using the quantum dot of different sizes, a light-emitting element that emit light of different wavelengths may be implemented. For example, the size of the quantum dots or the element ratio within the quantum dot compound may be selected to enable the quantum dots to emit red, green, and/or blue light. Furthermore, the quantum dots with suitable size may be configured such that light of one or more suitable colors is combined to emit white light.

The emission layer may be formed by applying an ink composition onto the hole transport region and volatilizing a portion or more of a solvent included in the ink composition.

The ink composition may be applied using an inkjet printing method, a spin coating method, a casting method, a micro gravure coating method, a gravure coating method, a bar coating method, a roll coating method, a wire bar coating method, a dip coating method, a spray coating method, a screen printing method, a flexographic printing method, an offset printing method, and/or the like.

Additionally, the emission layer may further include a host and a dopant in addition to the quantum dot. The dopant may include a phosphorescent dopant, a fluorescent dopant, or any combination thereof.

A content (e.g., amount) of the dopant in the emission layer may be about 0.01 to about 15 parts by weight with respect to 100 parts by weight of the host.

In one or more embodiments, the emission layer may include a delayed fluorescent material. The delayed fluorescent material may serve as a host or dopant in the emission layer.

A thickness of the emission layer may be from about 100 Å to about 1000 Å, for example from about 200 Å to about 600 Å. When the thickness of the emission layer satisfies the aforementioned range, excellent or suitable light-emitting characteristics may be exhibited without a substantial increase in driving voltage.

### Host

In one or more embodiments, the host may include a compound represented by Formula 301:

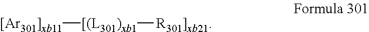

In Formula 301,

Ar₃₀₁ to L₃₀₁ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
xb11 may be 1, 2 or 3,
xb1 may be an integer from about 0 to about 5,
R₃₀₁ may be hydrogen, deuterium, —F, —Cl, —Br, —I, a hydroxyl group, a cyano group, a nitro group, a C₁-C₆₀ alkyl group substituted or unsubstituted with at least one R₁₀ₐ, a C₂-C₆₀ alkenyl group substituted or unsubstituted with at least one R₁₀ₐ, a C₂-C₆₀ alkynyl group substituted or unsubstituted with at least one R₁₀ₐ, a C₁-C₆₀ alkoxy group substituted or unsubstituted with at least one R₁₀ₐ, a C₃-C₆₀ carbocyclic group substituted or unsubstituted with at least one R₁₀ₐ, a C₁-C₆₀ heterocyclic group substituted or unsubstituted with at least one R₁₀ₐ, —Si(Q₃₀₁)(Q₃₀₂)(Q₃₀₃), —N(Q₃₀₁)(Q₃₀₂), —B(Q₃₀₁)(Q₃₀₂), —C(═O)(Q₃₀₁), —S(═O)₂(Q₃₀₁), or —P(═O)(Q₃₀₁)(Q₃₀₂),
xb21 may be an integer from about 1 to about 5,
the descriptions of Q₃₀₁ to Q₃₀₃ each refer to the description of Q₁ as described herein.

In one or more embodiments, if (e.g., when) xb11 in Formula 301 is two or greater, two or more Ar₃₀₁(s) may be connected to each other through a single bond.

In one or more embodiments, the host may include a compound represented by Formula 301-1, a compound represented by Formula 301-2, or any combination thereof:

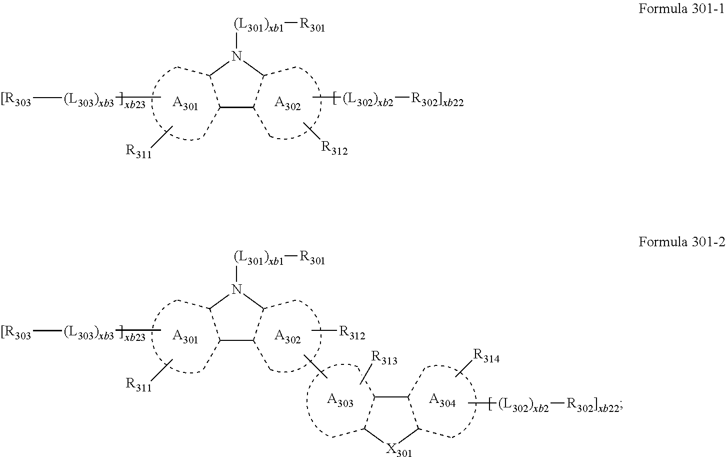

In Formulae 301-1 and 301-2,
ring A₃₀₁ to ring A₃₀₄ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
X₃₀₁ may be O, S, N[(L₃₀₄)_{4xb}-R₃₀₄], C(R₃₀₄)(R₃₀₅), or Si(R₃₀₄)(R₃₀₅),
xb22 and xb23 may each independently be, 0, 1, or 2,
the descriptions of L₃₀₁, xb1, and R₃₀₁ each refer to the descriptions herein,
the descriptions of L₃₀₂ to L₃₀₄ each independently refer to the description of L₃₀₁,
the descriptions of xb2 to xb4 each independently refer to the description of xb1,
the descriptions of R₃₀₂ to R₃₀₅ and R₃₁₁ to R₃₁₄ each refer to the description of R₃₀₁.

In one or more embodiments, the host may include an alkaline earth metal complex, a post-transition metal complex, or any combination thereof. For example, in one or more embodiments, the host may include a Be complex (for example, compound H55), an Mg complex, a Zn complex, or any combination thereof.

In one or more embodiments, the host may include at least one selected from among compounds H1 to H128, ADN (9,10-Di(2-naphthyl)anthracene), MADN (2-Methyl-9,10-bis(naphthalen-2-yl)anthracene), TBADN (9,10-di-(2-naphthyl)-2-t-butyl-anthracene), CBP (4,4′-bis(N-carbazolyl)-1,1′-biphenyl), mCP (1,3-di(carbazol-9-yl)benzene) TCP (1,3,5-tri(carbazol-9-yl)benzene), or any combination thereof:

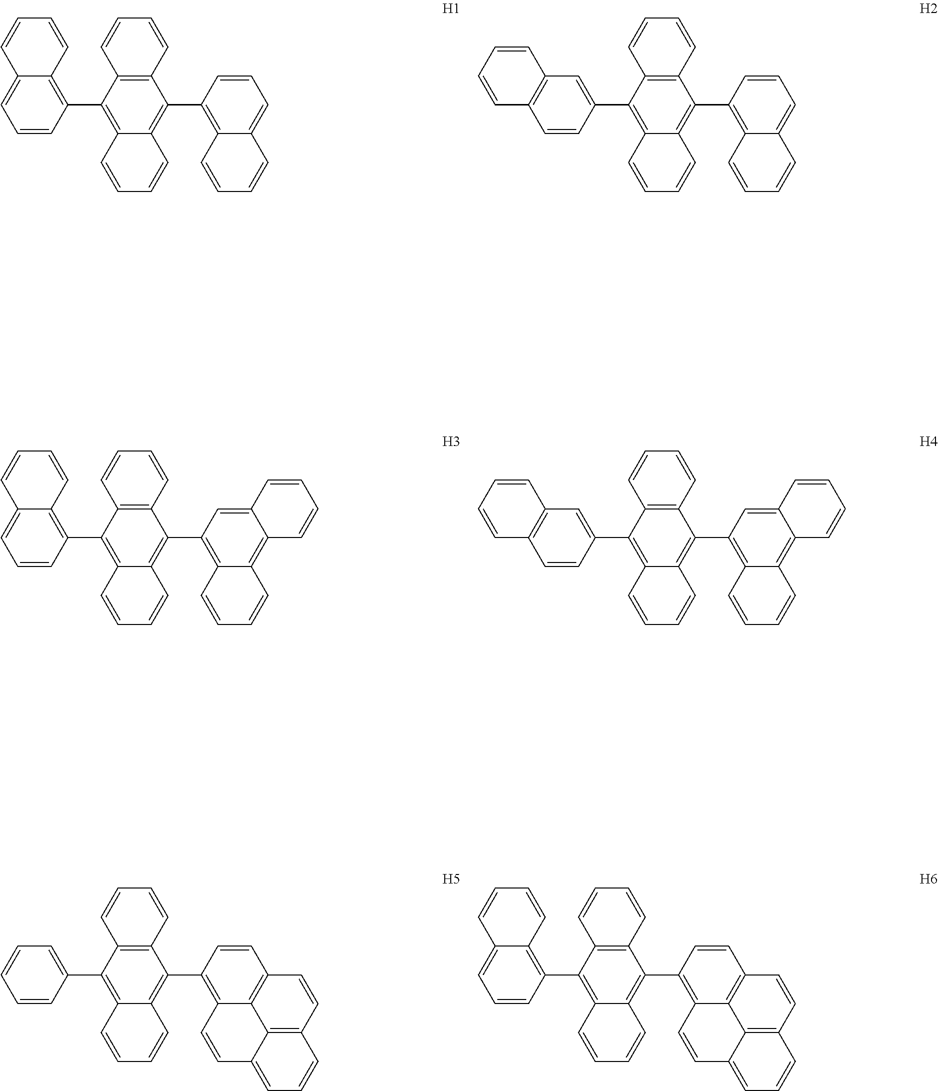

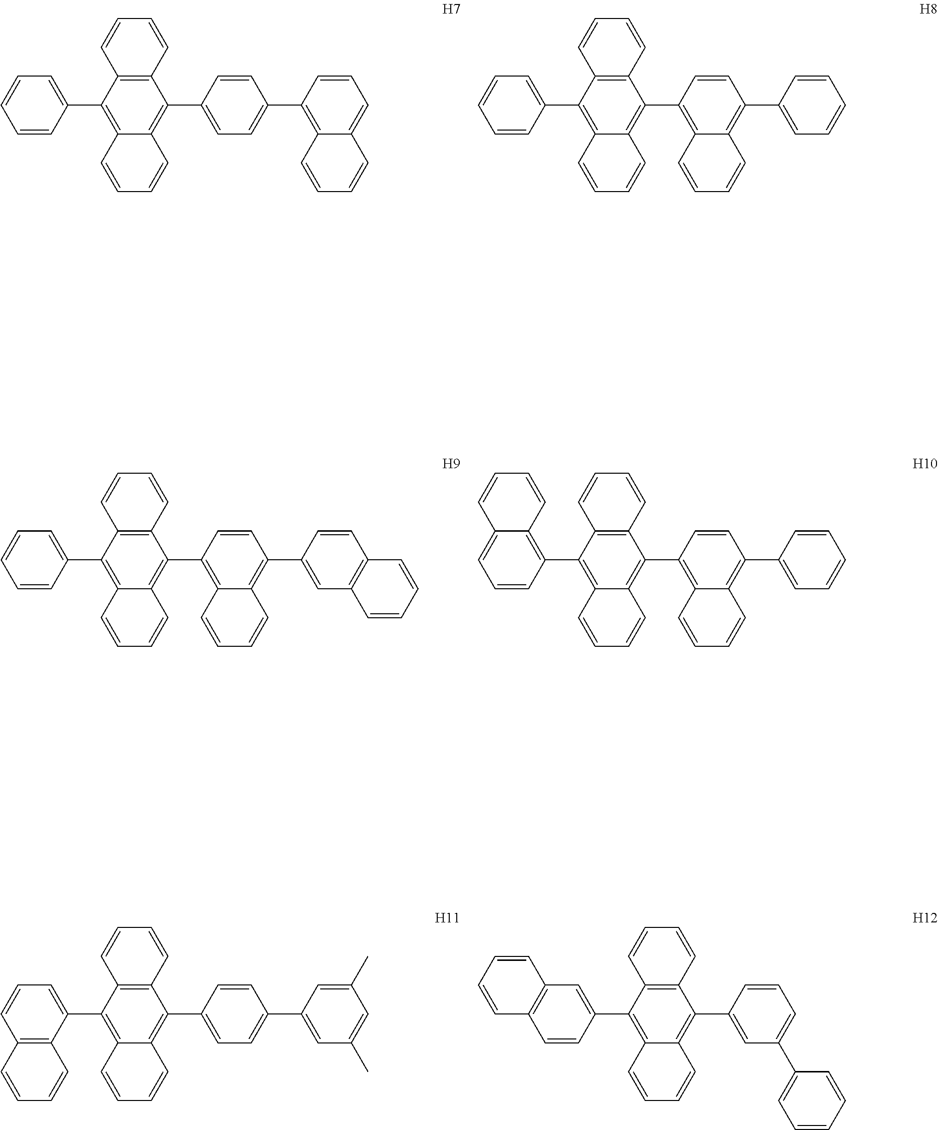

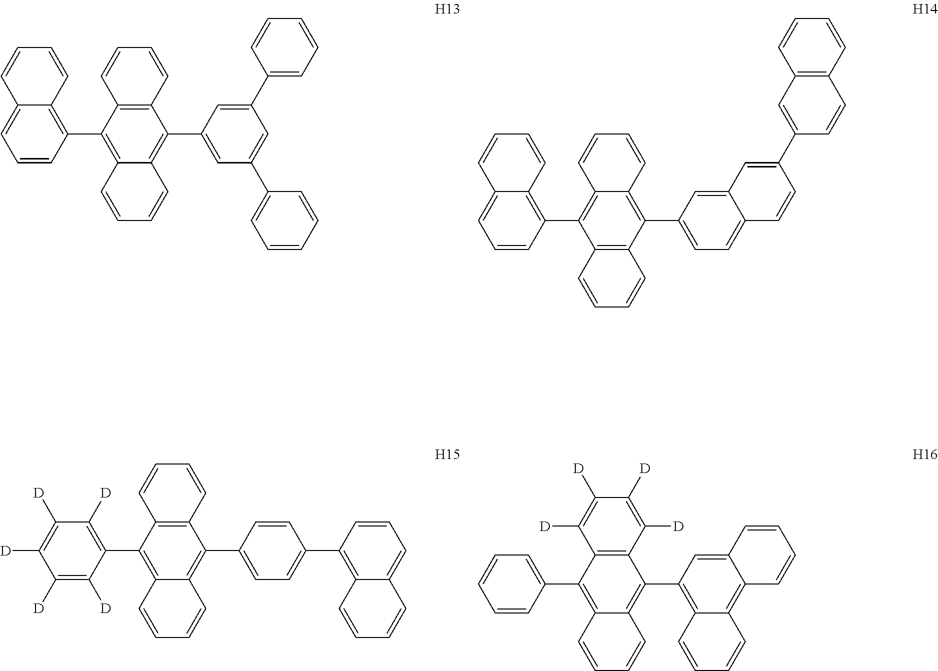

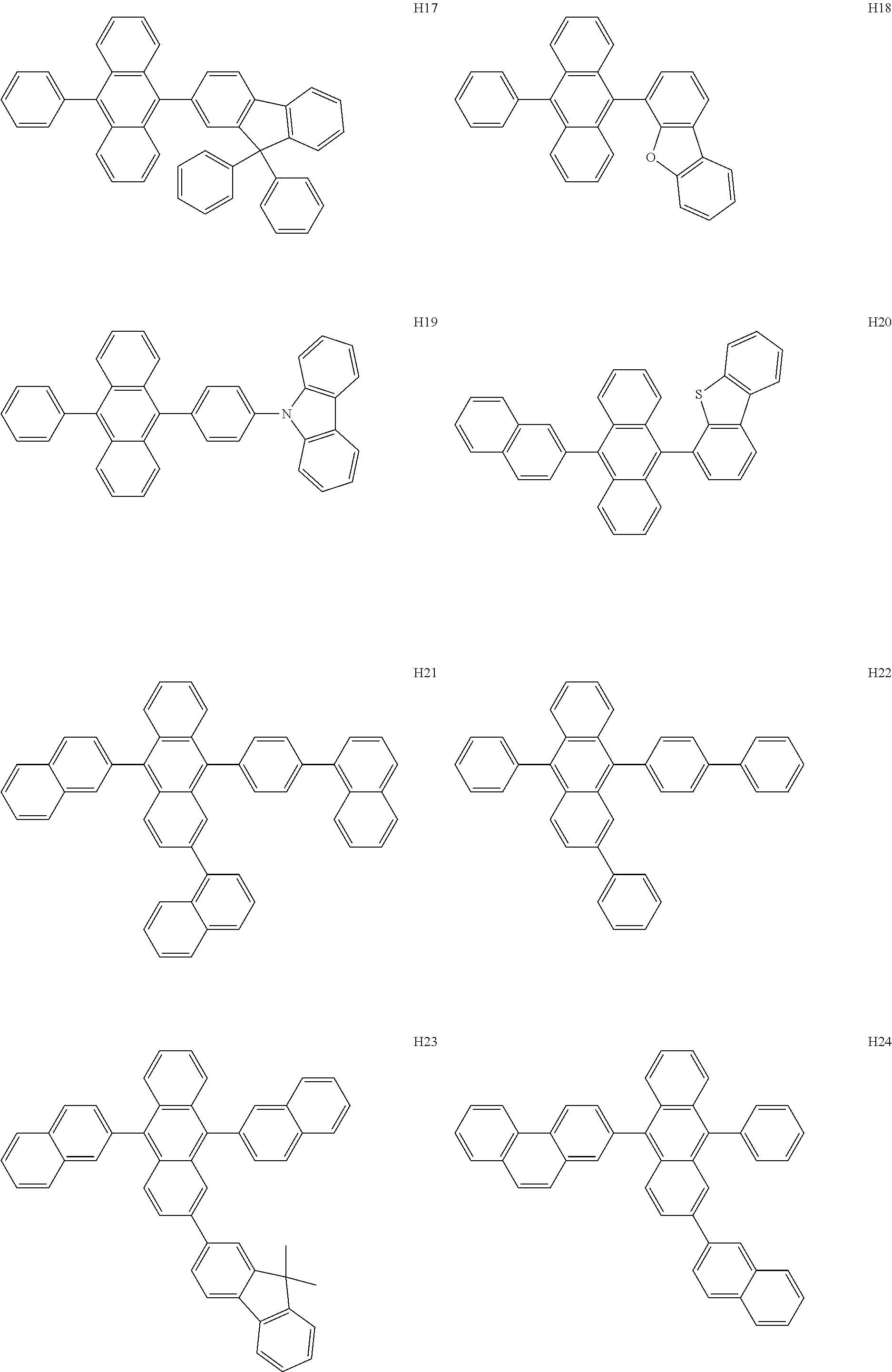

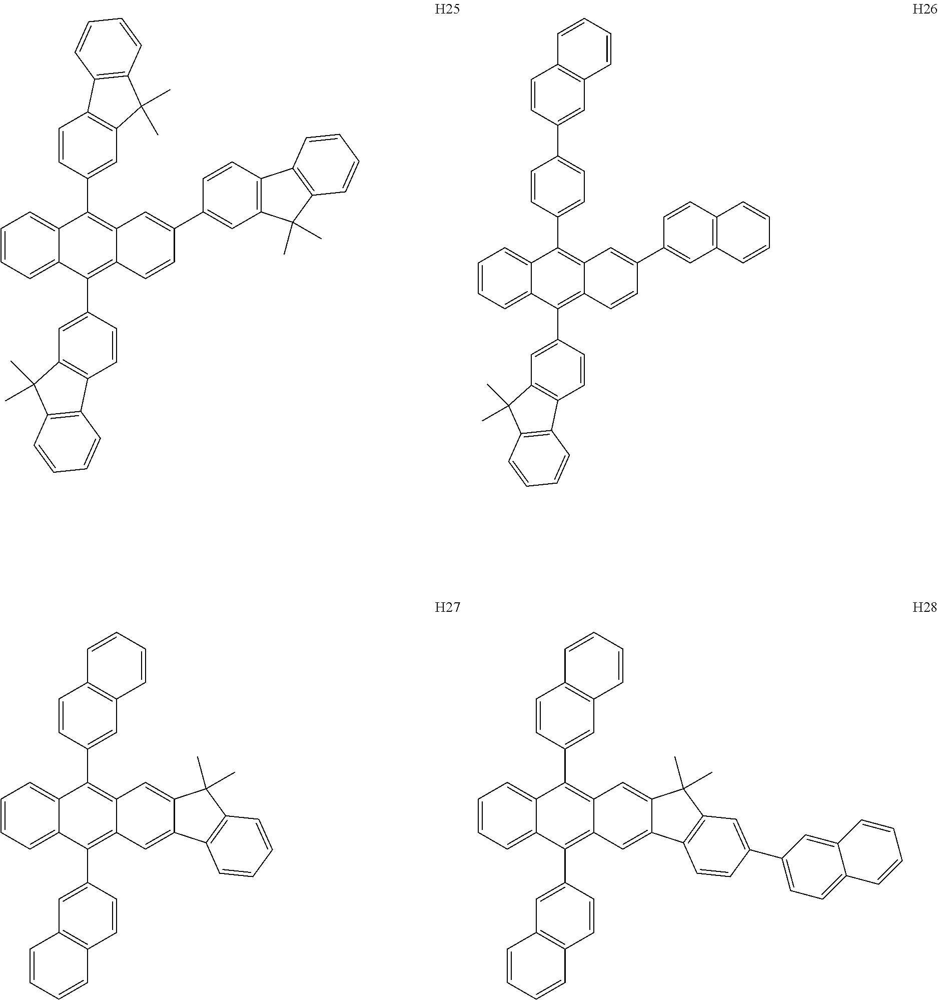

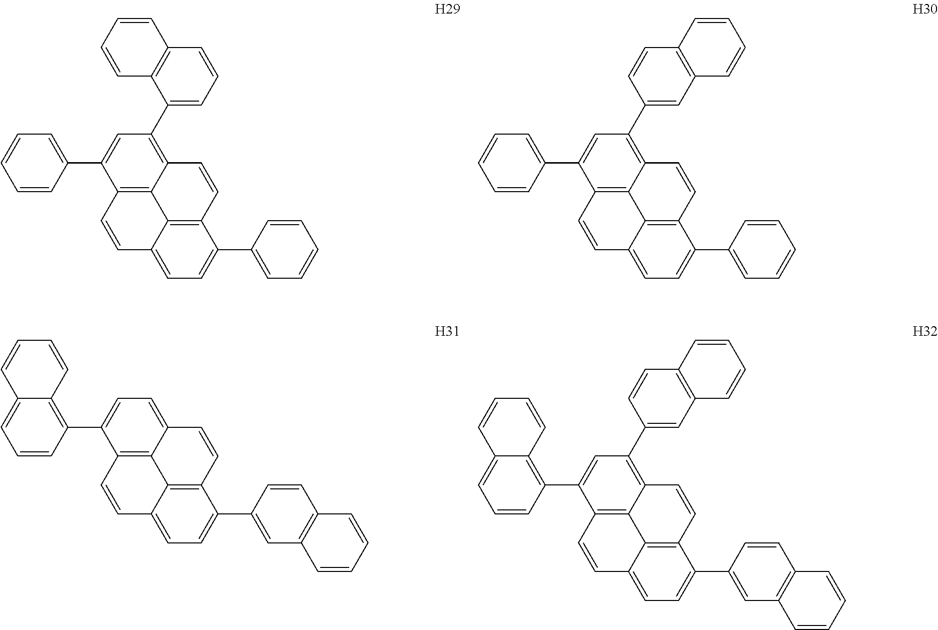

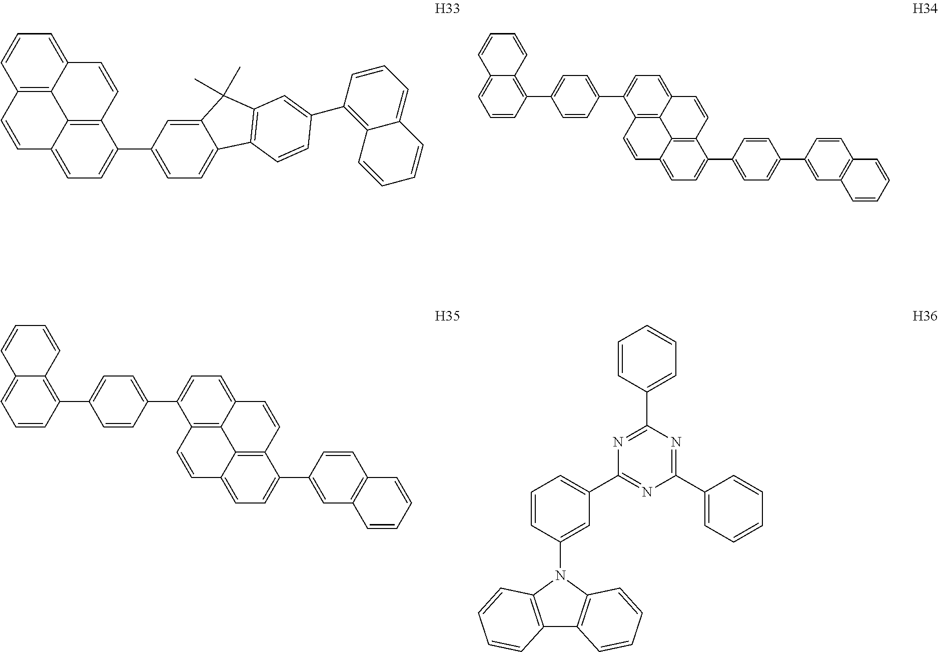

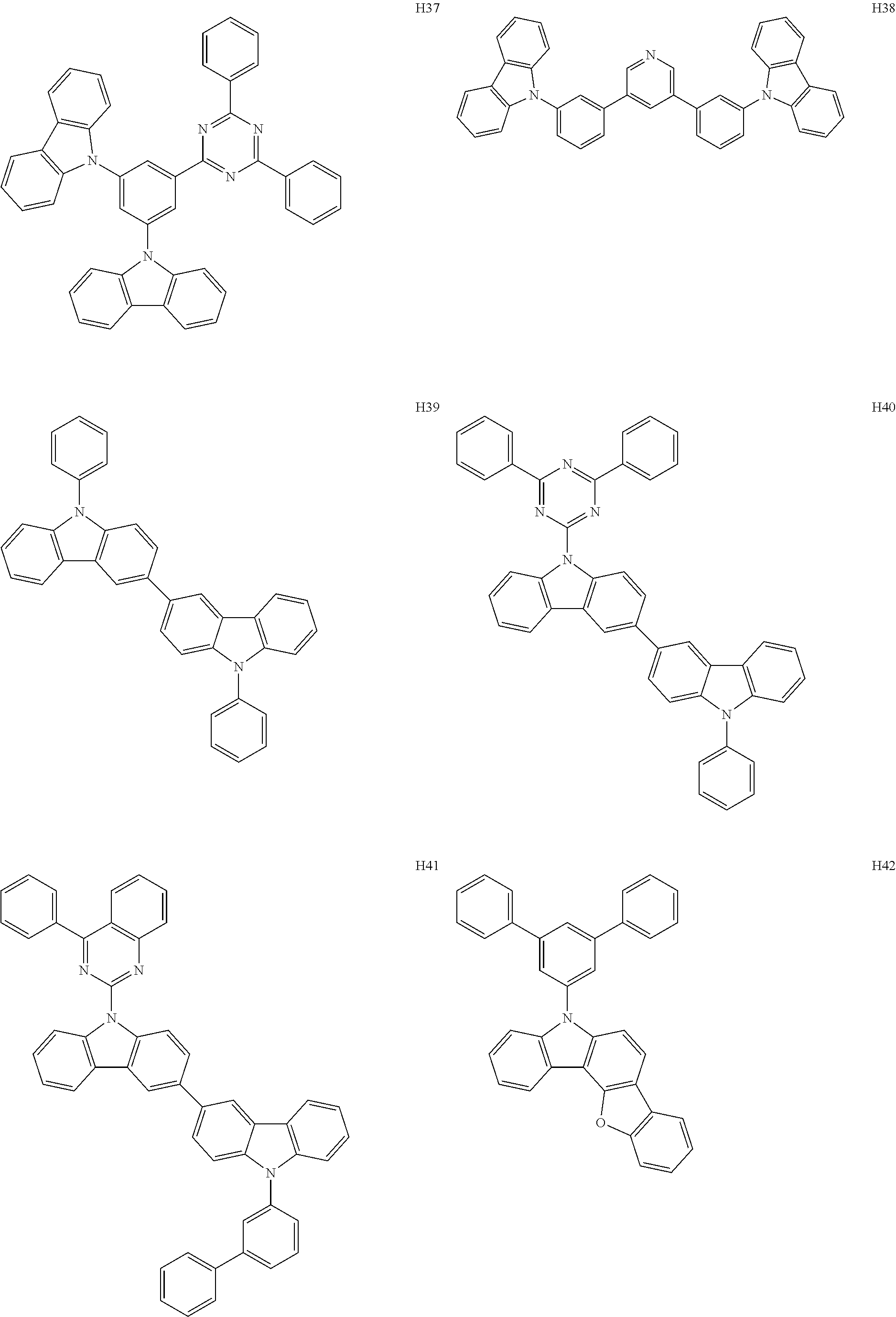 [SMILES: c1ccc(-c2nc(-c3ccccc3)nc(-c3cc(-n4c5ccccc5c5ccccc54)cc(-n4c5ccccc5c5ccccc54)c3)n2)cc1 ; c1cc(-c2cncc(-c3cccc(-n4c5ccccc5c5ccccc54)c3)c2)cc(-n2c3ccccc3c3ccccc32)c1 ; c1ccc(-n2c3ccccc3c3cc(-c4ccc5c(c4)c4ccccc4n5-c4ccccc4)ccc32)cc1 ; c1ccc(-c2nc(-c3ccccc3)nc(-n3c4ccccc4c4cc(-c5ccc6c(c5)c5ccccc5n6-c5ccccc5)ccc43)n2)cc1 ; c1ccc(-c2cccc(-n3c4ccccc4c4cc(-c5ccc6c(c5)c5ccccc5n6-c5nc(-c6ccccc6)c6ccccc6n5)ccc43)c2)cc1 ; c1ccc(-c2cc(-c3ccccc3)cc(-n3c4ccccc4c4c5oc6ccccc6c5ccc43)c2)cc1]

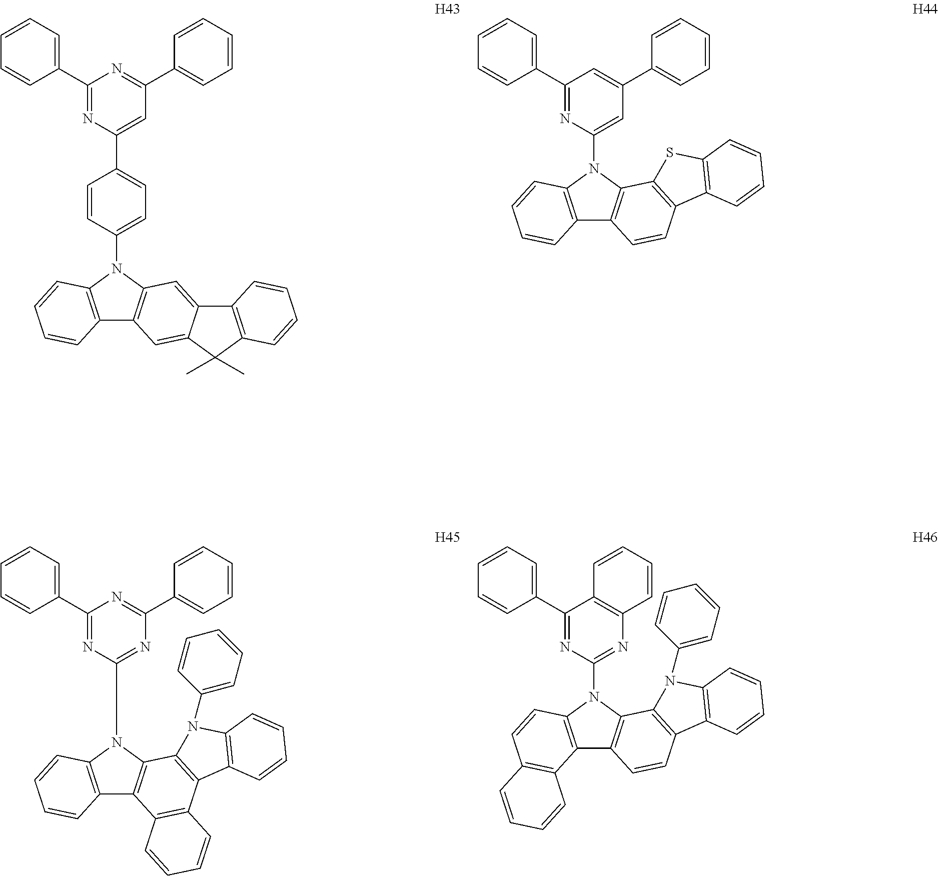 [SMILES: CC1(C)c2ccccc2-c2cc3c(cc21)c1ccccc1n3-c1ccc(-c2cc(-c3ccccc3)nc(-c3ccccc3)n2)cc1 ; c1ccc(-c2cc(-c3ccccc3)nc(-n3c4ccccc4c4ccc5c6ccccc6sc5c43)c2)cc1 ; c1ccc(-c2nc(-c3ccccc3)nc(-n3c4ccccc4c4c5ccccc5c5c6ccccc6n(-c6ccccc6)c5c43)n2)cc1 ; c1ccc(-c2nc(-n3c4ccc5ccccc5c4c4ccc5c6ccccc6n(-c6ccccc6)c5c43)nc3ccccc23)cc1]

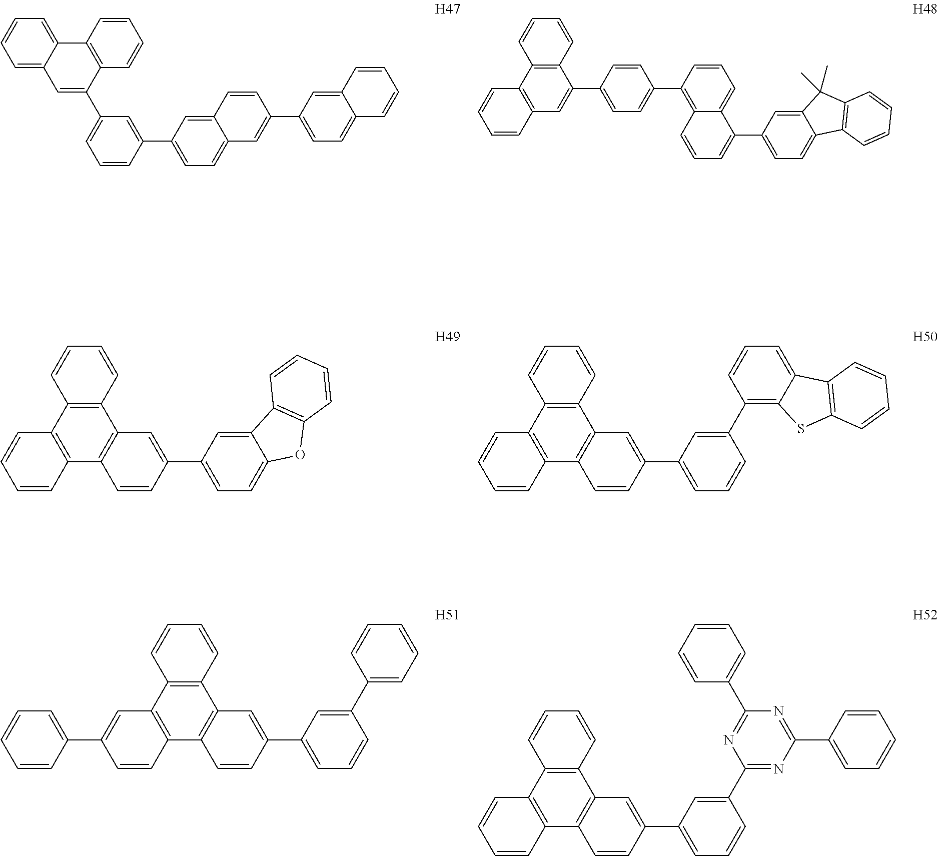

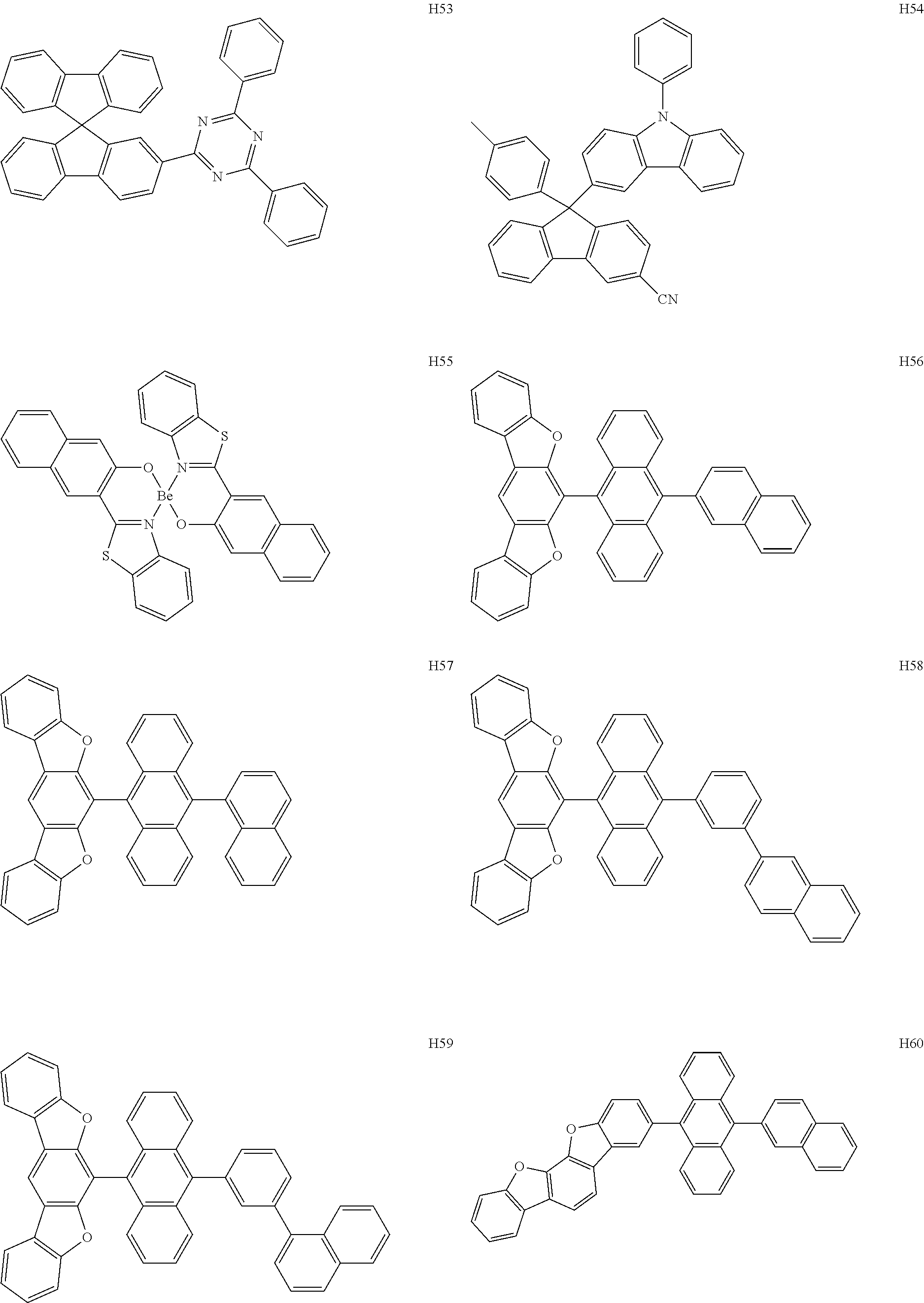

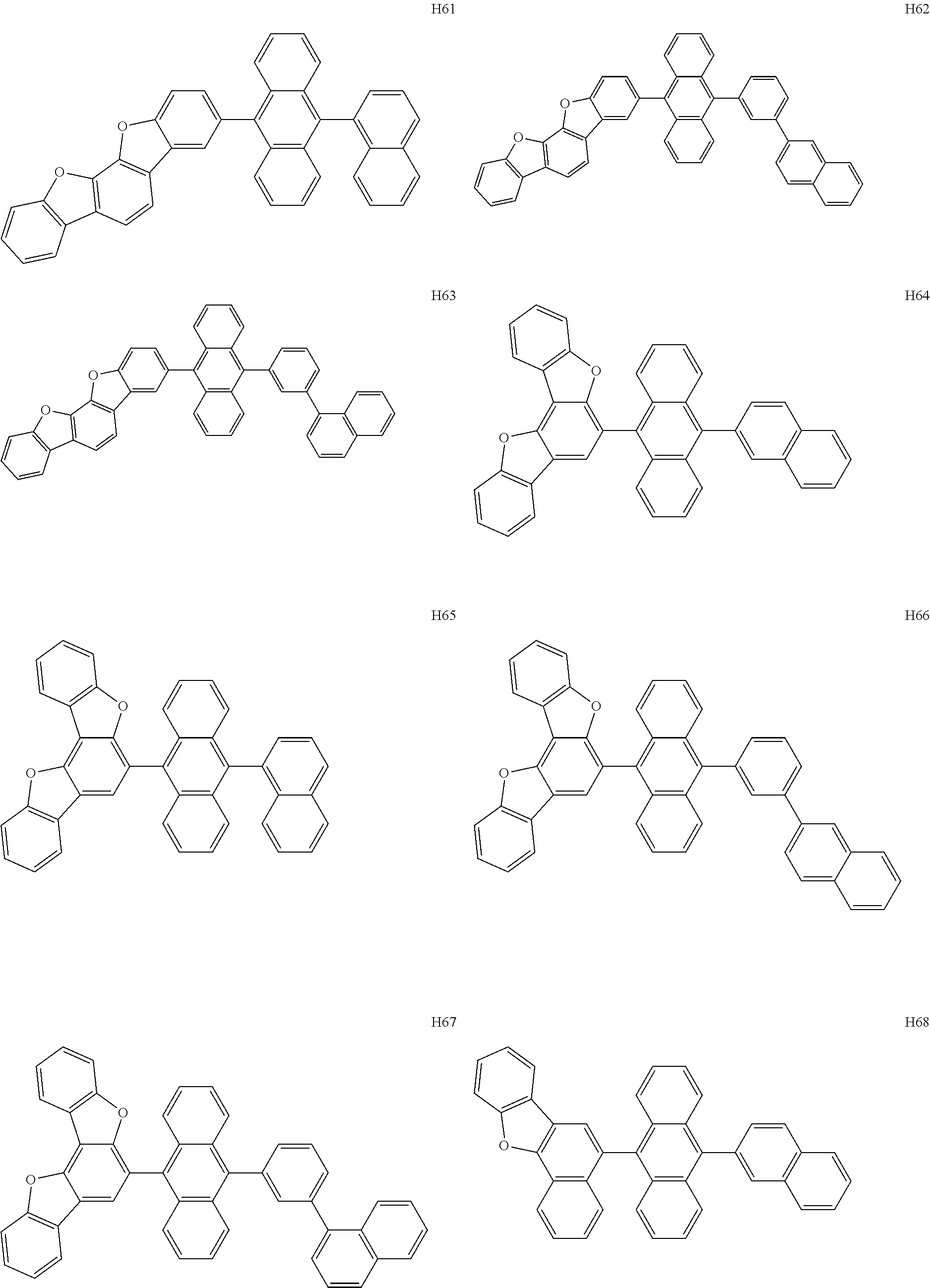

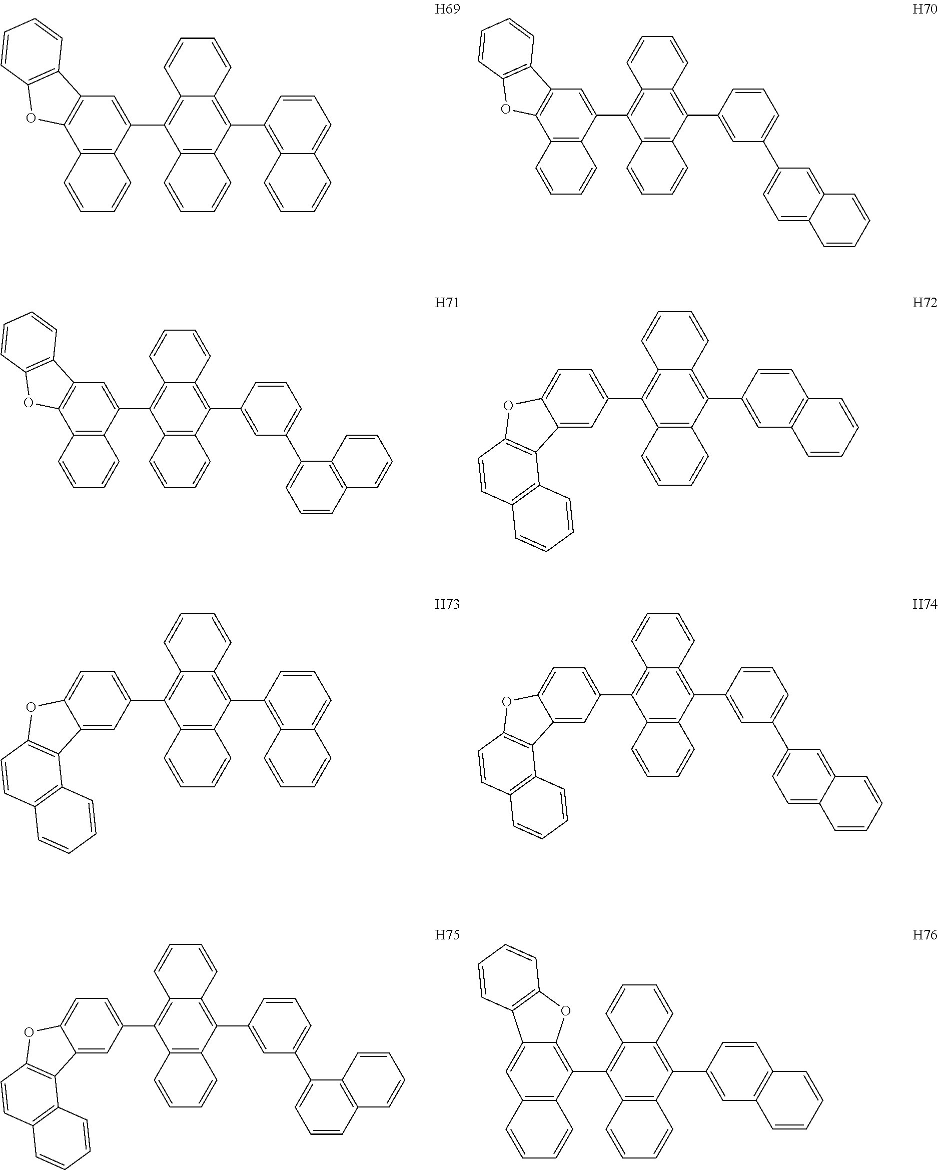

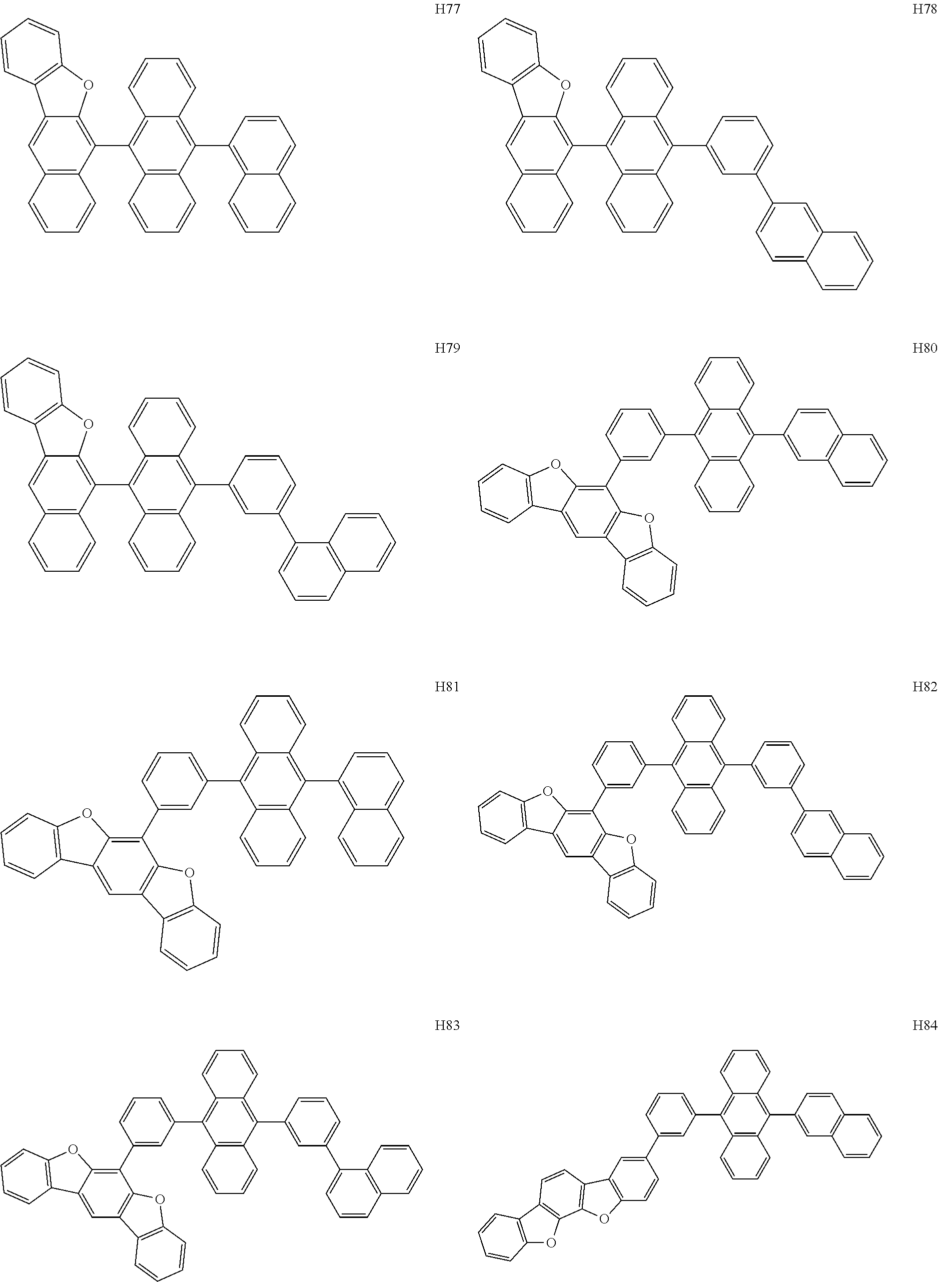

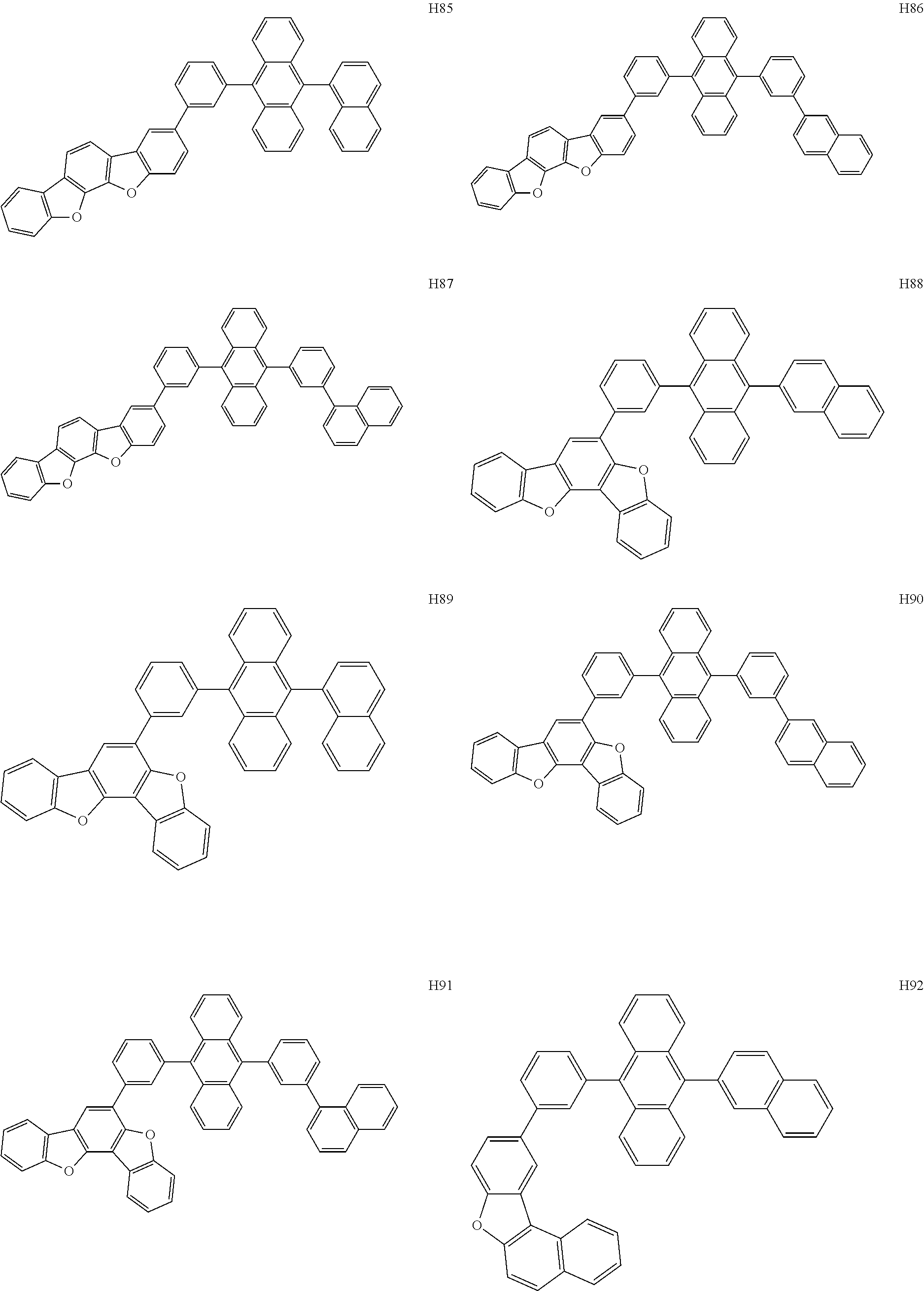

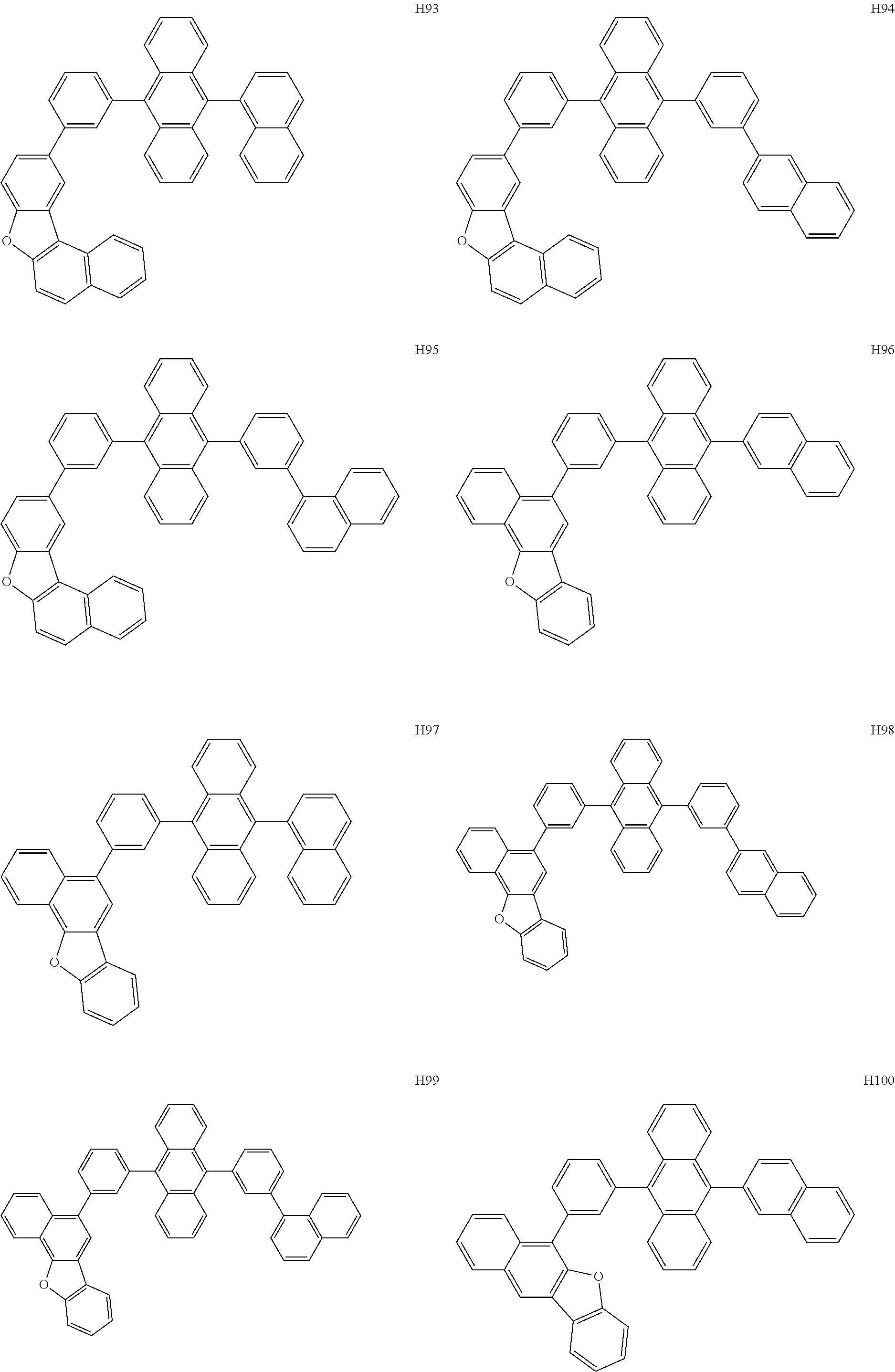

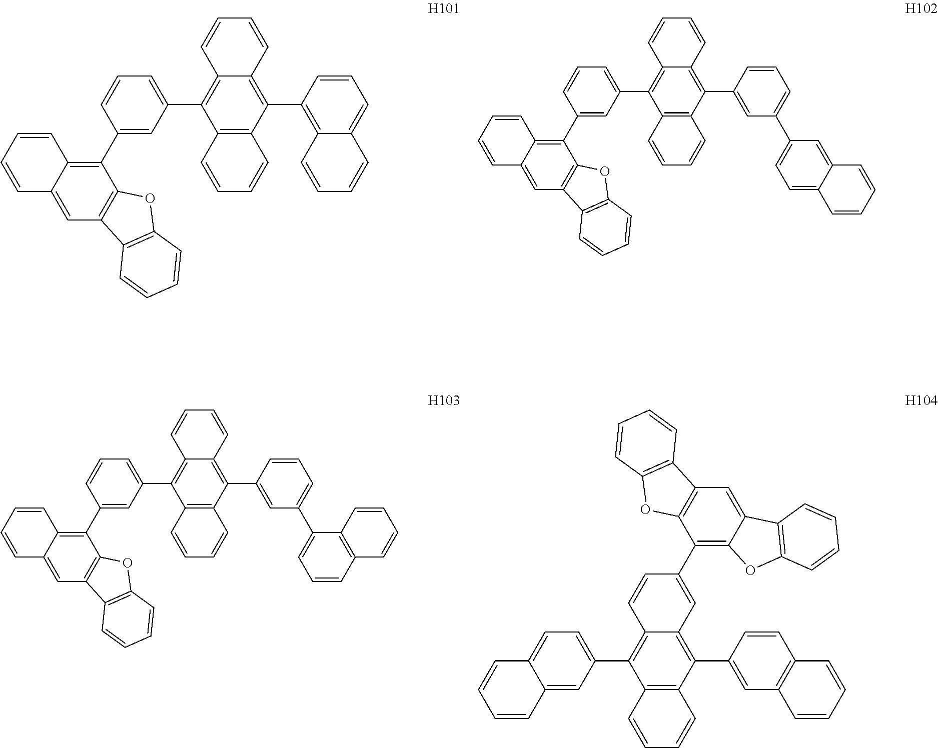 [SMILES: c1cc(-c2c3ccccc3c(-c3cccc4ccccc34)c3ccccc23)cc(-c2c3ccccc3cc3c2oc2ccccc23)c1 ; c1cc(-c2ccc3ccccc3c2)cc(-c2c3ccccc3c(-c3cccc(-c4c5ccccc5cc5c4oc4ccccc45)c3)c3ccccc23)c1 ; c1cc(-c2cccc3ccccc23)cc(-c2c3ccccc3c(-c3cccc(-c4c5ccccc5cc5c4oc4ccccc45)c3)c3ccccc23)c1 ; c1ccc2cc(-c3c4ccccc4c(-c4ccc5ccccc5c4)c4cc(-c5c6oc7ccccc7c6cc6c5oc5ccccc56)ccc34)ccc2c1]

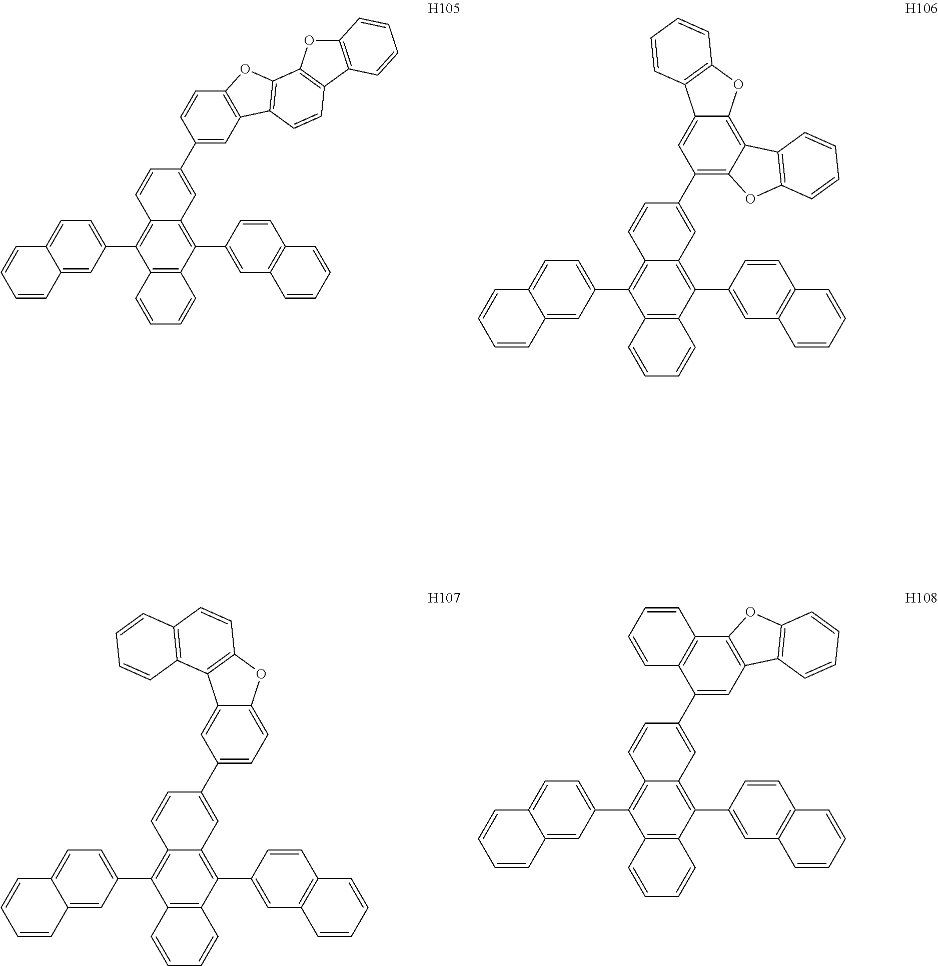 [SMILES: c1ccc2cc(-c3c4ccccc4c(-c4ccc5ccccc5c4)c4cc(-c5ccc6oc7c(ccc8c9ccccc9oc87)c6c5)ccc34)ccc2c1 ; c1ccc2cc(-c3c4ccccc4c(-c4ccc5ccccc5c4)c4cc(-c5cc6c7ccccc7oc6c6c5oc5ccccc56)ccc34)ccc2c1 ; c1ccc2cc(-c3c4ccccc4c(-c4ccc5ccccc5c4)c4cc(-c5ccc6oc7ccc8ccccc8c7c6c5)ccc34)ccc2c1 ; c1ccc2cc(-c3c4ccccc4c(-c4ccc5ccccc5c4)c4cc(-c5cc6c7ccccc7oc6c6ccccc56)ccc34)ccc2c1]

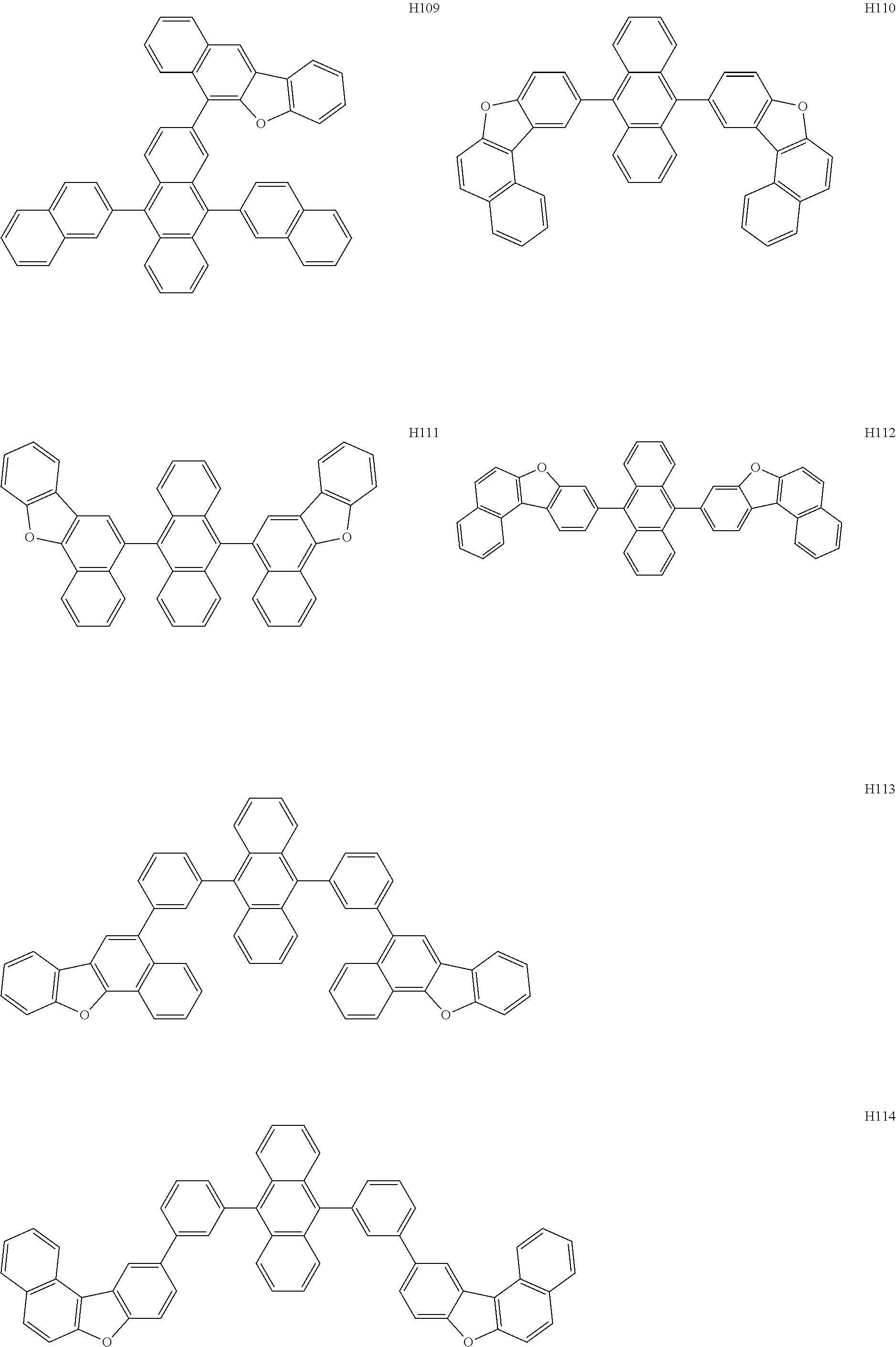

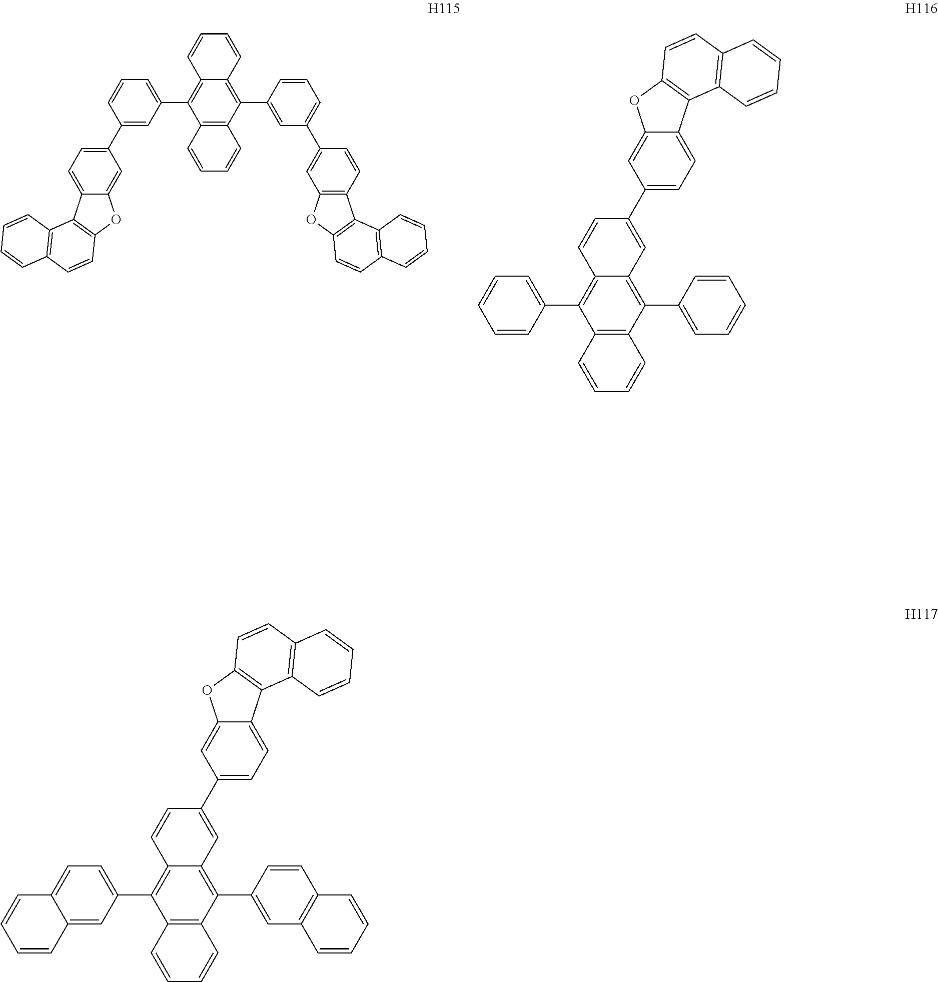 [SMILES: c1cc(-c2ccc3c(c2)oc2ccc4ccccc4c23)cc(-c2c3ccccc3c(-c3cccc(-c4ccc5c(c4)oc4ccc6ccccc6c45)c3)c3ccccc23)c1 ; c1ccc(-c2c3ccccc3c(-c3ccccc3)c3cc(-c4ccc5c(c4)oc4ccc6ccccc6c45)ccc23)cc1 ; c1ccc2cc(-c3c4ccccc4c(-c4ccc5ccccc5c4)c4cc(-c5ccc6c(c5)oc5ccc7ccccc7c56)ccc34)ccc2c1]

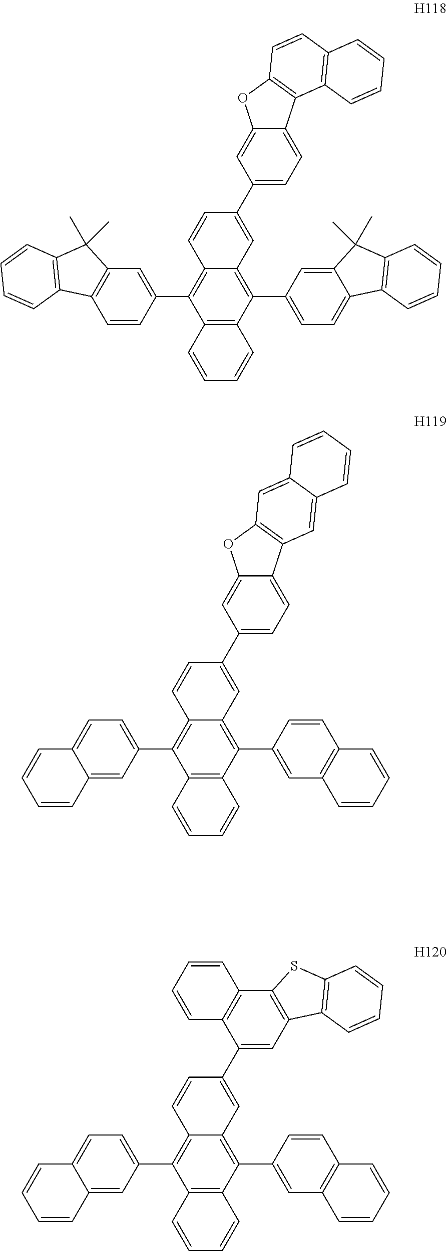 [SMILES: CC1(C)c2ccccc2-c2ccc(-c3c4ccccc4c(-c4ccc5c(c4)C(C)(C)c4ccccc4-5)c4cc(-c5ccc6c(c5)oc5ccc7ccccc7c56)ccc34)cc21 ; c1ccc2cc(-c3c4ccccc4c(-c4ccc5ccccc5c4)c4cc(-c5ccc6c(c5)oc5cc7ccccc7cc56)ccc34)ccc2c1 ; c1ccc2cc(-c3c4ccccc4c(-c4ccc5ccccc5c4)c4cc(-c5cc6c7ccccc7sc6c6ccccc56)ccc34)ccc2c1]

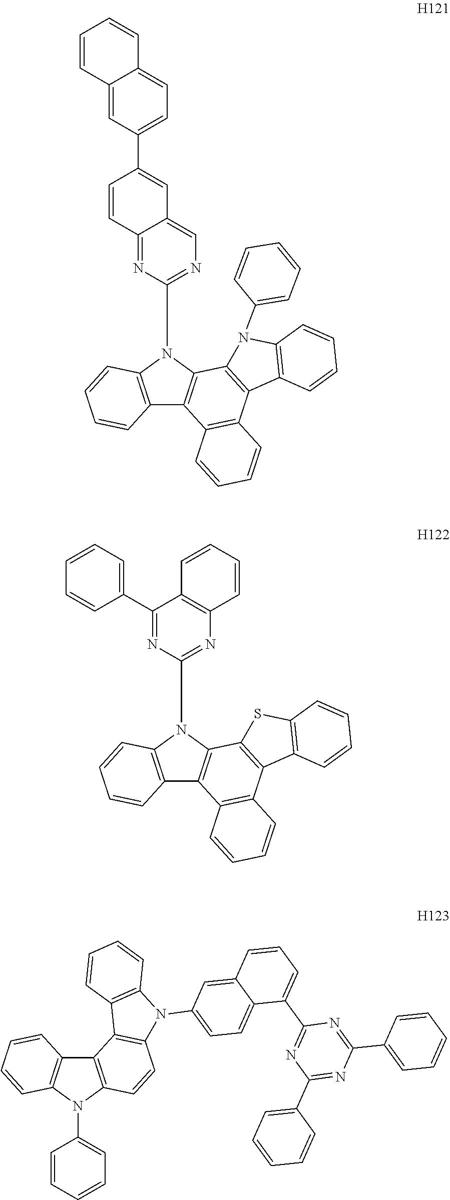 [SMILES: c1ccc(-n2c3ccccc3c3c4ccccc4c4c5ccccc5n(-c5ncc6cc(-c7ccc8ccccc8c7)ccc6n5)c4c32)cc1 ; c1ccc(-c2nc(-n3c4ccccc4c4c5ccccc5c5c6ccccc6sc5c43)nc3ccccc23)cc1 ; c1ccc(-c2nc(-c3ccccc3)nc(-c3cccc4cc(-n5c6ccccc6c6c7c8ccccc8n(-c8ccccc8)c7ccc65)ccc34)n2)cc1]

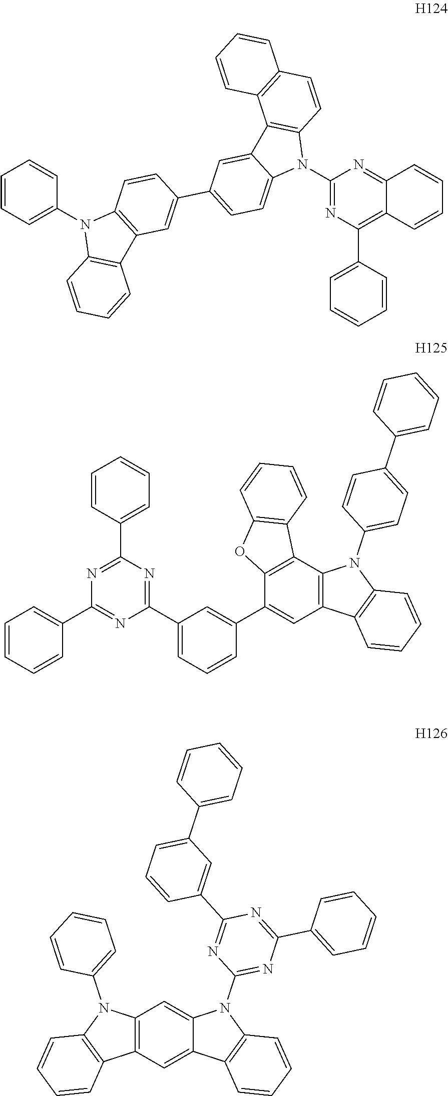 [SMILES: c1ccc(-c2nc(-n3c4ccc(-c5ccc6c(c5)c5ccccc5n6-c5ccccc5)cc4c4c5ccccc5ccc43)nc3ccccc23)cc1 ; c1ccc(-c2ccc(-n3c4ccccc4c4cc(-c5cccc(-c6nc(-c7ccccc7)nc(-c7ccccc7)n6)c5)c5oc6ccccc6c5c43)cc2)cc1 ; c1ccc(-c2cccc(-c3nc(-c4ccccc4)nc(-n4c5ccccc5c5cc6c7ccccc7n(-c7ccccc7)c6cc54)n3)c2)cc1]

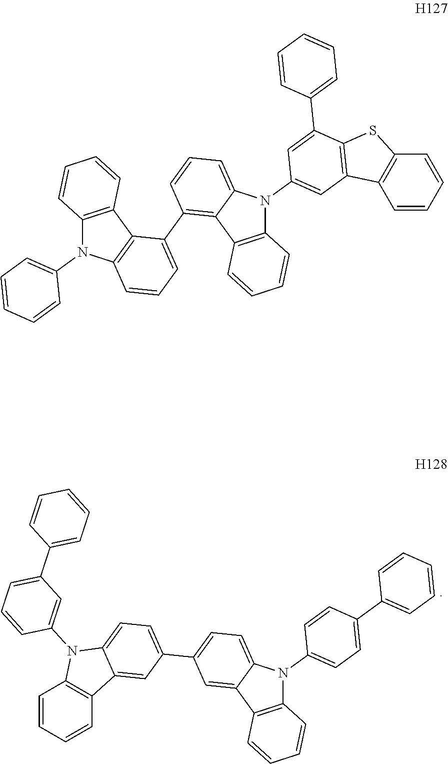 [SMILES: c1ccc(-c2cc(-n3c4ccccc4c4c(-c5cccc6c5c5ccccc5n6-c5ccccc5)cccc43)cc3c2sc2ccccc23)cc1 ; c1ccc(-c2ccc(-n3c4ccccc4c4cc(-c5ccc6c(c5)c5ccccc5n6-c5cccc(-c6ccccc6)c5)ccc43)cc2)cc1]

### Phosphorescent Dopant

The phosphorescent dopant may include at least one transition metal as a central metal.

The phosphorescent dopant may include a monodentate ligand, a bidentate ligand, a tridentate ligand, a tetradentate ligand, a pentadentate ligand, a hexadentate ligand, or any combination thereof.

The phosphorescent dopant may be electrically neutral.

In one or more embodiments, the phosphorescent dopant may include a metal organic compound represented by Formula 401:

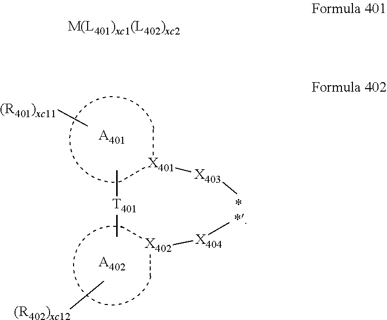

In Formulae 401 and 402,
M may be a transition metal (for example, iridium (Ir), platinum (Pt), palladium (Pd), osmium (Os), titanium (Ti), gold (Au), hafnium (Hf), europium (Eu), terbium (Tb), rhodium (Rh), rhenium (Re), or thulium (Tm)),
L₄₀₁ may be a ligand represented by Formula 402, xc1 may be 1, 2 or 3, and if (e.g., when) xc1 is two or greater, two or more L₄₀₁(s) may each independently be the same or different from each other,
L₄₀₂ may be an organic ligand, xc2 is 0, 1, 2, 3, or 4, and if (e.g., when) xc2 is two or greater, two or more L₄₀₂(s) may each independently be the same or different from each other,
X₄₀₁ and X₄₀₂ may each independently be nitrogen or carbon,
ring A₄₀₁ and ring A₄₀₂ may each independently be a C₃-C₆₀ carbocyclic group or a C₁-C₆₀ heterocyclic group,
T₄₀₁ may be a single bond, *—O—*′, *—S*′, *—C(═O)—*′, *—N(Q₄₁₁)-*′, *—C(Q₄₁₁)(Q₄₁₂)-*′, *—C(Q₄₁₁)═C(Q₄₁₂)*′, *—C(Q₄₁₁)=*′ or *═C═*′,
X₄₀₃ and X₄₀₄ may each independently be a chemical bond (for example, a covalent bond or a coordinate bond), O, S, N(Q₄₁₃), B(Q₄₁₃), P(Q₄₁₃), C(Q₄₁₃)(Q₄₁₄), or Si(Q₄₁₃)(Q₄₁₄),
the descriptions of Q₄₁₁ to Q₄₁₄, each refer to the description of Q₁ as described herein,
R₄₀₁ and R₄₀₂ may each independently be hydrogen, deuterium, —F, —Cl, —Br, —I, a hydroxyl group, a cyano group, a nitro group, a C₁-C₂₀ alkyl group substituted or unsubstituted with at least one R₁₀ₐ, a C₁-C₂₀ alkoxy group substituted or unsubstituted with at least one R₁₀ₐ, a C₃-C₆₀ carbocyclic group substituted or unsubstituted with at least one R₁₀ₐ, a C₁-C₆₀ heterocyclic group substituted or unsubstituted with at least one R₁₀ₐ, —Si(Q₄₀₁)(Q₄₀₂)(Q₄₀₃), —N(Q₄₀₁)(Q₄₀₂), —B(Q₄₀₁)(Q₄₀₂), —C(═O)(Q₄₀₁), —S(═O)₂(Q₄₀₁), or —P(═O)(Q₄₀₁)(Q₄₀₂),
the descriptions of Q₄₀₁ to Q₄₀₃, each refer to the description of Q₁ as described herein,
xc11 and xc12 may each independently be an integer from 0 to 10, and
in Formula 402, * and *′ are each a binding site with M in Formula 401.

In one or more embodiments, in Formula 402, i) X₄₀₁ may be nitrogen and X₄₀₂ may be carbon, or ii) both (e.g., simultaneously) X₄₀₁ and X₄₀₂ may be nitrogen.

In one or more embodiments, if (e.g., when) xc1 in Formula 401 is two or greater, two rings A₄₀₁ (s) among two or more L₄₀₁ (s) may be optionally connected to each other via a linking group T₄₀₂, and/or two rings A₄₀₂(s) may be optionally connected to each other via a linking group T₄₀₃ (see compounds PD1 to PD4 and PD7). The descriptions of T₄₀₂ and T₄₀₃, each refer to the description of T₄₀₁ as described herein.

In Formula 401, L₄₀₂ may be any organic ligand. For example, the L₄₀₂ may include a halogen, a diketone group (for example, an acetylacetonate group), a carboxylic acid group (for example, a picolinate group), —C(═O), an isonitrile group, —CN group, a phosphorus-containing group (for example, a phosphine group, a phosphite group, and/or the like), or any combination thereof.

In one or more embodiments, the phosphorescent dopant may include, for example, any one selected from among compounds PD1 to PD39, or any combination thereof:

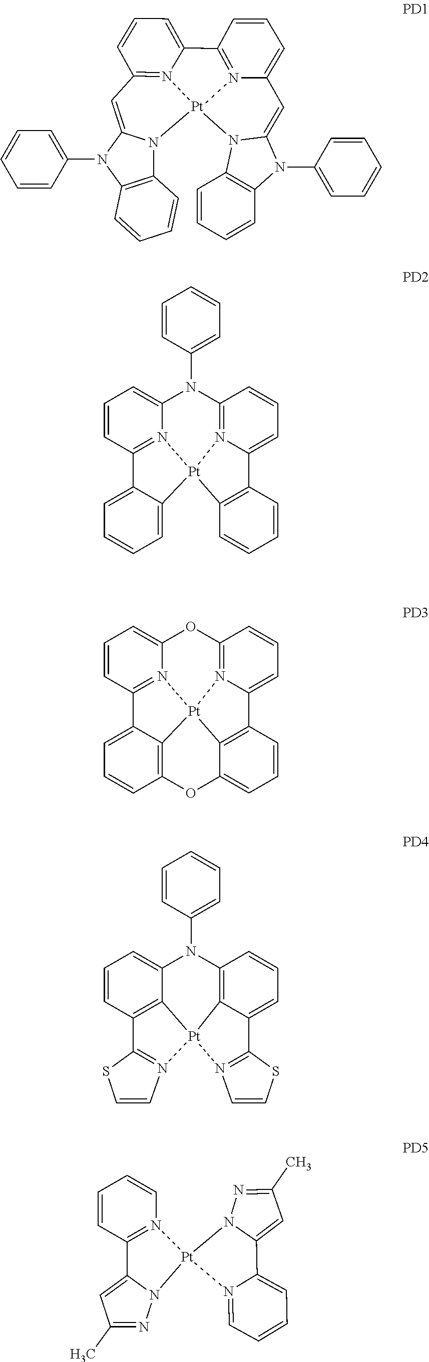

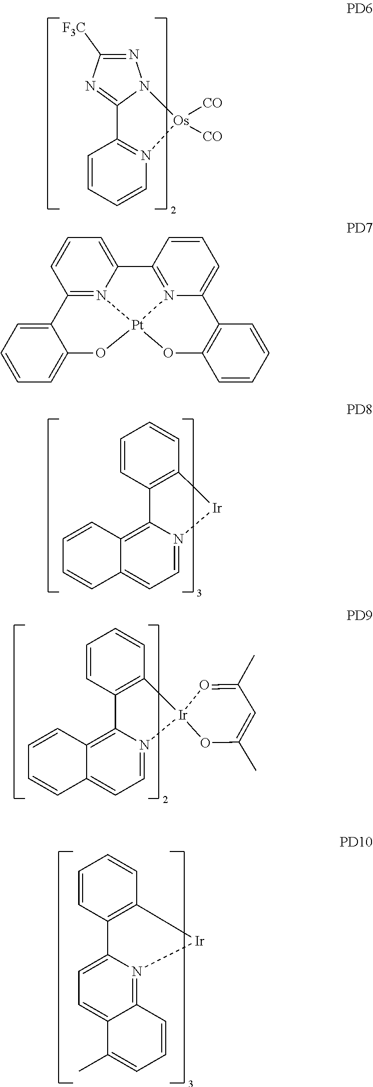

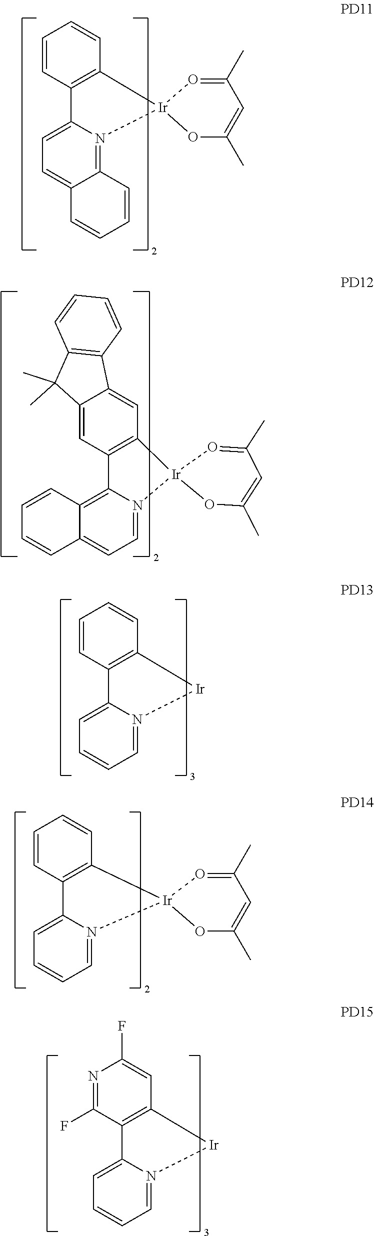

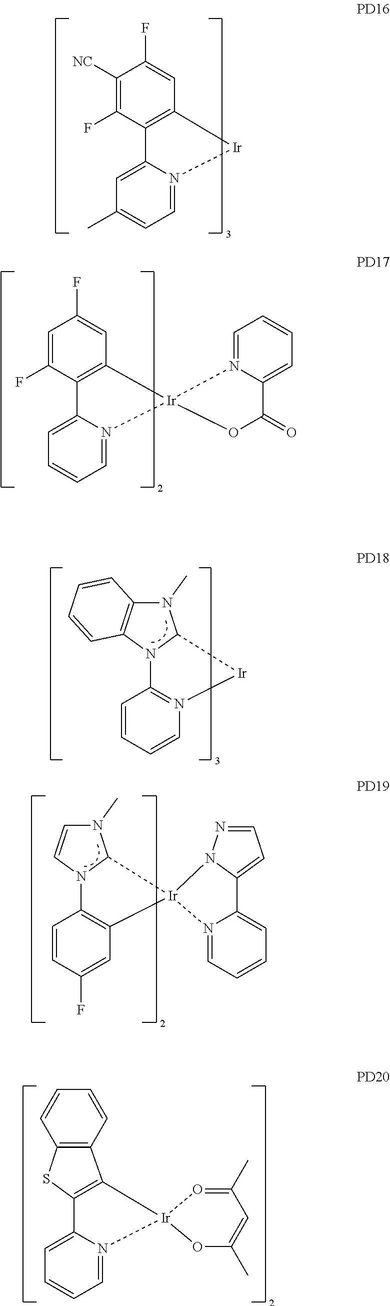

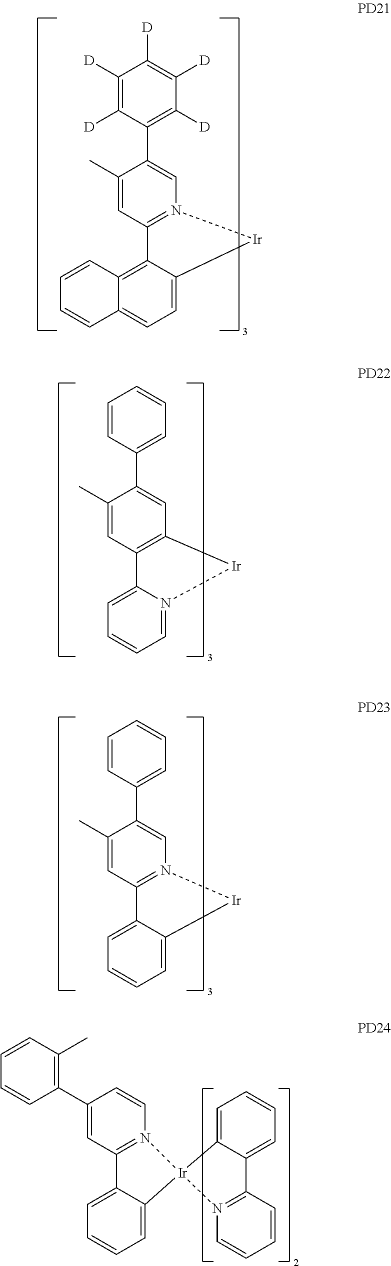

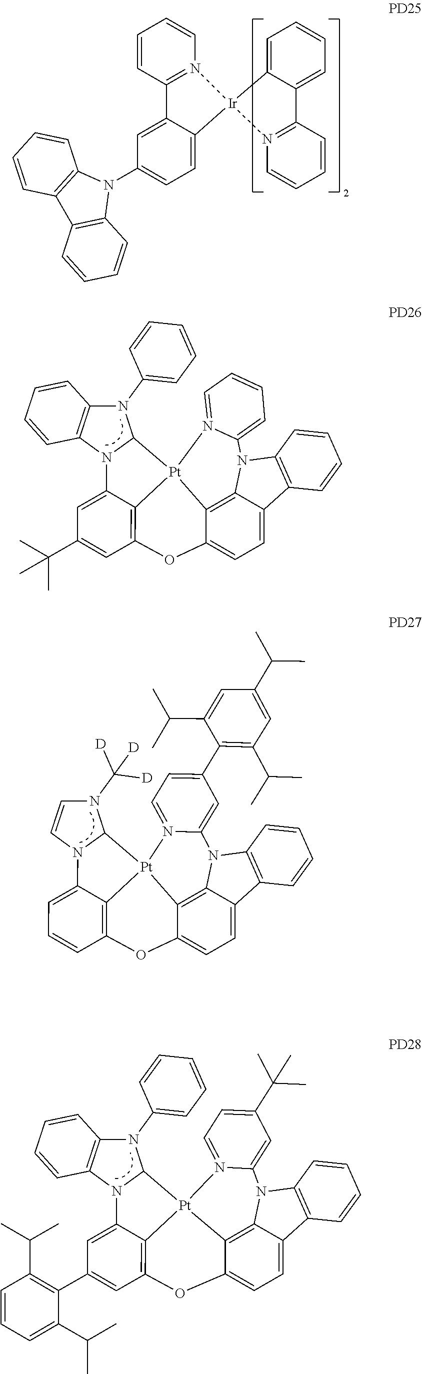

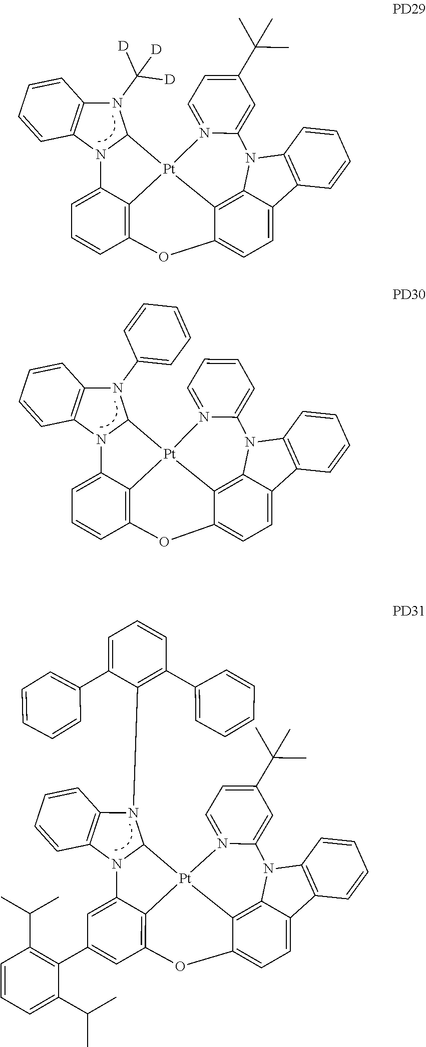

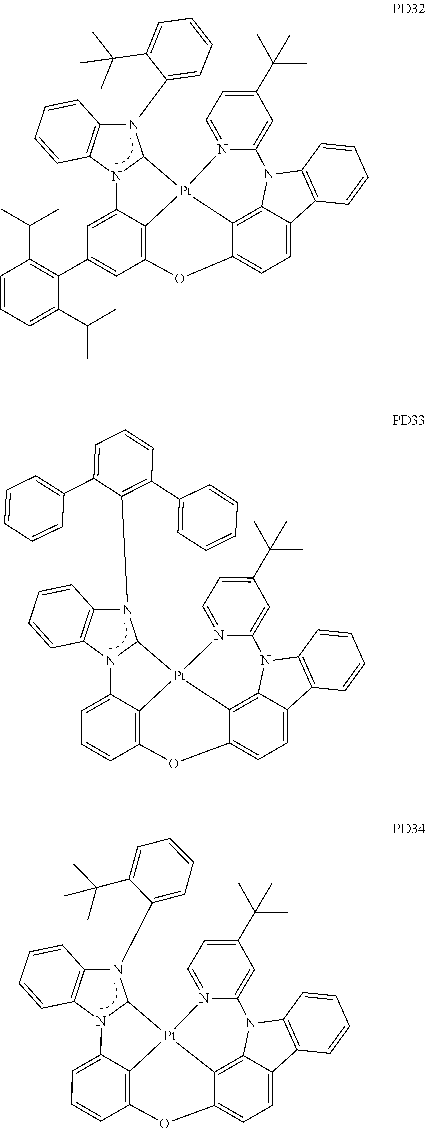

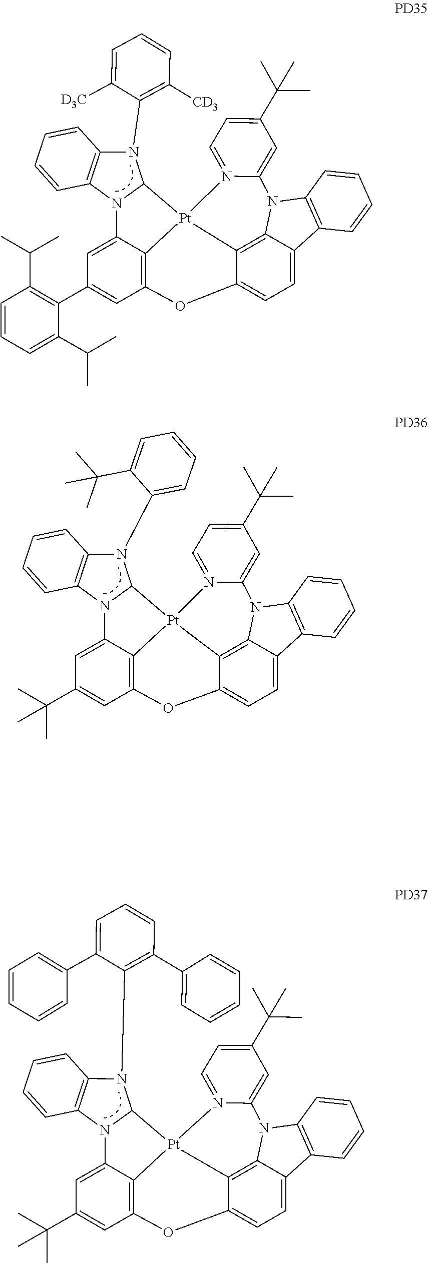

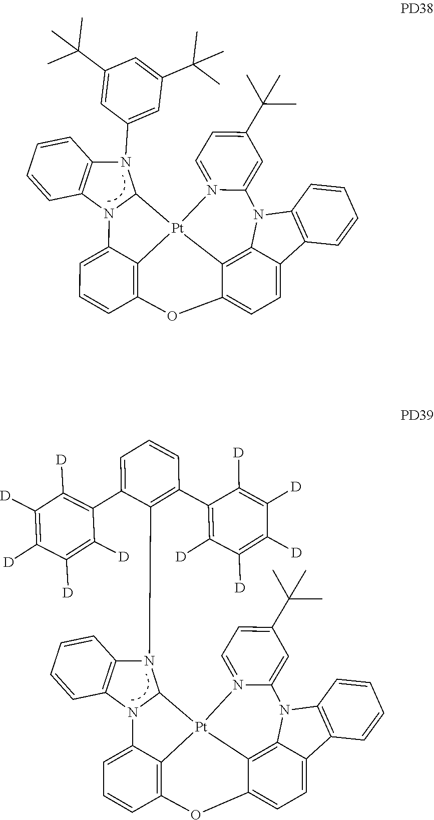

### Fluorescent Dopant

The fluorescent dopant may include an amine group-containing compound, a styryl group-containing compound, or any combination thereof.

For example, in one or more embodiments, the fluorescent dopant may include a compound represented by Formula 501:

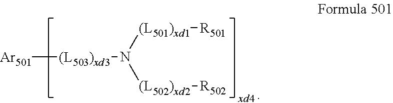

In Formula 501,
Ar₅₀₁, L₅₀₁ to L₅₀₃, R₅₀₁, and R₅₀₂ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
xd1 to xd3 may each independently be, 0, 1, 2, or 3, and
xd4 may be 1, 2, 3, 4, 5, or 6.

In one or more embodiments, in Formula 501, Ar₅₀₁ may include a condensed ring group in which three or more monocyclic groups are condensed with one another (for example, an anthracene group, a chrysene group, a pyrene group, and/or the like).

In one or more embodiments, in Formula 501, xd4 may be 2.

In one or more embodiments, the fluorescent dopant may include at least one selected from among compounds FD1 to FD37, 4,4′-bis(2,2-diphenylvinyl)-1,1′-biphenyl (DPVBi), 4,4′-bis[4-(N,N-diphenylamino)styryl]biphenyl (DPAVBi), or any combination thereof:

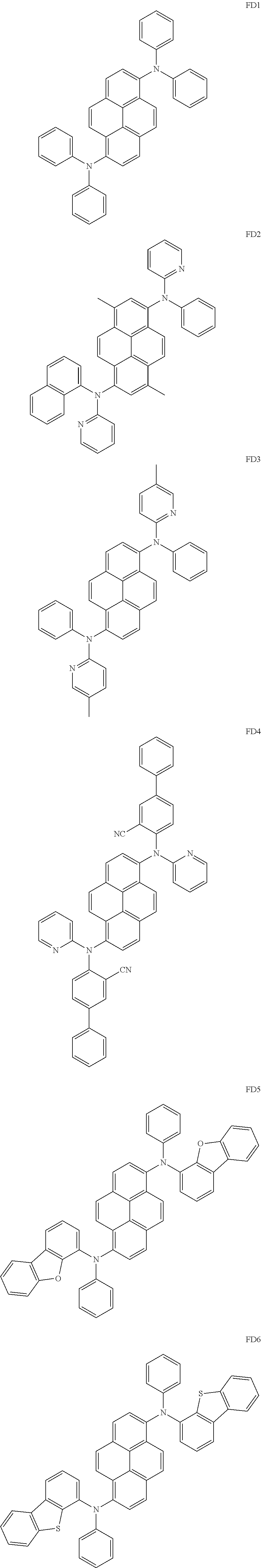 [SMILES: c1ccc(N(c2ccccc2)c2ccc3ccc4c(N(c5ccccc5)c5ccccc5)ccc5ccc2c3c54)cc1 ; Cc1cc(N(c2ccccc2)c2ccccn2)c2ccc3c(C)cc(N(c4ccccn4)c4cccc5ccccc45)c4ccc1c2c34 ; Cc1ccc(N(c2ccccc2)c2ccc3ccc4c(N(c5ccccc5)c5ccc(C)cn5)ccc5ccc2c3c54)nc1 ; N#Cc1cc(-c2ccccc2)ccc1N(c1ccccn1)c1ccc2ccc3c(N(c4ccccn4)c4ccc(-c5ccccc5)cc4C#N)ccc4ccc1c2c43 ; c1ccc(N(c2ccc3ccc4c(N(c5ccccc5)c5cccc6c5oc5ccccc56)ccc5ccc2c3c54)c2cccc3c2oc2ccccc23)cc1 ; c1ccc(N(c2ccc3ccc4c(N(c5ccccc5)c5cccc6c5sc5ccccc56)ccc5ccc2c3c54)c2cccc3c2sc2ccccc23)cc1]

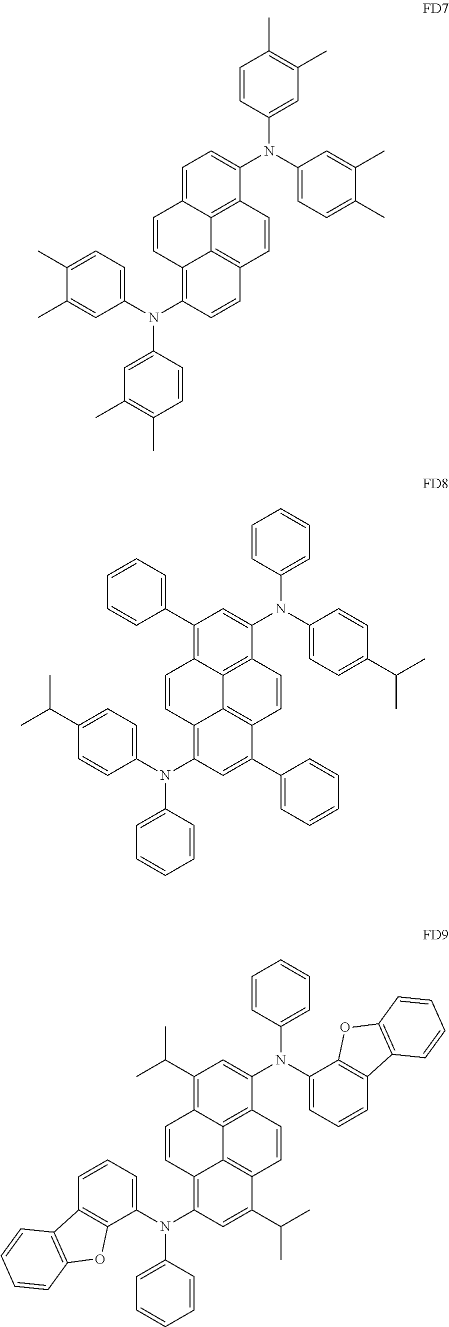

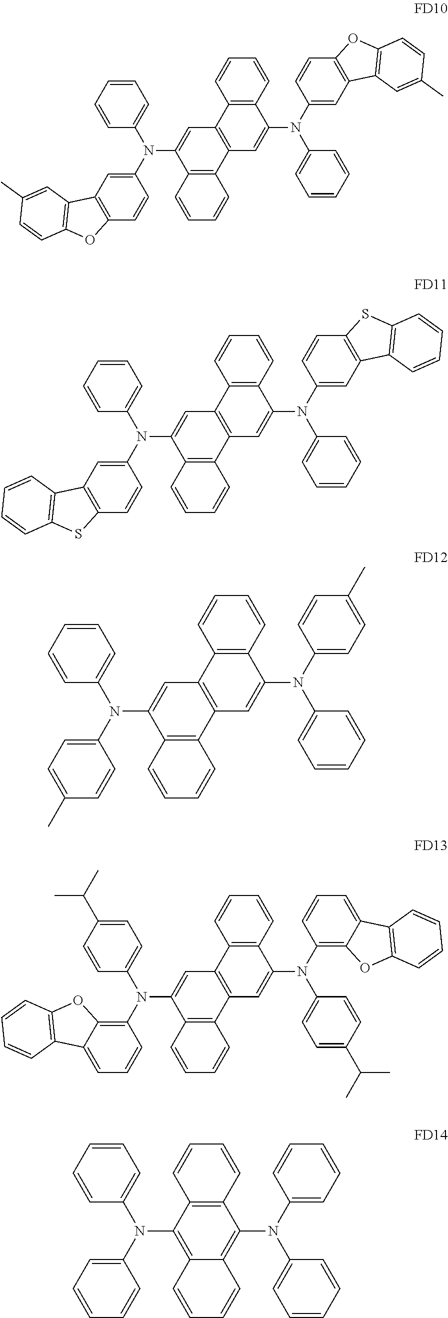

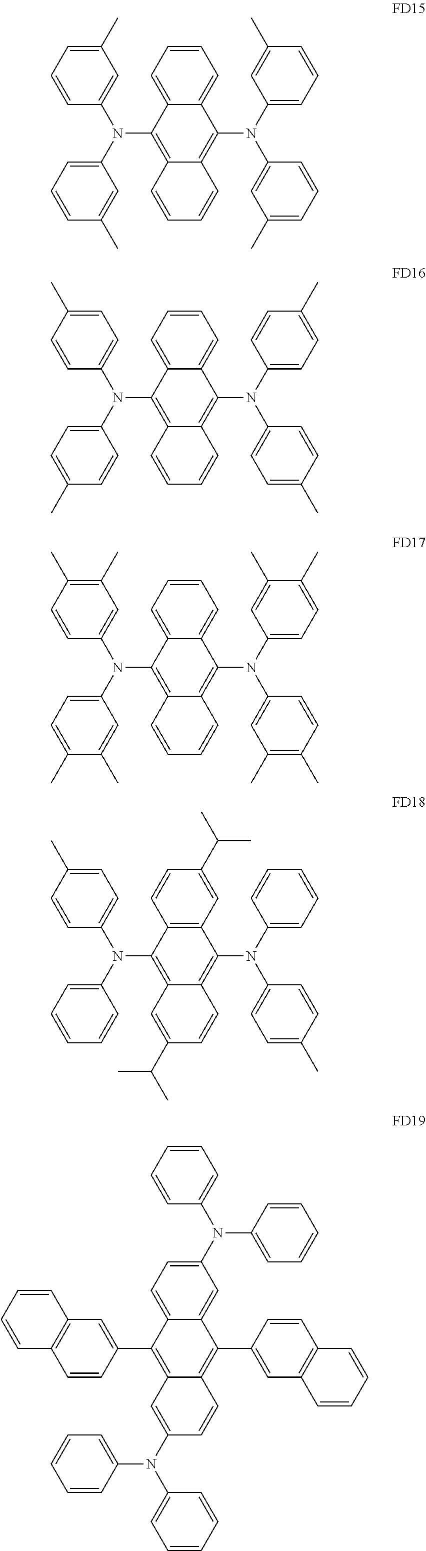

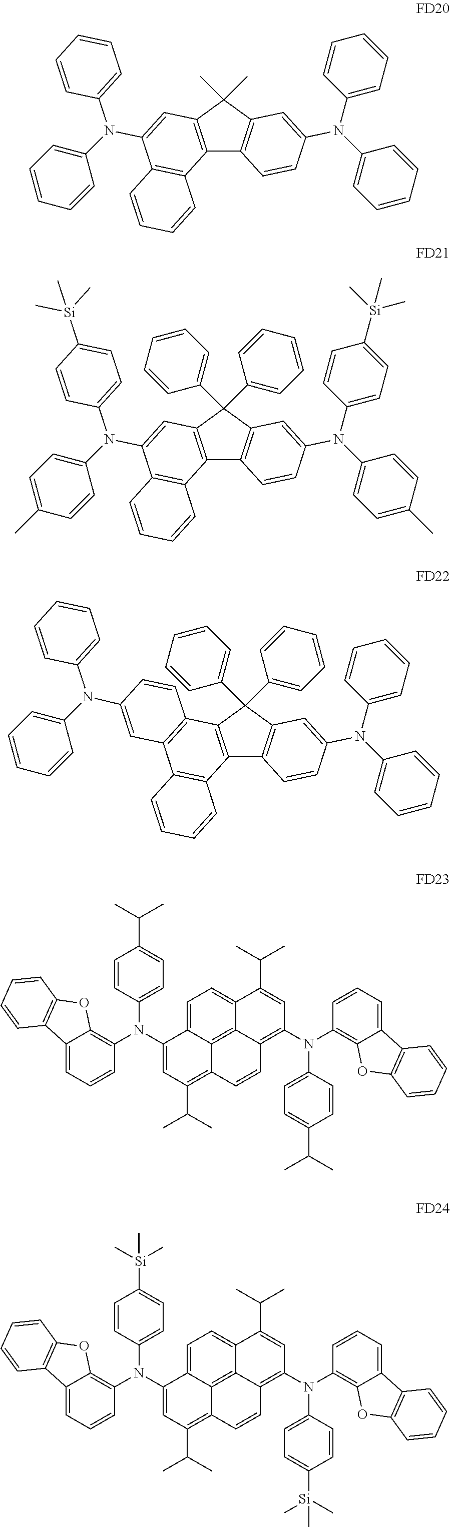

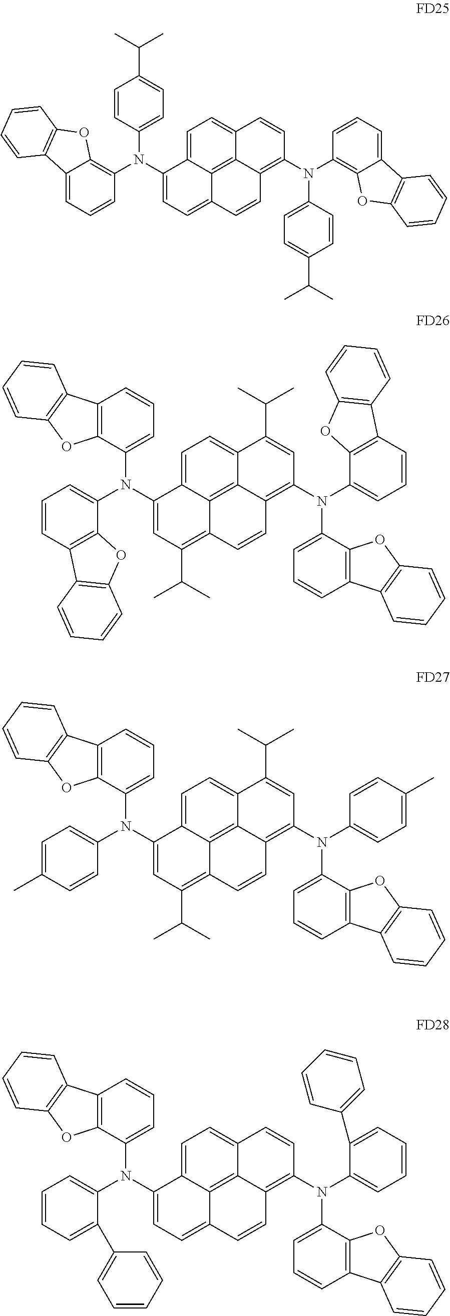 [SMILES: CC(C)c1ccc(N(c2ccc3ccc4c(N(c5ccc(C(C)C)cc5)c5cccc6c5oc5ccccc56)ccc5ccc2c3c54)c2cccc3c2oc2ccccc23)cc1 ; CC(C)c1cc(N(c2cccc3c2oc2ccccc23)c2cccc3c2oc2ccccc23)c2ccc3c(C(C)C)cc(N(c4cccc5c4oc4ccccc45)c4cccc5c4oc4ccccc45)c4ccc1c2c34 ; Cc1ccc(N(c2cc(C(C)C)c3ccc4c(N(c5ccc(C)cc5)c5cccc6c5oc5ccccc56)cc(C(C)C)c5ccc2c3c54)c2cccc3c2oc2ccccc23)cc1 ; c1ccc(-c2ccccc2N(c2ccc3ccc4c(N(c5ccccc5-c5ccccc5)c5cccc6c5oc5ccccc56)ccc5ccc2c3c54)c2cccc3c2oc2ccccc23)cc1]

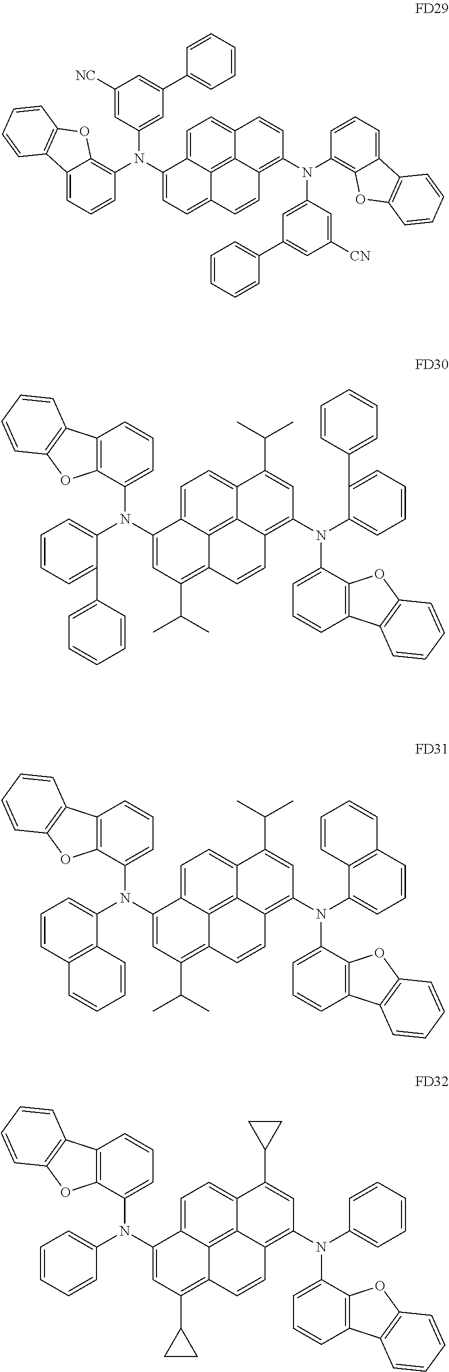 [SMILES: N#Cc1cc(-c2ccccc2)cc(N(c2ccc3ccc4c(N(c5cc(C#N)cc(-c6ccccc6)c5)c5cccc6c5oc5ccccc56)ccc5ccc2c3c54)c2cccc3c2oc2ccccc23)c1 ; CC(C)c1cc(N(c2ccccc2-c2ccccc2)c2cccc3c2oc2ccccc23)c2ccc3c(C(C)C)cc(N(c4ccccc4-c4ccccc4)c4cccc5c4oc4ccccc45)c4ccc1c2c34 ; CC(C)c1cc(N(c2cccc3ccccc23)c2cccc3c2oc2ccccc23)c2ccc3c(C(C)C)cc(N(c4cccc5ccccc45)c4cccc5c4oc4ccccc45)c4ccc1c2c34 ; c1ccc(N(c2cc(C3CC3)c3ccc4c(N(c5ccccc5)c5cccc6c5oc5ccccc56)cc(C5CC5)c5ccc2c3c54)c2cccc3c2oc2ccccc23)cc1]

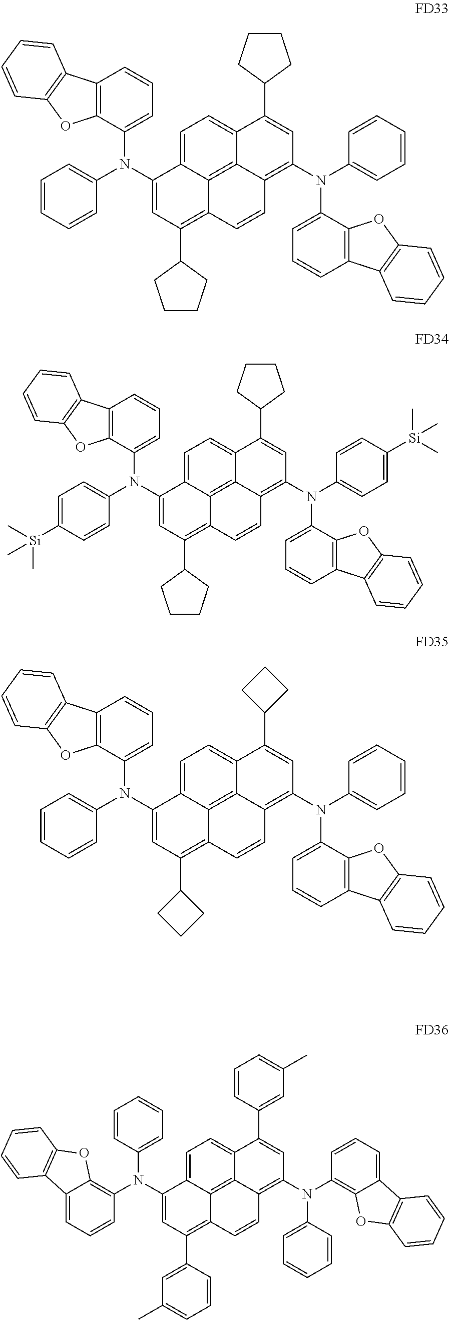

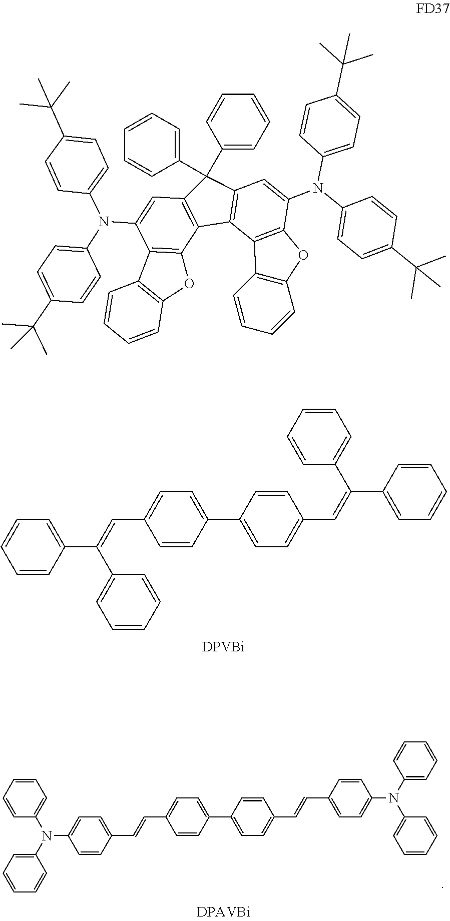

### Delayed Fluorescent Material

In one or more embodiments, the emission layer may include a delayed fluorescent material.

As used herein, the delayed fluorescent material may be selected from among any compound that may be to emit delayed fluorescence by a delayed fluorescence emission mechanism.

The delayed fluorescent material included in the emission layer may serve as a host or a dopant, depending on the type (kind) of other material included in the emission layer.

According to one or more embodiments, a difference (e.g., an absolute value of the difference) between a triplet energy level (eV) of the delayed fluorescent material and a singlet energy level (eV) of the delayed fluorescent material may be 0 eV or more and 0.5 eV or less. When the difference between the triplet energy level (eV) of the delayed fluorescent material and the singlet energy level (eV) of the delayed fluorescent material satisfies the range described above, the up-conversion from the triplet state to the singlet state in the delayed fluorescent material is effectively achieved, so that the luminescence efficiency of the light-emitting element 1A and/or the like may be improved.

For example, in one or more embodiments, the delayed fluorescent material may include, i) a material including at least one electron donor (for example, a π electron-rich C₃-C₆₀ cyclic group such as a carbazole group, and/or the like) and at least one electron acceptor (for example, a sulfoxide group, a cyano group, a π electron-deficient nitrogen-containing C₁-C₆₀ cyclic group, and/or the like), ii) a material including a C₈-C₆₀ polycyclic group including two or more cyclic groups condensed while sharing boron (B), and/or iii) the like.

Non-limiting examples of the delayed fluorescent material may include at least one selected from among compounds DF1 to DF14:

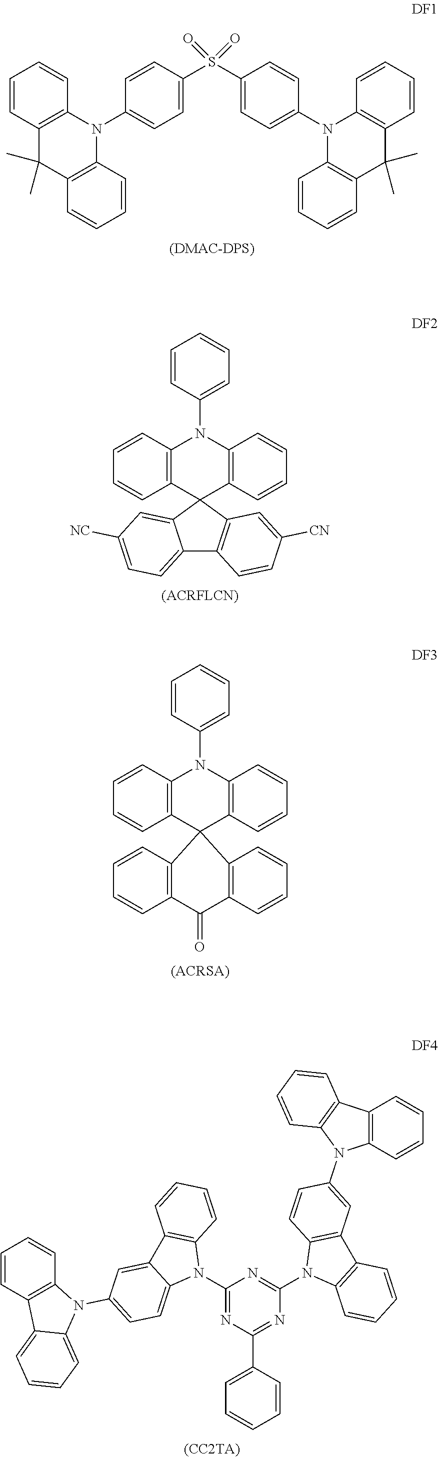

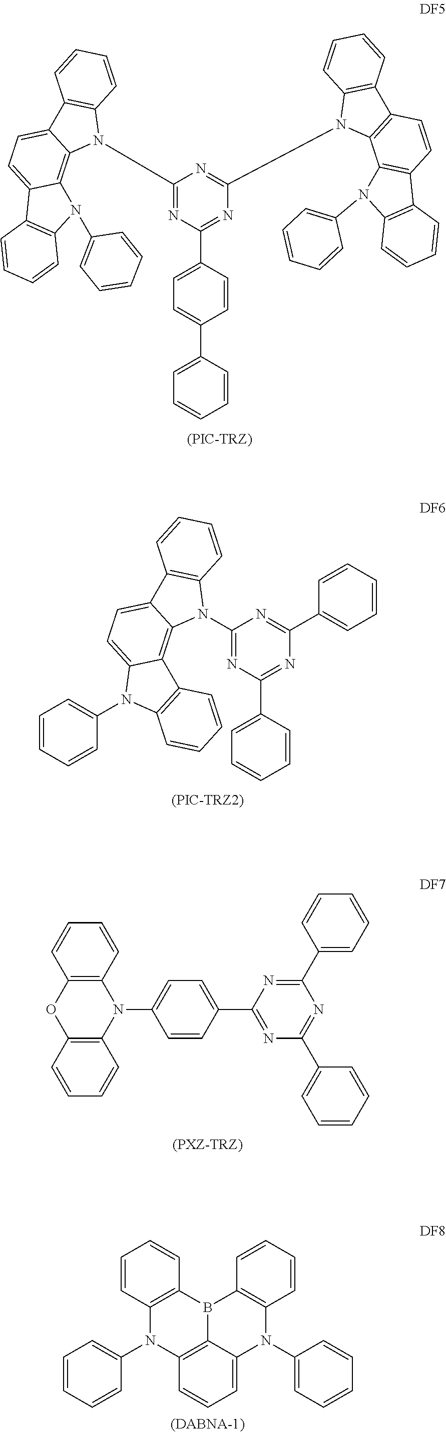

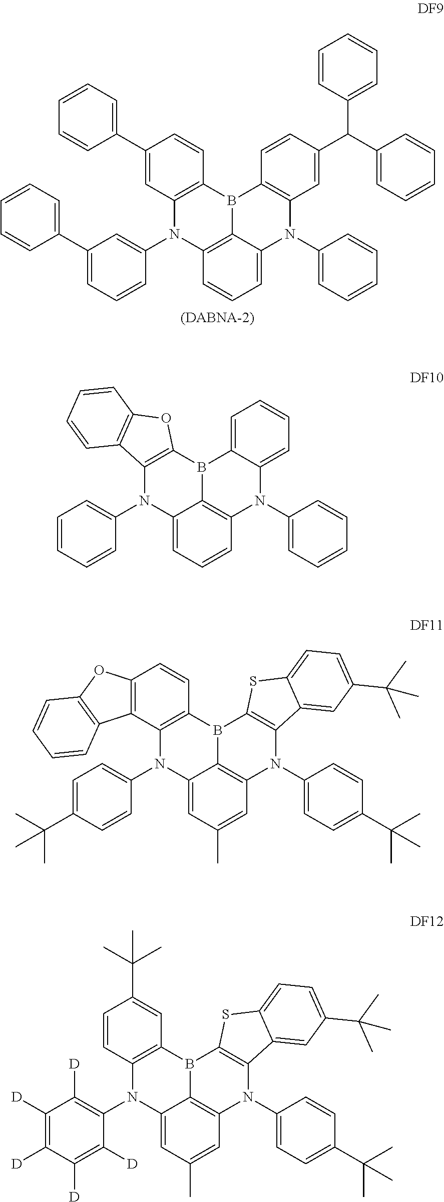

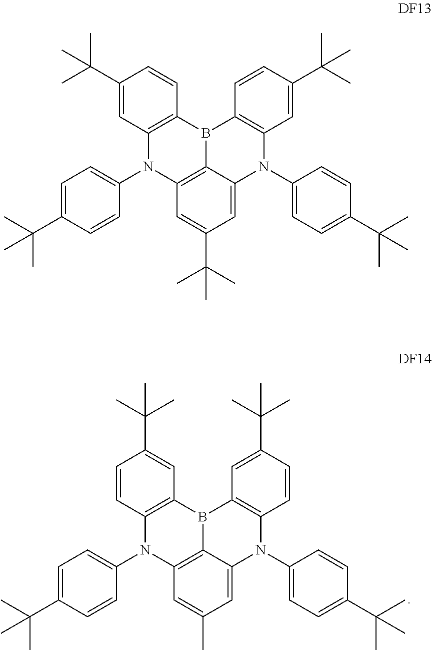

### Electron Transport Region in Intermediate Layer 130

The electron transport region may have i) a single-layer structure including (e.g., consisting of) a single layer including (e.g., consisting of) a single material, ii) a single-layer structure including (e.g., consisting of) a single layer including a plurality of different materials, or iii) a multi-layer structure including a plurality of layers including a plurality of different materials.

The electron transport region may include a buffer layer, a hole blocking layer, an electron control layer, an electron transport layer, an electron injection layer, or any combination thereof.

For example, in one or more embodiments, the electron transport region may have a structure such as an electron transport layer/electron injection layer structure, a hole blocking layer/electron transport layer/electron injection layer structure, an electron control layer/electron transport layer/electron injection layer structure, or a buffer layer/electron transport layer/electron injection layer structure, and/or the like, in each of which the constituent layers are sequentially stacked from the emission layer in the stated order.

In one or more embodiments, the electron transport region (for example, a buffer layer, a hole blocking layer, an electron control layer, or an electron transport layer in the electron transport region) may include a metal-free compound including at least one π electron-deficient nitrogen-containing C₁-C₆₀ cyclic group.

For example, in one or more embodiments, the electron transport region may include a compound represented by Formula 601.

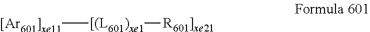

In Formula 601,
Ar₆₀₁ and L₆₀₁ may each independently be a C₃-C₆₀ carbocyclic group substituted or unsubstituted with at least one R₁₀ₐ or a C₁-C₆₀ heterocyclic group substituted or unsubstituted with at least one R₁₀ₐ,
xe11 may be 1, 2 or 3,
xe1 may be 0, 1, 2, 3, 4, or 5,
R₆₀₁ may be a C₃-C₆₀ carbocyclic group substituted or unsubstituted with at least one R₁₀ₐ, a C₁-C₆₀ heterocyclic group substituted or unsubstituted with at least one R₁₀ₐ, —Si(Q₆₀₁)(Q₆₀₂)(Q₆₀₃), —C(═O)(Q₆₀₁), —S(═O)₂(Q₆₀₁), or —P(═O)(Q₆₀₁)(Q₆₀₂),
the descriptions of Q₆₀₁ to Q₆₀₃, may each refer to the description of Q₁ as described herein,
xe21 may be 1, 2, 3, 4, or 5, and
at least one selected from among Ar₆₀₁, L₆₀₁, and R₆₀₁ may each independently be a π electron-deficient nitrogen-containing C₁-C₆₀ cyclic group substituted or unsubstituted with at least one R₁₀ₐ.

For example, in one or more embodiments, if (e.g., when) xe11 in Formula 601 is two or greater, two or more Ar₆₀₁(s) may be connected to each other through a single bond.

In one or more embodiments, Ar₆₀₁ in Formula 601 may be an anthracene group substituted or unsubstituted with at least one R₁₀ₐ.

In one or more embodiments, the electron transport region may include a compound represented by Formula 601-1:

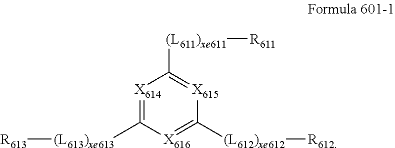

In Formula 601-1,
X₆₁₄ may be N or C (R₆₁₄), X₆₁₅ is N or C (R₆₁₅), X₆₁₆ may be N or C (R₆₁₆), and at least one selected from among X₆₁₄ to X₆₁₆ may be N,
the descriptions of L₆₁₁ to L₆₁₃ may each refer to the description of L₆₀₁,
the descriptions of xe611 to xe613 may each refer to the description of xe1,
the descriptions of R₆₁₁ to R₆₁₃ may each refer to the description of R₆₀₁, and
R₆₁₄ to R₆₁₆ may each independently be hydrogen, deuterium, —F, —Cl, —Br, —I, a hydroxyl group, a cyano group, a nitro group, a C₁-C₂₀ alkyl group, a C₁-C₂₀ alkoxy group, a C₃-C₆₀ carbocyclic group substituted or unsubstituted with at least one R₁₀ₐ, or a C₁-C₆₀ heterocyclic group substituted or unsubstituted with at least one R₁₀ₐ.

In one or more embodiments, in Formulae 601 and 601-1, xe1 and xe611 to xe613 may each independently be, 0, 1, or 2.

In one or more embodiments, the electron transport region may include at least one selected from among compounds ET1 to ET45, BCP (2,9-Dimethyl-4,7-diphenyl-1, 10-phenanthroline), Bphen (4,7-Diphenyl-1, 10-phenanthroline), Alq₃ (tris(8-hydroxyquinolinato)aluminum), BAlq (bis(2-methyl-8-quinolinolato-N1,08)-(1,1′-biphenyl-4-olato)aluminum), TAZ (3-(4-biphenyl)-4-phenyl-5-tert-butylphenyl-1,2,4-triazole), NTAZ (4-(naphthalen-1-yl)-3,5-diphenyl-4H-1,2,4-triazole), or any combination thereof:

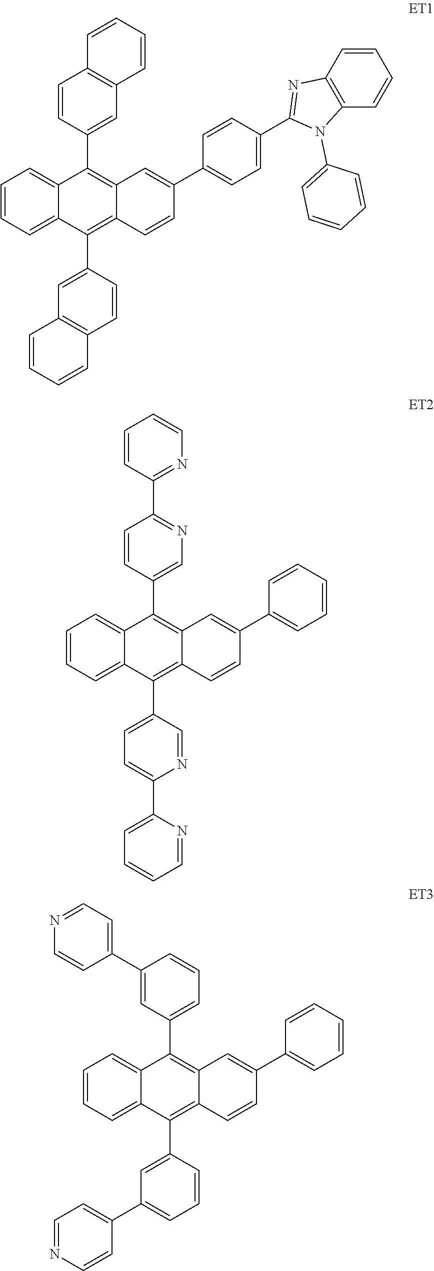 [SMILES: c1ccc(-n2c(-c3ccc(-c4ccc5c(-c6ccc7ccccc7c6)c6ccccc6c(-c6ccc7ccccc7c6)c5c4)cc3)nc3ccccc32)cc1 ; c1ccc(-c2ccc3c(-c4ccc(-c5ccccn5)nc4)c4ccccc4c(-c4ccc(-c5ccccn5)nc4)c3c2)cc1 ; c1ccc(-c2ccc3c(-c4cccc(-c5ccncc5)c4)c4ccccc4c(-c4cccc(-c5ccncc5)c4)c3c2)cc1]

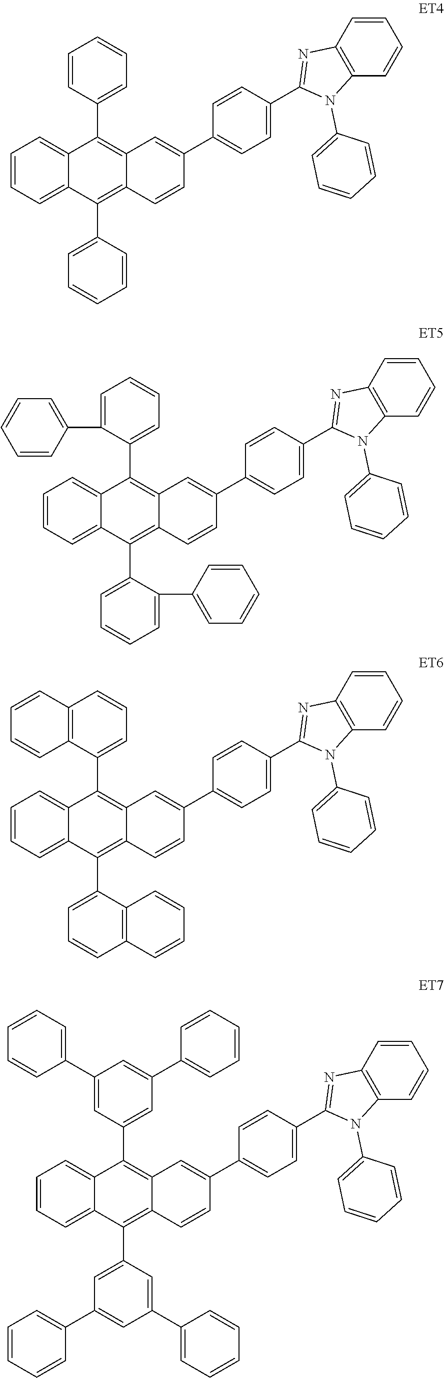 [SMILES: c1ccc(-c2c3ccccc3c(-c3ccccc3)c3cc(-c4ccc(-c5nc6ccccc6n5-c5ccccc5)cc4)ccc23)cc1 ; c1ccc(-c2ccccc2-c2c3ccccc3c(-c3ccccc3-c3ccccc3)c3cc(-c4ccc(-c5nc6ccccc6n5-c5ccccc5)cc4)ccc23)cc1 ; c1ccc(-n2c(-c3ccc(-c4ccc5c(-c6cccc7ccccc67)c6ccccc6c(-c6cccc7ccccc67)c5c4)cc3)nc3ccccc32)cc1 ; c1ccc(-c2cc(-c3ccccc3)cc(-c3c4ccccc4c(-c4cc(-c5ccccc5)cc(-c5ccccc5)c4)c4cc(-c5ccc(-c6nc7ccccc7n6-c6ccccc6)cc5)ccc34)c2)cc1]

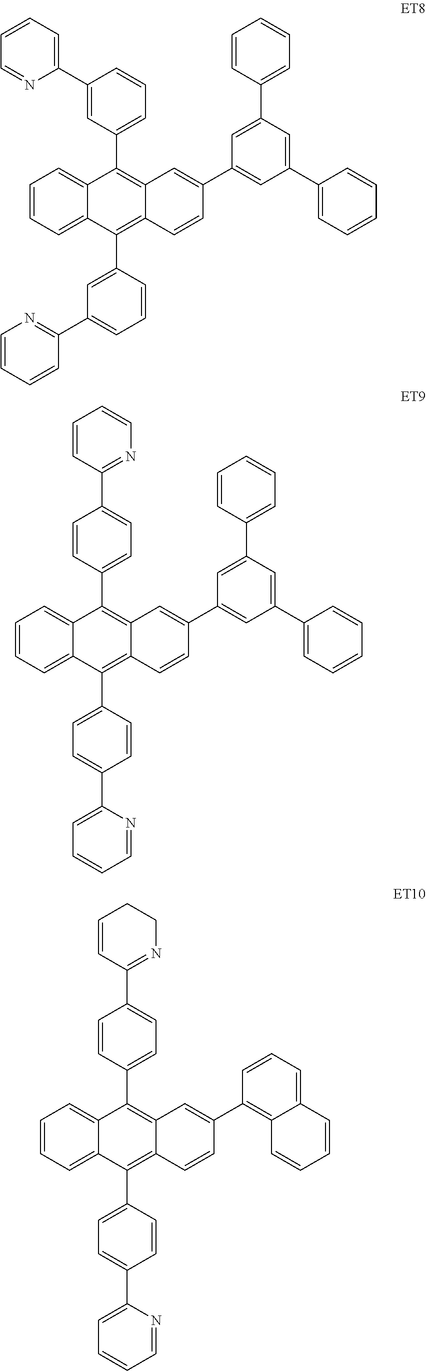

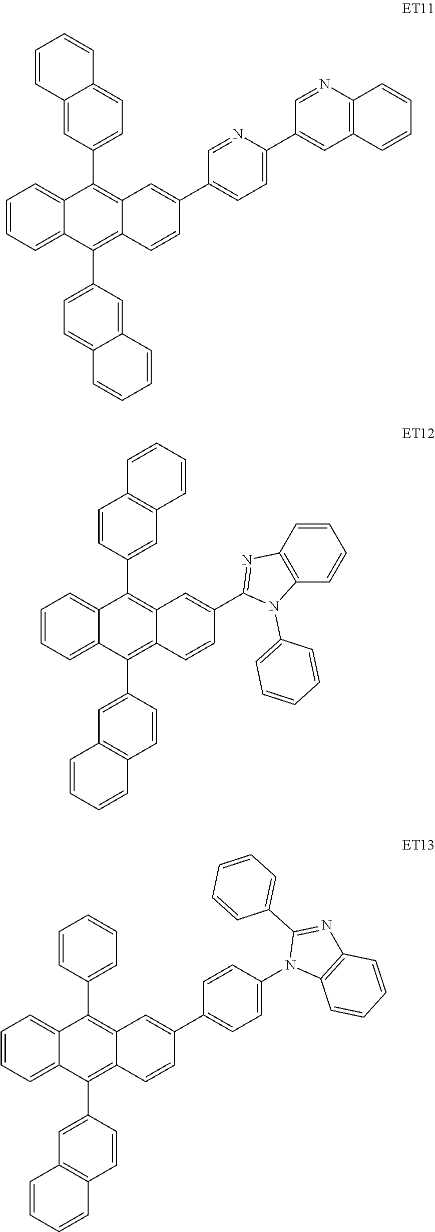 [SMILES: c1ccc2cc(-c3c4ccccc4c(-c4ccc5ccccc5c4)c4cc(-c5ccc(-c6cnc7ccccc7c6)nc5)ccc34)ccc2c1 ; c1ccc(-n2c(-c3ccc4c(-c5ccc6ccccc6c5)c5ccccc5c(-c5ccc6ccccc6c5)c4c3)nc3ccccc32)cc1 ; c1ccc(-c2c3ccccc3c(-c3ccc4ccccc4c3)c3ccc(-c4ccc(-n5c(-c6ccccc6)nc6ccccc65)cc4)cc23)cc1]

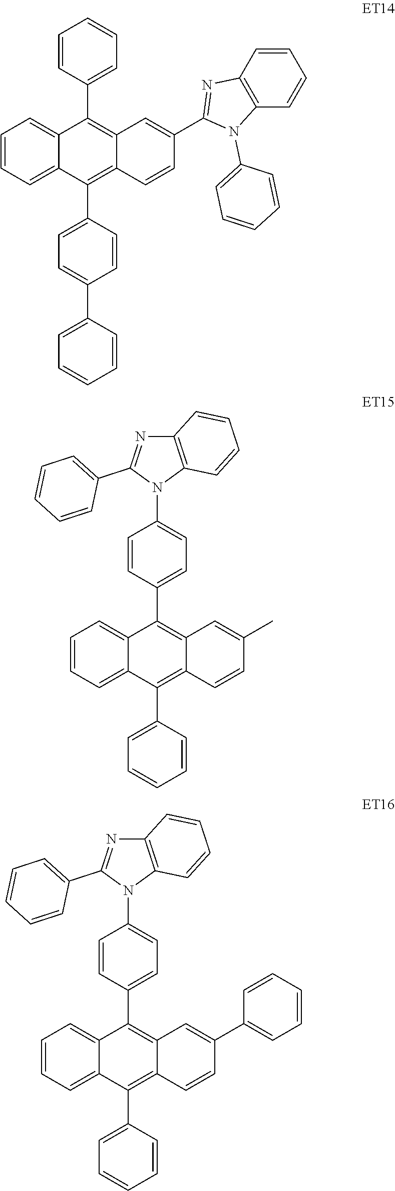

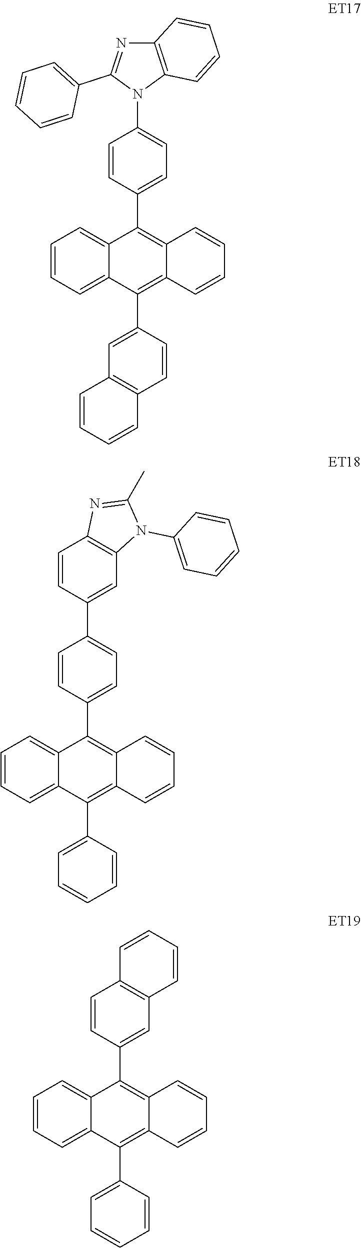

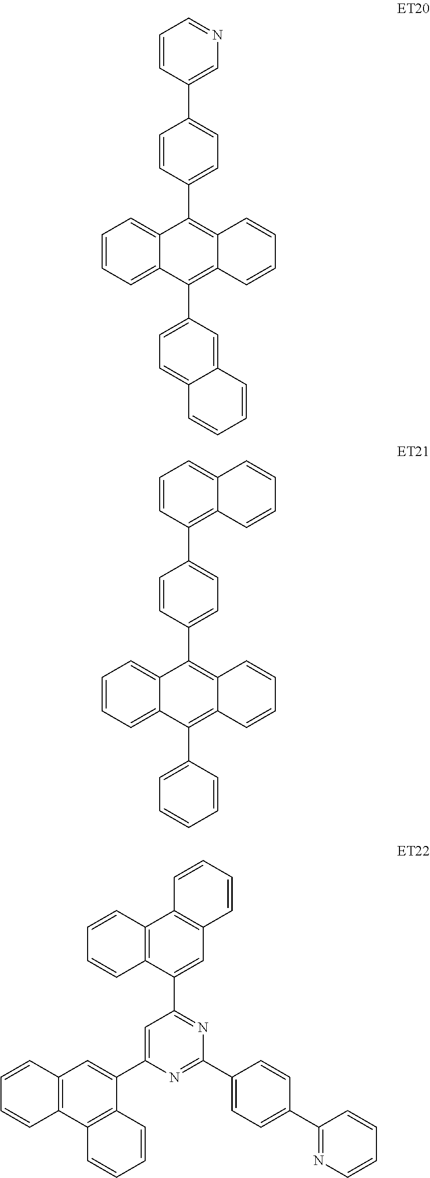

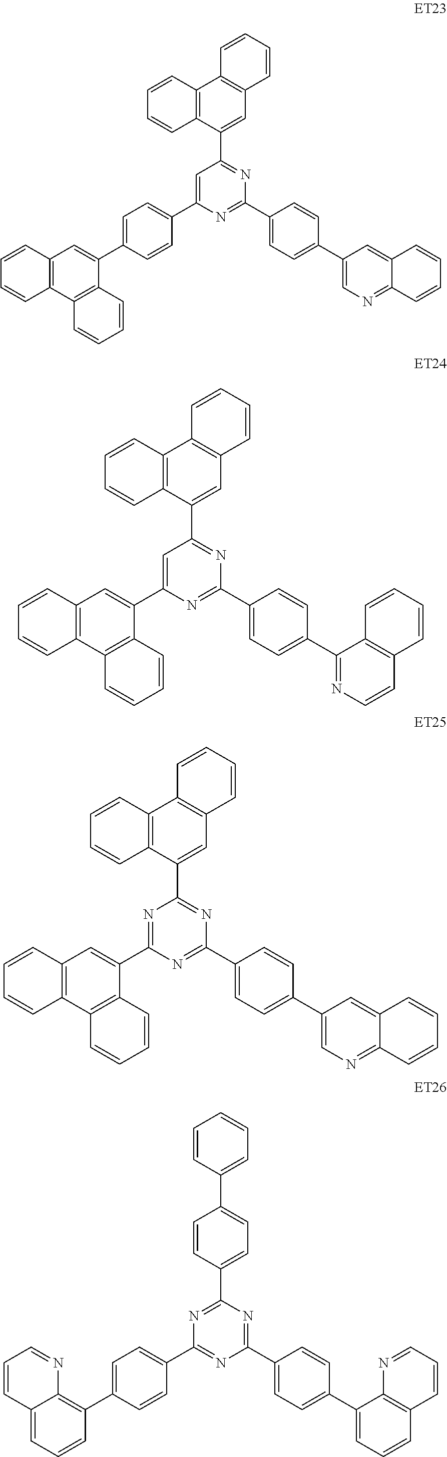 [SMILES: c1ccc2ncc(-c3ccc(-c4nc(-c5ccc(-c6cc7ccccc7c7ccccc67)cc5)cc(-c5cc6ccccc6c6ccccc56)n4)cc3)cc2c1 ; c1ccc2c(-c3ccc(-c4nc(-c5cc6ccccc6c6ccccc56)cc(-c5cc6ccccc6c6ccccc56)n4)cc3)nccc2c1 ; c1ccc2ncc(-c3ccc(-c4nc(-c5cc6ccccc6c6ccccc56)nc(-c5cc6ccccc6c6ccccc56)n4)cc3)cc2c1 ; c1ccc(-c2ccc(-c3nc(-c4ccc(-c5cccc6cccnc56)cc4)nc(-c4ccc(-c5cccc6cccnc56)cc4)n3)cc2)cc1]

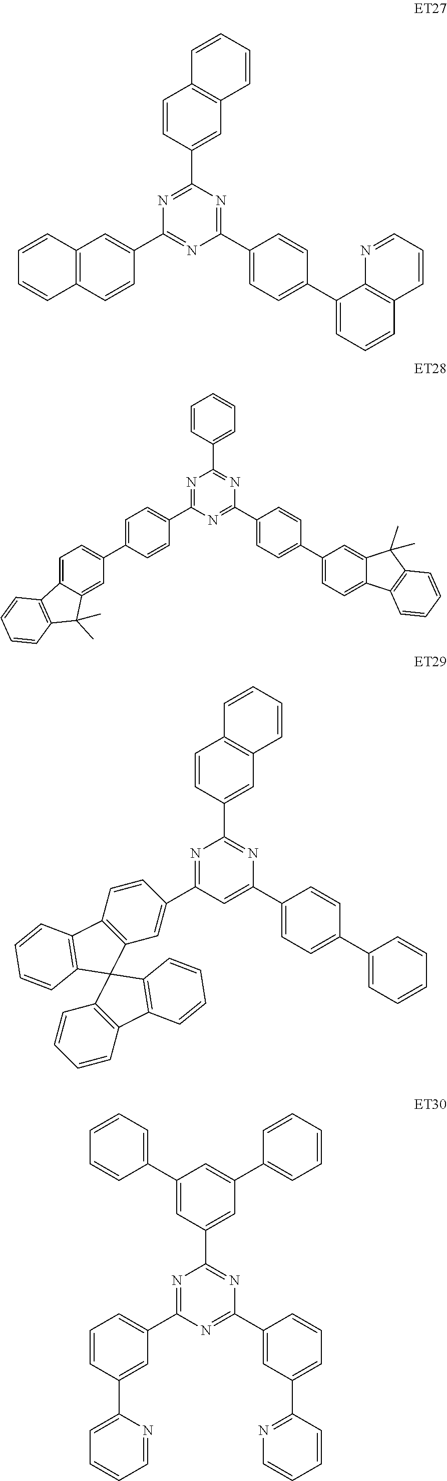 [SMILES: c1ccc2cc(-c3nc(-c4ccc(-c5cccc6cccnc56)cc4)nc(-c4ccc5ccccc5c4)n3)ccc2c1 ; CC1(C)c2ccccc2-c2ccc(-c3ccc(-c4nc(-c5ccccc5)nc(-c5ccc(-c6ccc7c(c6)C(C)(C)c6ccccc6-7)cc5)n4)cc3)cc21 ; c1ccc(-c2ccc(-c3cc(-c4ccc5c(c4)C4(c6ccccc6-c6ccccc64)c4ccccc4-5)nc(-c4ccc5ccccc5c4)n3)cc2)cc1 ; c1ccc(-c2cc(-c3ccccc3)cc(-c3nc(-c4cccc(-c5ccccn5)c4)nc(-c4cccc(-c5ccccn5)c4)n3)c2)cc1]

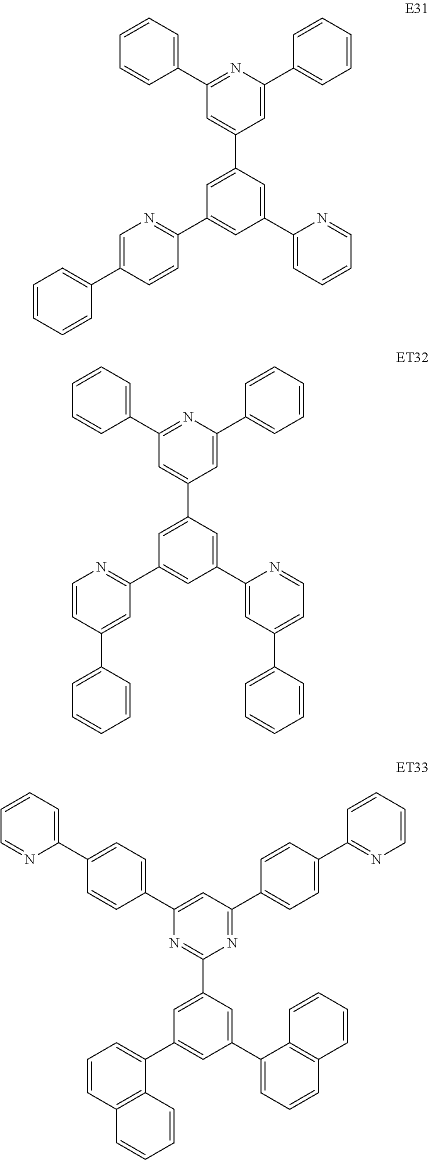 [SMILES: c1ccc(-c2ccc(-c3cc(-c4cc(-c5ccccc5)nc(-c5ccccc5)c4)cc(-c4ccccn4)c3)nc2)cc1 ; c1ccc(-c2ccnc(-c3cc(-c4cc(-c5ccccc5)nc(-c5ccccc5)c4)cc(-c4cc(-c5ccccc5)ccn4)c3)c2)cc1 ; c1ccc(-c2ccc(-c3cc(-c4ccc(-c5ccccn5)cc4)nc(-c4cc(-c5cccc6ccccc56)cc(-c5cccc6ccccc56)c4)n3)cc2)nc1]

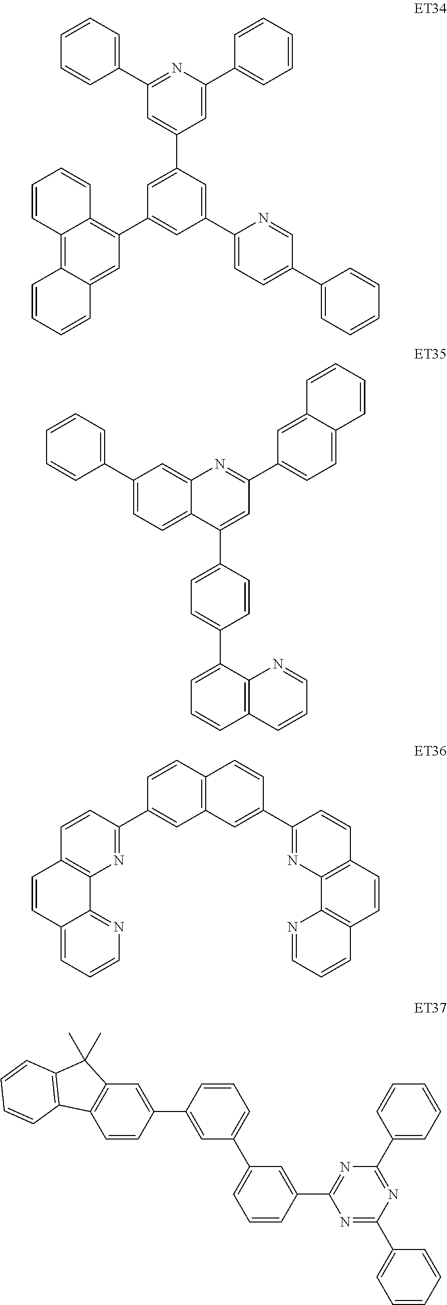

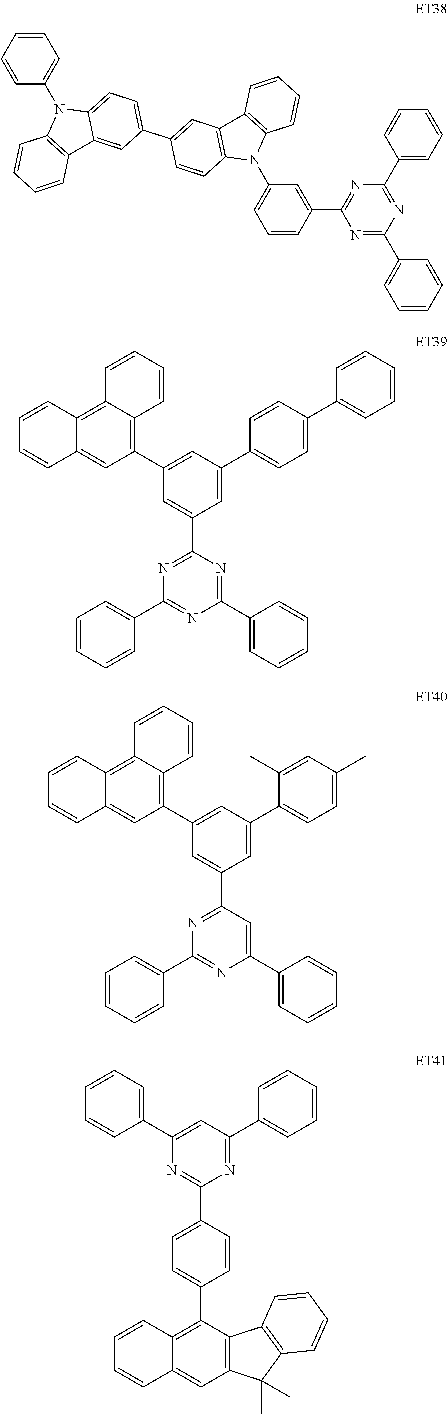 [SMILES: c1ccc(-c2nc(-c3ccccc3)nc(-c3cccc(-n4c5ccccc5c5cc(-c6ccc7c(c6)c6ccccc6n7-c6ccccc6)ccc54)c3)n2)cc1 ; c1ccc(-c2ccc(-c3cc(-c4nc(-c5ccccc5)nc(-c5ccccc5)n4)cc(-c4cc5ccccc5c5ccccc45)c3)cc2)cc1 ; Cc1ccc(-c2cc(-c3cc(-c4ccccc4)nc(-c4ccccc4)n3)cc(-c3cc4ccccc4c4ccccc34)c2)c(C)c1 ; CC1(C)c2ccccc2-c2c1cc1ccccc1c2-c1ccc(-c2nc(-c3ccccc3)cc(-c3ccccc3)n2)cc1]

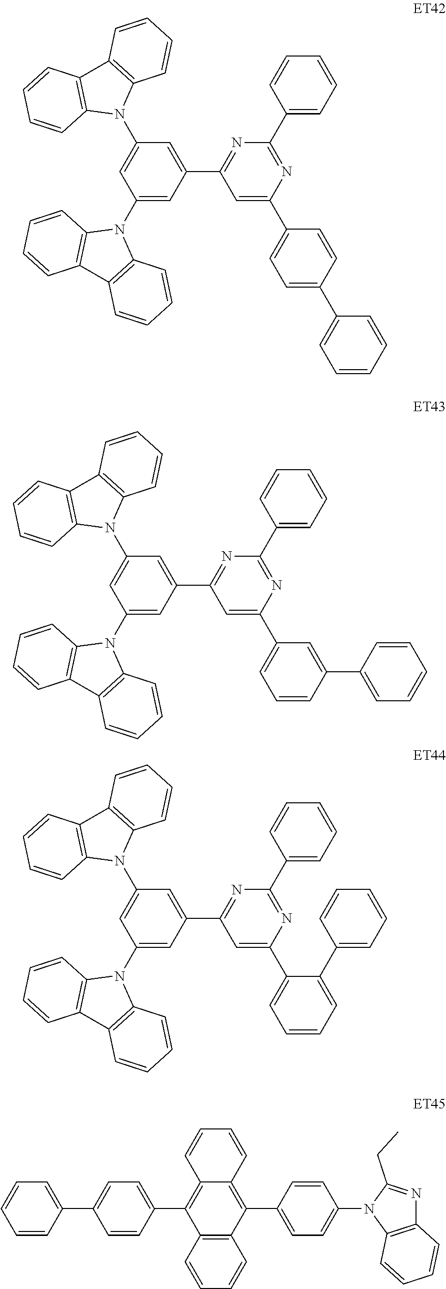

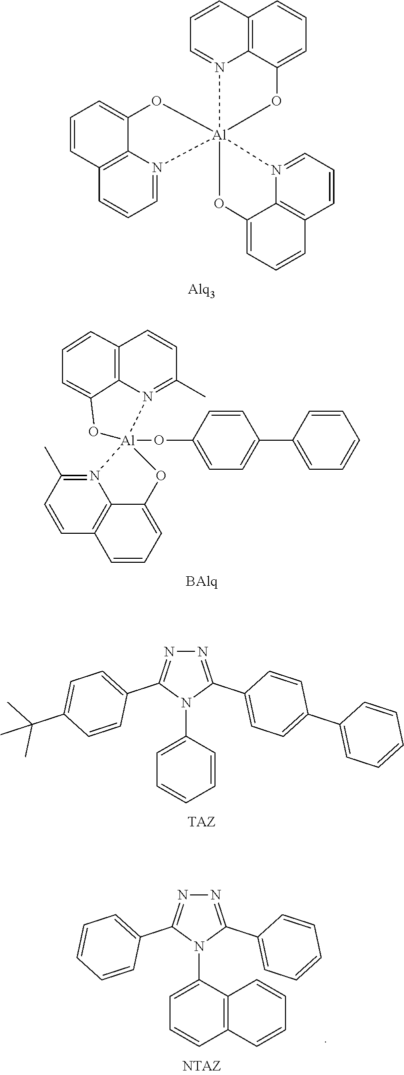

A thickness of the electron transport region may be from about 100 Å to about 5000 Å, for example, from about 160 Å to about 4000 Å. When the electron transport region includes a buffer layer, a hole blocking layer, an electron control layer, an electron transport layer, or any combination thereof, a thickness of the buffer layer, the hole blocking layer, or the electron control layer may each independently be about 20 Å to about 1000 Å, for example about 30 Å to about 300 Å, and a thickness of the electron transport layer may be from about 100 Å to about 1000 Å, for example about 150 Å to about 500 Å. When the thicknesses of the buffer layer, hole blocking layer, electron control layer, electron transport layer, and/or electron transport region satisfy the aforementioned ranges, satisfactory electron transport characteristics may be obtained without a substantial increase in driving voltage.

In one or more embodiments, the electron transport region (for example, the electron transport layer in the electron transport region) may further include a metal-containing material in addition to one or more of the materials described above.

The metal-containing material may include an alkali metal complex, an alkaline earth metal complex, or any combination thereof. A metal ion of the alkali metal complex may be a Li ion, a Na ion, a K ion, a Rb ion, or a Cs ion, and a metal ion of the alkaline earth metal complex may be a Be ion, an Mg ion, a Ca ion, an Sr ion, or a Ba ion. A ligand coordinated to the metal ion of the alkali metal complex or the metal ion of the alkaline earth metal complex may include hydroxyquinoline, hydroxyisoquinoline, hydroxybenzoquinoline, hydroxyacridine, hydroxyphenanthridine, hydroxyphenyloxazole, hydroxyphenylthiazole, hydroxyphenyloxadiazole, hydroxyphenylthiadiazole, hydroxyphenylpyridine, hydroxyphenylbenzimidazole, hydroxyphenylbenzothiazole, bipyridine, phenanthroline, cyclopentadiene, or any combination thereof.

For example, in one or more embodiments, the metal-containing material may include a Li complex. The Li complex may include, for example, the following compound ET-D1 (LiQ) or ET-D2:

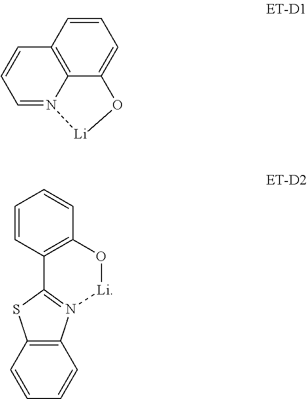

In one or more embodiments, the electron transport region may include an electron injection layer that facilitates electron injection from the second electrode 150. The electron injection layer may be in direct contact with the second electrode 150.

The electron injection layer may have i) a single-layer structure including (e.g., consisting of) a single layer including (e.g., consisting of) a single material, ii) a single-layer structure including (e.g., consisting of) a single layer including a plurality of different materials, or iii) a multi-layer structure that has a plurality of layers including a plurality of different materials.

The electron injection layer may include an alkali metal, an alkaline earth metal, a rare earth metal, an alkali metal-containing compound, an alkaline earth metal-containing compound, a rare earth metal-containing compound, an alkali metal complex, an alkaline earth metal complex, a rare earth metal complex, or any combination thereof.

The alkali metal may include Li, Na, K, Rb, Cs, or any combination thereof. The alkaline earth metal may include Mg, Ca, Sr, Ba, or any combination thereof. The rare earth metal may include Sc, Y, Ce, Tb, Yb, Gd, or any combination thereof.

The alkali metal-containing compound, the alkaline earth metal-containing compound, and the rare earth metal-containing compound may include an oxide, a halide (for example, a fluoride, a chloride, a bromide, an iodide, and/or the like), a telluride of the alkali metal, the alkaline earth metal and the rare earth metal, respectively, or any combination thereof.

The alkali metal-containing compound may include an alkali metal oxide such as Li₂O, Cs₂O, K₂O, and/or the like, an alkali metal halide such as LiF, NaF, CsF, KF, LiI, NaI, CsI, KI, and/or the like, or any combination thereof. The alkaline earth metal-containing compound may include an alkaline earth metal oxide such as BaO, SrO, CaO, BaₓSr₁₋ₓO (x is a real number satisfying 0<x<1), BaₓCa₁₋ₓO (x is a real number satisfying 0<x<1), and/or the like. The rare earth metal-containing compound may include YbF₃, ScF₃, Sc₂O₃, Y₂O₃, Ce₂O₃, GdF₃, TbF₃, YbI₃, ScI₃, TbI₃, or any combination thereof. In one or more embodiments, the rare earth metal-containing compound may include a lanthanide metal telluride. Non-limiting examples of the lanthanide metal telluride may include LaTe, CeTe, PrTe, NdTe, PmTe, SmTe, EuTe, GdTe, TbTe, DyTe, HoTe, ErTe, TmTe, YbTe, LuTe, La₂Te₃, Ce₂Te₃, Pr₂Te₃, Nd₂Te₃, Pm₂Te₃, Sm₂Te₃, Eu₂Te₃, Gd₂Te₃, Tb₂Te₃, Dy₂Te₃, Ho₂Te₃, Er₂Te₃, Tm₂Te₃, Yb₂Te₃, Lu₂Te₃, and/or the like.

The alkali metal complex, alkaline earth metal complex, and rare earth metal complex may include i) one of the metal ions of the alkali metal, one of the metal ions of alkaline earth metal, and one of the metal ions of rare earth metal as described above and ii) a ligand bonded to the respective metal ion, for example, hydroxyquinoline, hydroxyisoquinoline, hydroxybenzoquinoline, hydroxyacridine, hydroxyphenanthridine, hydroxyphenyloxazole, hydroxyphenylthiazole, hydroxyphenyloxadiazole, hydroxyphenylthiadiazole, hydroxyphenylpyridine, hydroxyphenylbenzimidazole, hydroxyphenylbenzothiazole, bipyridine, phenanthroline, cyclopentadiene, or any combination thereof.

In one or more embodiments, the electron injection layer may include (e.g., consist of) only the alkali metal, alkaline earth metal, rare earth metal, alkali metal-containing compound, alkaline earth metal-containing compound, rare earth metal-containing compound, alkali metal complex, alkaline earth metal complex, rare earth metal complex, or any combination thereof as described above, or may further include an organic material (for example, a compound represented by Formula 601).

According to one or more embodiments, the electron injection layer may include (e.g., consist of) i) an alkali metal-containing compound (for example, an alkali metal halide); or ii) a) an alkali metal-containing compound (for example, an alkali metal halide), and b) an alkali metal, an alkaline earth metal, a rare earth metal, or any combination thereof. For example, in one or more embodiments, the electron injection layer may be a KI:Yb co-deposition layer, an RbI:Yb co-deposition layer, a LiF:Yb co-deposition layer, and/or the like.

When the electron injection layer further includes an organic material, the alkali metal, the alkaline earth metal, the rare earth metal, the alkali metal-containing compound, the alkaline earth metal-containing compound, the rare earth metal-containing compound, the alkali metal complex, the alkaline earth metal complex, the rare earth metal complex, or any combination thereof may be uniformly (e.g., substantially uniformly) or non-uniformly dispersed in the matrix including the organic material.

A thickness of the electron injection layer may be from about 1 Å to about 100 Å, or from about 3 Å to about 90 Å. When the thickness of the electron injection layer satisfies the aforementioned ranges, satisfactory electron injection characteristics may be obtained without a substantial increase in driving voltage.

### Second Electrode 150

The second electrode 150 may be on (e.g., arranged on) top of the intermediate layer 130 as described above. The second electrode 150 may be a cathode, which is an electron injection electrode, in this regard, a metal, an alloy, an electrically conductive compound, or any combination thereof that has a low work-function may be used as a material for the second electrode 150.

The second electrode 150 may include lithium (Li), silver (Ag), magnesium (Mg), aluminum (Al), aluminum-lithium (Al—Li), calcium (Ca), magnesium-indium (Mg—In), magnesium-silver (Mg—Ag), ytterbium (Yb), silver-ytterbium (Ag—Yb), ITO, IZO, or any combination thereof. The second electrode 150 may be a transmissive electrode, a transflective electrode, a semi-transflective electrode, or a reflective electrode.

The second electrode 150 may have a single-layer structure or a multi-layer structure that has multiple layers.

### Capping Layer

In one or more embodiments, a first capping layer may be on (e.g., arranged on an outer side of) the first electrode 110, and/or a second capping layer may be on (e.g., arranged on an outer side of) the second electrode 150. For example, in one or more embodiments, the light-emitting element 1A may have a structure in which the first capping layer, the first electrode 110, the intermediate layer 130, and the second electrode 150 are sequentially stacked, a structure in which the first electrode 110, the intermediate layer 130, the second electrode 150, and the second capping layer are sequentially stacked, or a structure in which the first capping layer, the first electrode 110, the intermediate layer 130, the second electrode 150, and the second capping layer are sequentially stacked.

In one or more embodiments, light generated in the emission layer of the intermediate layer 130 of the light-emitting element 1A may be extracted to the outer side through the first electrode 110, which is a transmissive, a semi-transflective electrode, or a transflective electrode, and the first capping layer. In one or more embodiments, light generated in the emission layer of the intermediate layer 130 of the light-emitting element 1A may be extracted to the outer side through the second electrode 150, which is a transmissive electrode, a semi-transflective electrode, or a transflective electrode, and the second capping layer.

The first capping layer and second capping layer may serve to improve an external luminescence efficiency by the principle of constructive interference. Thereby, the light extraction efficiency of the light-emitting element 1A increases; as a result, the luminescence efficiency of the light-emitting element 1A may be improved.

Each of the first capping layer and the second capping layer may include a material that has a refractive index of 1.6 or more (at 589 nm).

The first capping layer and the second capping layer may each independently be a capping layer including the quantum dot, an organic capping layer including an organic material, an inorganic capping layer including an inorganic material, or an organic-inorganic composite capping layer including an organic material and an inorganic material.

At least one of the first capping layer or the second capping layer may (e.g., the first capping layer and the second capping layer may each independently) include a carbocyclic compound, a heterocyclic compound, an amine group-containing compound, a porphine derivative, a phthalocyanine derivative, a naphthalocyanine derivative, an alkali metal complex, an alkaline earth metal complex, or any combination thereof. The carbocyclic compound, the heterocyclic compound, and the amine group-containing compound may be each optionally substituted with substituents including O, N, S, Se, Si, F, Cl, Br, I, or any combination thereof. thereof.

According to one or more embodiments, at least one of the first capping layer or the second capping layer may (e.g., the first capping layer and the second capping layer may each independently) include an amine group-containing compound.

For example, in one or more embodiments, at least one of the first capping layer or the second capping layer may (e.g., the first capping layer and the second capping layer may each independently) include a compound represented by Formula 201, a compound represented by Formula 202, or any combination thereof.

According to one or more embodiments, at least one of the first capping layer or the second capping layer may (e.g., the first capping layer and the second capping layer may each independently) include one of (e.g., at least one selected from among) compounds HT28 to HT33, one of (e.g., at least one selected from among) compounds CP1 to CP6, β-NPB, or any compound thereof:

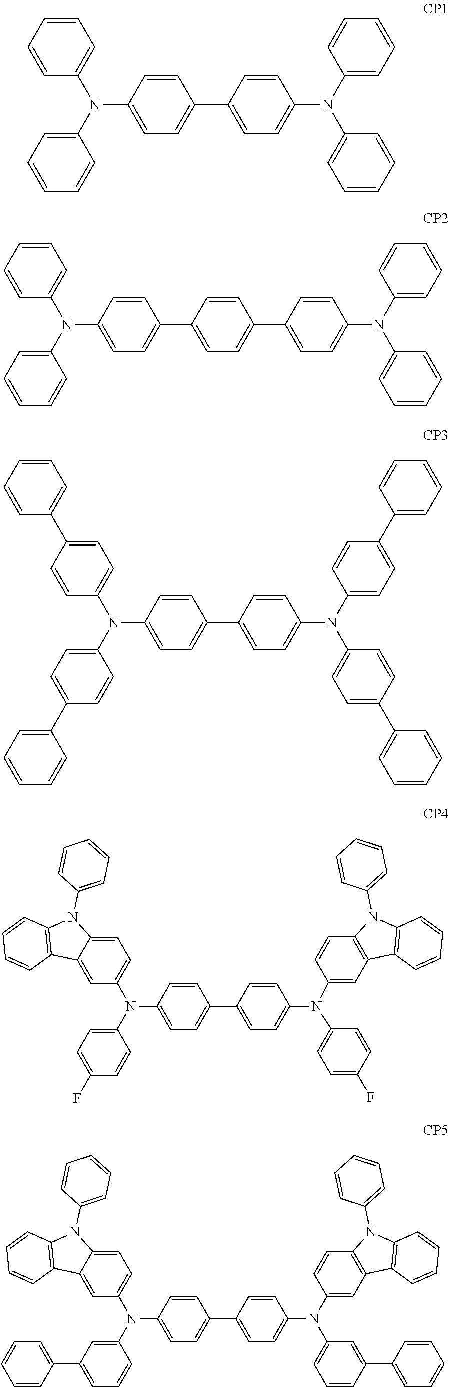 [SMILES: c1ccc(N(c2ccccc2)c2ccc(-c3ccc(N(c4ccccc4)c4ccccc4)cc3)cc2)cc1 ; c1ccc(N(c2ccccc2)c2ccc(-c3ccc(-c4ccc(N(c5ccccc5)c5ccccc5)cc4)cc3)cc2)cc1 ; c1ccc(-c2ccc(N(c3ccc(-c4ccccc4)cc3)c3ccc(-c4ccc(N(c5ccc(-c6ccccc6)cc5)c5ccc(-c6ccccc6)cc5)cc4)cc3)cc2)cc1 ; Fc1ccc(N(c2ccc(-c3ccc(N(c4ccc(F)cc4)c4ccc5c(c4)c4ccccc4n5-c4ccccc4)cc3)cc2)c2ccc3c(c2)c2ccccc2n3-c2ccccc2)cc1 ; c1ccc(-c2cccc(N(c3ccc(-c4ccc(N(c5cccc(-c6ccccc6)c5)c5ccc6c(c5)c5ccccc5n6-c5ccccc5)cc4)cc3)c3ccc4c(c3)c3ccccc3n4-c3ccccc3)c2)cc1]

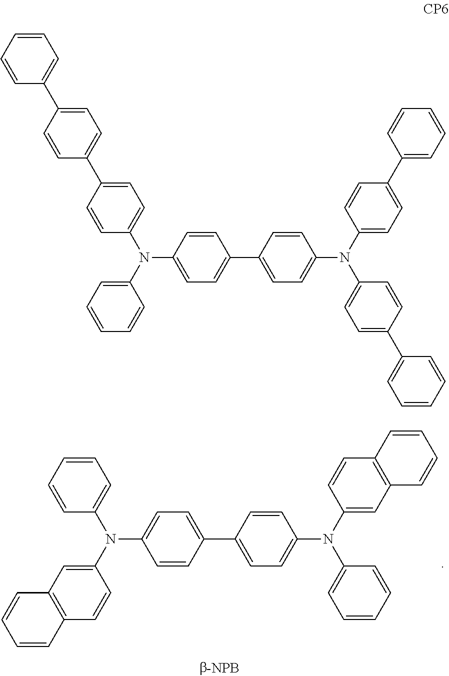

### Film

The quantum dots may be included in one or more suitable films. Accordingly, according to one or more embodiments of the present disclosure, a film including the quantum dot may be provided. The film may be, for example, an optical member (or a light control element) (for example, a color filter, a color conversion member, a capping layer, a light extraction efficiency enhancing layer, a selective light absorption layer, a polarizing layer, a quantum dot-containing layer, and/or the like), a light-shielding member (for example, a light reflective layer, a light absorption layer, and/or the like), a protective member (for example, an insulation layer, a dielectric layer, and/or the like), and/or the like.

### Optical Member

The quantum dot may be used in one or more suitable optical members.

Therefore, according to one or more embodiments of the present disclosure, provided is an optical member including the quantum dot.

According to one or more embodiments, the optical member may be a light control element.

According to one or more embodiments, the optical member may be a color filter, a color conversion member, a capping layer, a light extraction efficiency enhancement layer, a selective light absorption layer, or a polarization layer.

In one or more embodiments, the optical member may be a color conversion member.

The color conversion member may include a substrate and a pattern layer formed on the substrate.

The substrate may be the substrate of the color conversion member itself, or may be an area on which the color conversion member is arranged among one or more suitable apparatuses (for example, a display apparatus/device). The substrate may be glass, silicon (Si), silicon oxide (SiOₓ), or a polymer substrate, and the polymer substrate may be polyethersulfone (PES) or polycarbonate (PC).

The pattern layer may include the quantum dot in the form of a thin-film. For example, in one or more embodiments, the pattern layer may be a quantum dot in a form of a thin film.

The color conversion member including the substrate and the pattern layer may further include a partition wall or a black matrix formed between each pattern layer. In one or more embodiments, the color conversion member may further include a color filter to further improve light conversion efficiency.

In one or more embodiments, the color conversion member may include a red pattern layer that may be to emit red light, a green pattern layer that may be to emit green light, a blue pattern layer that may be to emit blue light, or any combination thereof. The red pattern layer, green pattern layer, and/or blue pattern layer may be implemented by controlling the components, composition, and/or structure of the quantum dot.

According to one or more embodiments of the present disclosure, provided is an apparatus including the quantum dot (or an optical member including the quantum dot).

The apparatus may further include a light source, and the quantum dot (or optical members including the quantum dots) may be arranged in a travel path of light emitted from the light source.

The light source may be to emit blue light, red light, green light, or white light. For example, the light source may be to emit blue light or red light. Additionally, light emitted from the light source may be absorbed by the quantum dot.

In one or more embodiments, the light source may be an organic light-emitting element (OLED) or a light-emitting element (LED).

Light emitted from the light source described above may be photoconverted by the quantum dot while passing through the quantum dot, and light that has a wavelength different from the wavelength of the light emitted from the light source may be emitted by the quantum dot.

For example, in one or more embodiments, the quantum dot may be to absorb and convert light emitted from the light source to emit light that has a maximum emission wavelength of about 400 nm to about 2500 nm.

### Electronic Apparatus

The quantum dot and/or the light-emitting element including the quantum dot may be included in one or more suitable electronic apparatuses. For example, in one or more embodiments, an electronic apparatus including the quantum dot and/or the light-emitting element including the quantum dot may be a light-emitting apparatus, an authentication apparatus, and/or the like.

In one or more embodiments, the electronic apparatus (for example, light-emitting apparatus) may further include, in addition to the light-emitting element, i) a color filter, ii) a color conversion layer, or iii) a color filter and a color conversion layer.

The color filter and/or color conversion layer may be arranged on at least one propagation direction of light emitted from the light-emitting element. For example, in one or more embodiments, the light emitted from the light-emitting element may be red light, blue light, or white light (e.g., combined white light). The description of the light-emitting element may refer to the details described above. According to one or more embodiments, the color conversion layer may include a quantum dot. The quantum dot may be, for example, a quantum dot as disclosed herein.

The electronic apparatus may include a first substrate. The first substrate may include a plurality of sub-pixel regions, the color filter may include a plurality of color filter regions respectively corresponding to the plurality of sub-pixel regions, and the color conversion layer may include a plurality of color conversion regions respectively corresponding to the plurality of sub-pixel regions.

A pixel defining layer may be arranged between the plurality of sub-pixel regions, defining each sub-pixel region.

The color filter may further include a plurality of color filter regions and a light-shielding pattern arranged among the plurality of color filter regions, the color conversion layer may further include a plurality of color conversion regions and a light-shielding pattern arranged among the plurality of color conversion regions.

The plurality of color filter regions (or the plurality of color conversion regions) may include, a first region configured to emit first-colored light; a second region configured to emit second-colored light; and/or a third region configured to emit third-colored light, wherein the first-colored light, second-colored light, and/or third-colored light may have different maximum emission wavelengths. For example, in one or more embodiments, the first-colored light may be a red light, the second-colored light may be a green light, and the third-colored light may be a blue light. For example, the plurality of color filter regions (or the plurality of color conversion regions) may include quantum dots. For example, in one or more embodiments, the first region may include a red quantum dot to emit red light, the second region may include a green quantum dot to emit green light, and the third region may not include (e.g., may exclude) any quantum dot. The description of the quantum dot may refer to details disclosed herein. The first region, the second region, and/or the third region may each further include a scattering agent.

In one or more embodiments, the light-emitting element may be to emit a first light, and the first region may be to absorb the first light and emit a first-first-colored light; the second region may be to absorb the first light and emit a second-first-colored light; and the third region may be to absorb the first light and emit a third-first-colored light. In this regard, the first-first-colored light, the second-first-colored light, and the third-first-colored light may have different maximum emission wavelengths. For example, in one or more embodiments, the first light may be a blue light, the first-first-colored light may be a red light, the second-first-colored light may be a green light, and the third-first-colored light may be a blue light.

In one or more embodiments, the electronic apparatus may further include a thin-film transistor in addition to the light-emitting element described above. The thin-film transistor may include a source electrode, a drain electrode, and an active layer, and one selected from among the source electrode and the drain electrode may be electrically connected to the first electrode or the second electrode of the light-emitting element.

The thin-film transistor may further include a gate electrode, a gate insulating layer, and/or the like.

The active layer may include crystalline silicon, amorphous silicon, an organic semiconductor, an oxide semiconductor, and/or the like.

In one or more embodiments, the electronic apparatus may further include a sealing portion that seals the light-emitting element. The sealing portion may be arranged between the color filter and/or the color conversion layer and the light-emitting element. The sealing portion allows light from the light-emitting element to be extracted externally while concurrently (e.g., simultaneously) blocking external air and moisture from infiltrating into the light-emitting element. The sealing portion may be a sealing substrate including a transparent glass substrate or a plastic substrate. The sealing portion may be a thin-film encapsulation layer including one or more of organic layers and/or inorganic layers. When the sealing portion is a thin-film encapsulation layer, the electronic apparatus may be flexible.

On the sealing portion, in addition to the color filter and/or color conversion layer, one or more suitable functional layers may be additionally arranged depending on the purpose of the electronic apparatus. Non-limiting examples of the functional layer may include a touch screen layer, a polarizing layer, and/or the like. The touch screen layer may be a pressure-sensitive touch screen layer, a capacitive touch screen layer, or an infrared touch screen layer.

The authentication apparatus may further include a sensor for collecting biometric information in addition to the light-emitting element as described above. The authentication apparatus may be, for example, a biometric authentication apparatus that authenticates an individual using biometric information (for example, fingertips, pupils, and/or the like).

The electronic apparatus may be applied to one or more of displays, light sources, lighting apparatus, personal computers (for example, mobile personal computers), mobile phones, digital cameras, electronic notepads, electronic dictionaries, electronic game consoles, medical devices (for example, electronic thermometers, blood pressure monitors, blood glucose meters, pulse measurement devices, pulse wave measurement devices, electrocardiograph display apparatuses, ultrasound diagnostic devices, endoscopic display apparatuses), fish finders, one or more suitable measurement instruments, gauges (for example, instruments for vehicles, aircraft, or ships), projectors, and/or the like.

### Electronic Devices

The quantum dot and the light-emitting element including the quantum dot may be included in one or more suitable electronic devices.

For example, in one or more embodiments, the electronic device (e.g., with a display device) including the light-emitting element may be at least one of a flat panel display, a curved display, a computer monitor, a medical monitor, a television, a billboard, an indoor light, an outdoor light, a signaling light, a head-up display, a fully transparent display, a partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro display, a 3D display, a virtual reality display, an augmented reality display, a vehicle, a video wall including tiled multiple displays, a theater or stadium screen, a phototherapy device, and a signboard.

Because the light-emitting element has excellent or suitable luminescence efficiency, long-life effect, and/or the like, the electronic device including the light-emitting element may have characteristics such as high brightness, high resolution, and low power consumption, and/or the like.

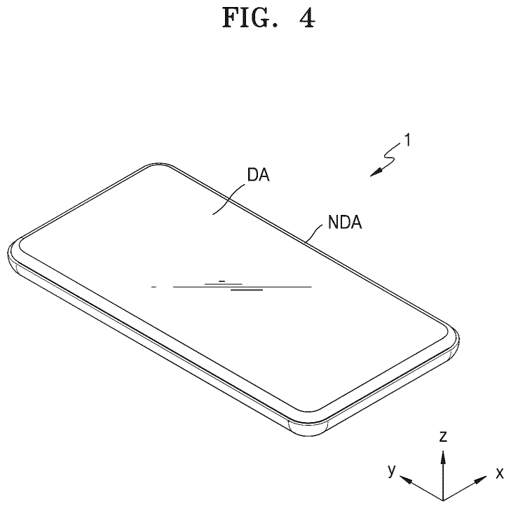

### Description of FIG. 4

FIG. 4 is a perspective view schematically illustrating an electronic device 1 including a light-emitting element according to one or more embodiments of the present disclosure. The electronic device 1 is an apparatus that displays a moving image or a still image, and may be a mobile phone, a smart phone, a tablet personal computer, a mobile communication terminal, an electronic notebook, an e-book, a portable multimedia player (PMP), a navigation device, an Ultra Mobile PC (UMPC), or other portable electronic devices, as well as one or more other suitable products or parts thereof, such as a television, a laptop, a monitor, a billboard, or an Internet of Things (IOT), and/or the like. In one or more embodiments, the electronic device 1 may be a wearable device such as a smart watch, a watch phone, an eyewear display, or a head mounted display (HMD), or a part thereof. Of course, embodiments of the disclosure are not limited thereto. For example, in one or more embodiments, the electronic device 1 may be a dashboard of a vehicle, a center information display (CID) placed on a center fascia or dashboard of a vehicle, a room mirror display replacing a side mirror of a vehicle, a display placed on the rear seat entertainment of a vehicle or on the back of a front seat thereof, a head-up display (HUD) installed at the front of a vehicle or projected on a front window glass thereof, or a computer-generated hologram augmented reality head-up display (CGH AR HUD). For convenience of explanation, FIG. 4 illustrates an embodiment in which the electronic device 1 is a smart phone.

The electronic device 1 may include a display area DA and a non-display area NDA on the outer side (e.g., around) the display area DA. The display apparatus of the electronic device 1 may implement an image through a plurality of multiple pixels arranged two-dimensionally in the display area DA.

The non-display area NDA is an area that does not display an image, and may completely be around (e.g., surround) the display area DA. Drivers and/or the like for providing electrical signals or power to display devices arranged in the display area (DA) may be arranged in the non-display area (NDA). Pads, which are areas where electronic devices or printed circuit boards and/or the like may be electrically connected, may be arranged in the non-display area (NDA).

The electronic device 1 may have different lengths in an x-axis direction and in a y-axis direction. For example, as shown in FIG. 4, in one or more embodiments, a length in the x-axis direction may be shorter than a length (e.g., a width) in the y-axis direction. In one or more embodiments, the length in the x-axis direction and the length (e.g., the width) in the y-axis direction may be substantially the same. In one or more embodiments, the length in the x-axis direction may be longer than the length (e.g., the width) in the y-axis direction.

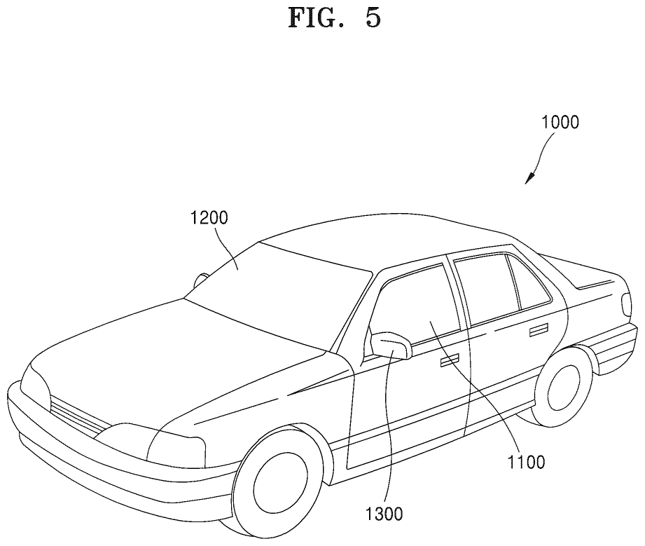

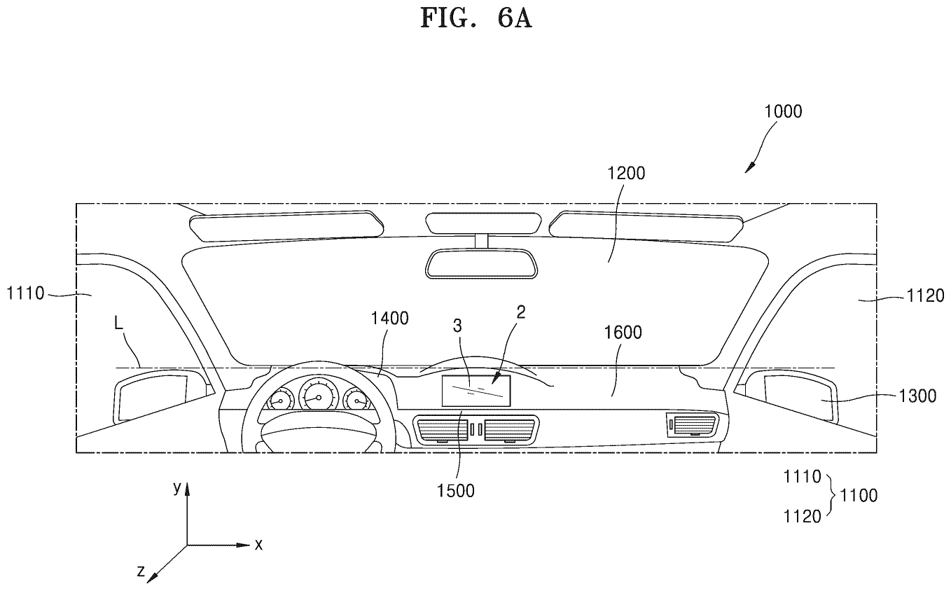

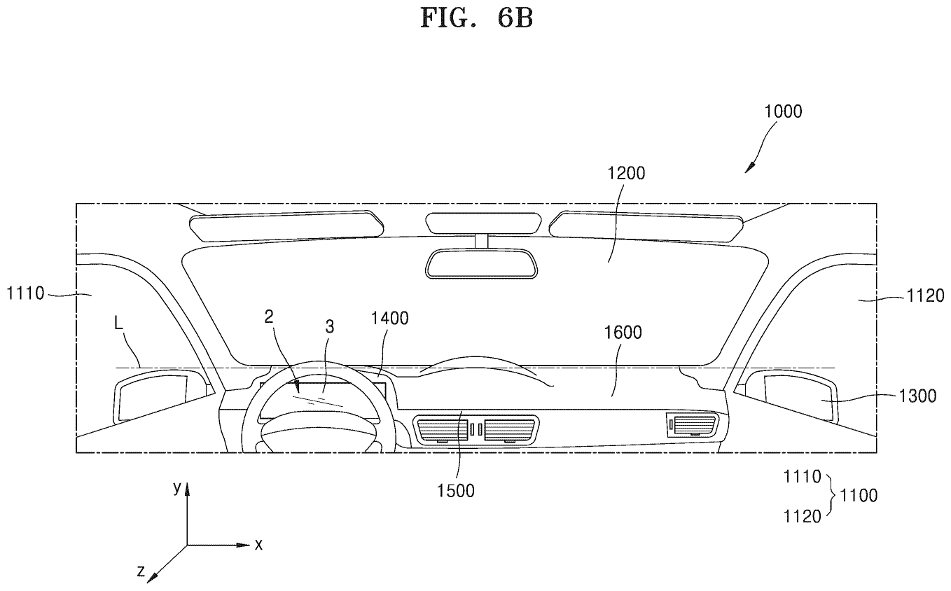

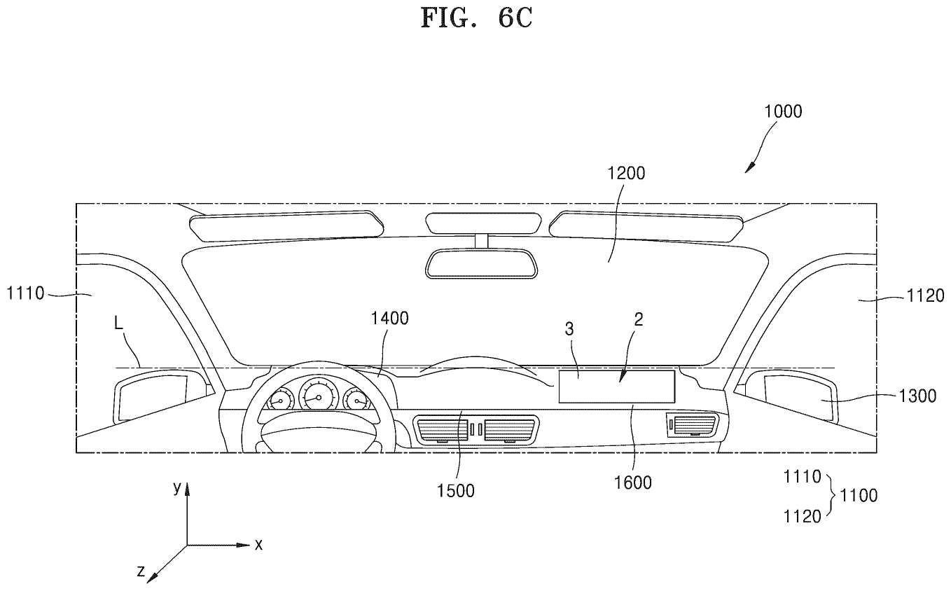

### Description of FIG. 5 and FIG. 6A to FIG. 6C

FIG. 5 is a diagram schematically illustrating an exterior of a vehicle 1000 as an electronic device including a light-emitting element according to one or more embodiments of the present disclosure. FIG. 6A to FIG. 6C are each a diagram schematically illustrating an interior of the vehicle 1000 according to one or more embodiments.

Referring to FIG. 5, FIG. 6A, FIG. 6B, and FIG. 6C, the vehicle 1000 may refer to one or more suitable apparatuses that move a transport object, such as a human, an object, or an animal, and/or the like, from a starting point to a destination.

The vehicle 1000 may include a vehicle running on a road or a rail, a ship moving on the sea or a river, and an airplane flying in the sky utilizing the effects of air.

In one or more embodiments, the vehicle 1000 may drive on a road or a track. The vehicle 1000 may move in a certain direction according to the rotation of at least one wheel thereof. For example, the vehicle 1000 may include a three-wheeled or four-wheeled automobile, construction machinery, a two-wheeled automobile, a motorized apparatus, a bicycle, or a train running on a track.

The vehicle 1000 may include a body that has an interior and an exterior, and a chassis on which mechanical apparatuses necessary for driving are installed, excluding the body. The exterior of the body of the vehicle 1000 may include a front panel, bonnet, roof panel, rear panel, trunk, and pillars provided at the boundaries between doors. The chassis of the vehicle 1000 may include a power generation apparatus, a power transmission apparatus, a driving apparatus, a steering apparatus, a braking apparatus, a suspension apparatus, a transmission apparatus, a fuel apparatus, front, rear, left, and right wheels, and/or the like.

The vehicle 1000 may include a side window glass 1100, a front window glass 1200, a side mirror 1300, a cluster 1400, a center fascia 1500, a passenger dashboard 1600, and a display apparatus 2.

The side window glass 1100 and the front window glass 1200 may be partitioned by a pillar arranged between the side window glass 1100 and the front window glass 1200.

The side window glass 1100 may be installed on a side of the vehicle 1000. In one or more embodiments, the side window glass 1100 may be installed on a door of the vehicle 1000. The side window glass 1100 may be provided in plural and may face each other. In one or more embodiments, the side window glass 1100 may include a first side window glass 1110 and a second side window glass 1120. In one or more embodiments, the first side window glass 1110 may be arranged adjacent to the cluster 1400. The second side window glass 1120 may be arranged adjacent to the passenger dashboard 1600.

In one or more embodiments, the side window glasses 1100 may be spaced and/or apart (e.g., spaced apart or separated) from each other in an x direction or a −x direction (the direction opposite the x-direction). For example, the first side window glass 1110 and the second side window glass 1120 may be spaced and/or apart (e.g., spaced apart or separated) from each other in the x direction or the −x direction. For example, an imaginary straight line L connecting the side window glasses 1100 may extend in the x direction or the −x direction. For example, the imaginary straight line L connecting the first side window glass 1110 and the second side window glass 1120 may extend in the x direction or the −x direction.

The front window glass 1200 may be installed at the front of the vehicle 1000. The front window glass 1200 may be arranged between the side window glasses 1100 opposite to (e.g., facing) each other.

The side mirror 1300 may provide a rearward visibility of the vehicle 1000. The side mirror 1300 may be installed on the exterior of the vehicle body. In one or more embodiments, the side mirrors 1300 may be provided in plural. Any one of the plurality of side mirrors 1300 may be arranged on the outer side of the first side window glass 1110. Another one of the plurality of side mirrors 1300 may be arranged on the outer side of the second side window glass 1120.

The cluster 1400 may be located in front of a steering wheel. The cluster 1400 may be arranged with a tachometer, speedometer, coolant temperature gauge, fuel gauge, turn signal indicator, high beam indicator, warning light, seat belt warning light, odometer, trip meter, automatic transmission selector indicator, door open warning light, engine oil warning light, and/or fuel shortage warning light.

The center fascia 1500 may include a control panel arranged with a plurality of buttons for adjusting an audio apparatus, an air conditioning apparatus, and/or seat heaters. The center fascia 1500 may be arranged on one side of the cluster 1400.

The passenger dashboard 1600 may be spaced and/or apart (e.g., spaced apart or separated) from the cluster 1400 with the center fascia 1500 in between. In one or more embodiments, the cluster 1400 may be arranged corresponding to a driver seat, and the passenger dashboard 1600 may be arranged corresponding to a passenger seat. In one or more embodiments, the cluster 1400 may be adjacent to the first side window glass 1110, and the passenger dashboard 1600 may be adjacent to the second side window glass 1120.

In one or more embodiments, the display apparatus 2 may include a display panel 3, wherein the display panel 3 may display an image. The display apparatus 2 may be arranged inside the vehicle 1000. In one or more embodiments, the display apparatus 2 may be arranged between side window glasses 1100 opposite to (e.g., facing) each other. The display apparatus 2 may be arranged on at least one of the cluster 1400, the center fascia 1500, or the passenger dashboard 1600.

The display apparatus 2 may include an organic light emitting display, an inorganic light emitting display, a quantum dot display, and/or the like, hereinafter, an organic light emitting display including a light-emitting element according to the present disclosure will be described as an example of a display apparatus 2 according to one or more embodiments, but one or more suitable types (kinds) of display apparatuses as described above may be used in one or more embodiments.

Referring to FIG. 6A, in one or more embodiments, the display apparatus 2 may be arranged in the center fascia 1500. In one or more embodiments, the display apparatus 2 may display navigation information. In one or more embodiments, the display apparatus 2 may display information regarding audio, video, and/or vehicle settings.

Referring to FIG. 6B, in one or more embodiments, the display device 2 may be arranged in the cluster 1400. In these embodiments, the cluster 1400 may display driving information and/or the like through the display apparatus 2. For example, the cluster 1400 may be implemented digitally. The digital cluster 1400 may display vehicle information and driving information as images. For example, a needle and a gauge of the tachometer and one or more suitable warning light icons may be displayed through digital signals.

Referring to FIG. 6C, in one or more embodiments, the display apparatus 2 may be arranged in the passenger dashboard 1600. The display apparatus 2 may be embedded in the passenger dashboard 1600 or located on the passenger dashboard 1600. In one or more embodiments, a display apparatus 2 arranged on the passenger dashboard 1600 may display an image related to information displayed on the cluster 1400 and/or information displayed on the center fascia 1500. In one or more embodiments, the display apparatus 2 arranged on the passenger dashboard 1600 may display information that is different from the information displayed on the cluster 1400 and/or the information displayed on the center fascia 1500.

### Method of Preparation

Each layer included in the hole transport region, each layer included in the emission layer, and each layer included in the electron transport region may be formed in a certain region using one or more suitable methods, such as vacuum deposition, spin coating, casting, Langmuir-Blodgett (LB) deposition, inkjet printing, laser printing, laser induced thermal imaging (LITI), and/or the like.

When each layer included in the hole transport region, the emission layer, and each layer included in the electron transport region is formed by vacuum deposition, the deposition conditions may be selected, for example, within a deposition temperature range of about 100° C. to about 500° C., a vacuum degree of about 10⁻⁸ torr to about 10⁻³ torr, and a deposition rate of about 0.01 Å/sec to about 100 Å/sec, by considering a material to be included in the layer to be formed and the structure of the layer to be formed.

### Definition of Terms

As used herein, a C₃-C₆₀ carbocyclic group refers to a cyclic group that has 3 carbon atoms to 60 carbon atoms and consists solely of carbon as a ring-forming atom, and a C₁-C₆₀ heterocyclic group refers to a cyclic group that has 1 carbon atom to 60 carbon atoms and further includes a hetero atom as a ring-forming atom in addition to carbon. Each of the C₃-C₆₀ carbocyclic group and C₁-C₆₀ heterocyclic group may be a monocyclic group including (e.g., consisting of) one (e.g., exactly one) ring or a polycyclic group in which two or more rings are condensed together. For example, the number of ring-forming atoms in the C₁-C₆₀ heterocyclic group may be 3 to 61.

As used herein, the cyclic group includes both (e.g., simultaneously) the C₃-C₆₀ carbocyclic group and the C₁-C₆₀ heterocyclic group.

As used herein, a π electron-rich C₃-C₆₀ cyclic group refers to a cyclic group that has 3 carbon atoms to 60 carbon atoms and does not include *—N═*′ as a ring-forming moiety, and a π electron-deficient nitrogen-containing C₁-C₆₀ cyclic group refers to a heterocyclic group that has 1 carbon atom to 60 carbon atoms and includes *—N═*′ as a ring-forming moiety.

For example,

The C₃-C₆₀ carbocyclic group may be i) a group T1 or ii) a condensed ring group in which two or more groups T1 are condensed with each other (for example, a cyclopentadiene group, an adamantane group, a norbornane group, a benzene group, a pentalene group, a naphthalene group, an azulene group, an indacene group, an acenaphthylene group, a phenalene group, a phenanthrene group, anthracene group, a fluoranthene group, a triphenylene group, a pyrene group, a chrysene group, a perylene group, a pentaphene group, a heptalene group, a naphthacene group, a picene group, a hexacene group, a pentacene group, a rubicene group, a coronene group, an ovalene group, an indene group, a fluorene group, a spiro-bifluorene group, a benzofluorene group, an indenophenanthrene group, or an indenoanthracene group),

The C₁-C₆₀ heterocyclic group may be i) a group T2, ii) a condensed ring group in which two or more groups T2 are condensed with each other, or iii) a condensed ring group in which one or more groups T2 and one or more groups T1 are condensed with each other (for example, a pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, a benzothienodibenzothiophene group, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, an azadibenzofuran group, and/or the like),

The π electron-rich C₃-C₆₀ cyclic group may be i) the group T1, ii) the condensed ring group in which two or more groups T1 are condensed with each other, iii) a group T3, iv) a condensed ring group in which two or more groups T3 are condensed with each other, or v) a condensed ring group in which one or more groups T3 and one or more groups T1 are condensed with each other (for example, the C₃-C₆₀ carbocyclic group, a 1H-pyrrole group, a silole group, a borole group, a 2H-pyrrole group, a 3H-pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, indenocarbazole group, indolocarbazole group, benzofurocarbazole group, benzothienocarbazole group, benzosilolocarbazole group, benzoindolocarbazole group, benzocarbazole group, benzonaphthofuran group, benzonaphthothiophene group, benzonaphthosilole group, benzofurodibenzofuran group, benzofurodibenzothiophene group, benzothienodibenzothiophene group, and/or the like),

The π electron-deficient nitrogen-containing C₁-C₆₀ cyclic group may be i) a group T4, ii) a condensed ring group in which two or more groups T4 are condensed with each other, iii) a condensed ring group in which one or more groups T4 and one or more groups T1 are condensed with each other, iv) a condensed ring group in which one or more groups T4 and one or more groups T3 are condensed with each other, or v) a condensed ring group in which one or more groups T4, one or more groups T1, and one or more groups T3 are condensed with one another (for example, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, an azadibenzofuran group, and/or the like),

The group T1 may be a cyclopropane group, a cyclobutane group, a cyclopentane group, a cyclohexane group, a cycloheptane group, a cyclooctane group, a cyclobutene group, a cyclopentene group, a cyclopentadiene group, a cyclohexene group, a cyclohexadiene group, a cycloheptene group, an adamantane group, a norbornane (or, bicyclo[2.2.1]heptane) group, a norbornene group, a bicyclo[1.1.1]pentane group, a bicyclo[2.1.1]hexane group, a bicyclo[2.2.2]octane group, or a benzene group,

The group T2 may be a furan group, a thiophene group, a 1H-pyrrole group, a silole group, a borole group, a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, a tetrazine group, a pyrrolidine group, an imidazolidine group, a dihydropyrrole group, a piperidine group, a tetrahydropyridine group, a dihydropyridine group, a hexahydropyrimidine group, a tetrahydropyrimidine group, a dihydropyrimidine group, a piperazine group, a tetrahydropyrazine group, a dihydropyrazine group, a tetrahydropyridazine group, or a dihydropyridazine group,

The group T3 may be a furan group, a thiophene group, a 1H-pyrrole group, a silole group, or a borole group,

The group T4 may be a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, or a tetrazine group.

As used herein, the terms “cyclic group,” “C₃-C₆₀ carbocyclic group,” “C₁-C₆₀ heterocyclic group,” “π electron-rich C₃-C₆₀ cyclic group,” or “π electron-deficient nitrogen-containing C₁-C₆₀ cyclic group” may, depending on the structure of a formula in which the term is used, be a group condensed to any cyclic group, a monovalent group or a polyvalent group (for example, a divalent group, a trivalent group, a tetravalent group, and/or the like). For example, a “benzene group” may be a benzo group, a phenyl group, a phenylene group, and/or the like, which could be easily understood by those skilled in the art depending on the structure of a formula including the “benzene group.”

For example, non-limiting examples of a monovalent C₃-C₆₀ carbocyclic group and a monovalent C₁-C₆₀ heterocyclic group may include a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₁-C₆₀ heteroaryl group, a monovalent non-aromatic condensed polycyclic group, and a monovalent non-aromatic condensed heteropolycyclic group, and non-limiting examples of a divalent C₃-C₆₀ carbocyclic group and a divalent C₁-C₆₀ heterocyclic group may include a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a C₁-C₆₀ heteroarylene group, a divalent non-aromatic condensed polycyclic group, and a divalent non-aromatic condensed heteropolycyclic group.

As used herein, the term “C₁-C₆₀ alkyl group” refers to a linear or branched aliphatic hydrocarbon monovalent group that has 1 carbon atom to 60 carbon atoms, and non-limiting examples of which include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and/or the like. As used herein, the term “C₁-C₆₀ alkylene group” refers to a divalent group that has substantially the same structure as the C₁-C₆₀ alkyl group.

As used herein, the term “C₂-C₆₀ alkenyl group” refers to a monovalent hydrocarbon group including one or more carbon-carbon double bond in the middle or terminal of a C₂-C₆₀ alkyl group, and non-limiting examples thereof include an ethenyl group, a propenyl group, a butenyl group, and/or the like. As used herein, the term “C₂-C₆₀ alkenylene group” refers to a divalent group that has substantially the same structure as the C₂-C₆₀ alkenyl group.

As used herein, the term “C₂-C₆₀ alkynyl group” refers to a monovalent hydrocarbon group including one or more carbon-carbon triple bond in the middle or terminal of a C₂-C₆₀ alkyl group, and non-limiting examples thereof include an ethynyl group, a propynyl group, and/or the like. As used herein, the term “C₂-C₆₀ alkynylene group” refers to a divalent group that has substantially the same structure as the C₂-C₆₀ alkynyl group.

As used herein, the term “C₁-C₆₀ alkoxy group” refers to a monovalent group that has the formula of -OA₁₀₁ (wherein, A₁₀₁ is a C₁-C₆₀ alkyl group), and non-limiting examples thereof include a methoxy group, an ethoxy group, an isopropyloxy group, and/or the like.

As used herein, the term “C₃-C₁₀ cycloalkyl group” refers to a monovalent saturated hydrocarbon cyclic group that has 3 carbon atoms to 10 carbon atoms, and non-limiting examples thereof include a cyclopropyl group, a cyclobutyl group, a cyclopentyl group, a cyclohexyl group, a cycloheptyl group, a cyclooctyl group, an adamantanyl (i.e., adamantyl) group, a norbornanyl (i.e., norbornyl) group (or, a bicyclo[2.2.1]heptyl group), a bicyclo[1.1.1]pentyl group, a bicyclo[2.1.1]hexyl group, a bicyclo[2.2.2]octyl group, and/or the like. As used herein, the term “C₃-C₁₀ cycloalkylene group” refers to a divalent group that has substantially the same structure as the C₃-C₁₀ cycloalkyl group.

As used herein, the term “C₁-C₁₀ heterocycloalkyl group” refers to a monovalent cyclic group that has 1 carbon atom to 10 carbon atoms and further includes at least one heteroatom as a ring-forming atom in addition to the carbon atom, and non-limiting examples thereof include a 1,2,3,4-oxatriazolidinyl group, a tetrahydrofuranyl group, a tetrahydrothiophenyl group, and/or the like. As used herein, the term “C₁-C₁₀ heterocycloalkylene group” refers to a divalent group that has substantially the same structure as the C₁-C₁₀ heterocycloalkyl group.

As used herein, the term “C₃-C₁₀ cycloalkenyl group” refers to a monovalent cyclic group that has 3 carbon atoms to 10 carbon atoms and at least one carbon-carbon double bond in the ring, but has no aromaticity, and non-limiting examples thereof include a cyclopentenyl group, a cyclohexenyl group, a cycloheptenyl group, and/or the like. As used herein, the term “C₃-C₁₀ cycloalkenylene group” refers to a divalent group that has substantially the same structure as the C₃-C₁₀ cycloalkenyl group.

As used herein, the term “C₁-C₁₀ heterocycloalkenyl group” is a monovalent cyclic group that has 1 carbon atom to 10 carbon atoms, which further includes at least one heteroatom as a ring-forming atom in addition to carbon atoms, and has at least one double bond within the ring. Non-limiting examples of the C₁-C₁₀ heterocycloalkenyl group include a 4,5-dihydro-1,2,3,4-oxatriazolyl group, a 2,3-dihydrofuranyl group, a 2,3-dihydrothiophenyl group, and/or the like. As used herein, the term “C₁-C₁₀ heterocycloalkenylene group” refers to a divalent group that has the same structure as the C₁-C₁₀ heterocycloalkenyl group.

As used herein, the term “C₆-C₆₀ aryl group” refers to a monovalent group that has a carbocyclic aromatic system having 6 carbon atoms to 60 carbon atoms, and the term “C₆-C₆₀ arylene group” refers to a divalent group that has a carbocyclic aromatic system having 6 carbon atoms to 60 carbon atoms. Non-limiting examples of the C₆-C₆₀ aryl group include a phenyl group, a pentalenyl group, a naphthyl group, an azulenyl group, an indacenyl group, an acenaphthyl group, a phenalenyl group, a phenanthrenyl group, anthracenyl group, a fluoranthenyl group, a triphenylenyl group, a pyrenyl group, a chrysenyl group, a perylenyl group, a pentaphenyl group, a heptalenyl group, a naphthacenyl group, a picenyl group, a hexacenyl group, a pentacenyl group, a rubicenyl group, a coronenyl group, an ovalenyl group, and/or the like. When the C₆-C₆₀ aryl group and C₆-C₆₀ arylene group each include two or more rings, the two or more rings may be condensed with each other.

As used herein, the term “C₁-C₆₀ heteroaryl group” refers to a monovalent group which, in addition to carbon atoms, further includes at least one heteroatom as a ring-forming atom and has a heterocyclic aromatic system that has 1 carbon atom to 60 carbon atoms, and the term “C₁-C₆₀ heteroarylene group” refers to a divalent group which, in addition to carbon atoms, further includes at least one heteroatom as a ring-forming atom and has a heterocyclic aromatic system that has 1 carbon atom to 60 carbon atoms. Non-limiting examples of the C₁-C₆₀ heteroaryl group include a pyridinyl group, a pyrimidinyl group, a pyrazinyl group, a pyridazinyl group, a triazinyl group, a quinolinyl group, a benzoquinolinyl group, an isoquinolinyl group, a benzoisoquinolinyl group, a quinoxalinyl group, a benzoquinoxalinyl group, a quinazolinyl group, a benzoquinazolinyl group, a cinnolinyl group, a phenanthrolinyl group, a phthalazinyl group, a naphthyridinyl group, and/or the like. When the C₁-C₆₀ heteroaryl group and C₁-C₆₀ heteroarylene group each include two or more rings, the two or more rings may be condensed with each other.

As used herein, the term “monovalent non-aromatic condensed polycyclic group” refers to a monovalent group (for example, that has 8 carbon atoms to 60 carbon atoms) in which two or more rings are condensed with each other, includes only carbon as a ring-forming atom, and the entire molecular structure has non-aromaticity when considered as a whole. Non-limiting examples of the monovalent non-aromatic condensed polycyclic group include an indenyl group, a fluorenyl group, a spiro-bifluorenyl group, a benzofluorenyl group, an indenophenanthrenyl group, an indenoanthracenyl group, and/or the like. As used herein, the term “divalent non-aromatic condensed polycyclic group” refers to a divalent group that has substantially the same structure as the monovalent non-aromatic condensed polycyclic group.

As used herein, the term “monovalent non-aromatic condensed heteropolycyclic group” refers to a monovalent group (for example, that has 1 carbon atom to 60 carbon atoms) in which two or more rings are condensed with each other, which further includes at least one heteroatom as a ring-forming atom in addition to a carbon atom, and in which the entire molecular structure has non-aromaticity when considered as a whole. Non-limiting examples of the non-aromatic condensed heteropolycyclic group include a pyrrolyl group, a thiophenyl group, a furanyl group, an indolyl group, a benzoindolyl group, a naphthoindolyl group, an isoindolyl group, a benzoisoindolyl group, a naphthoisoindolyl group, a benzosilolyl group, a benzothiophenyl group, a benzofuranyl group, a carbazolyl group, a dibenzosilolyl group, a dibenzothiophenyl group, a dibenzofuranyl group, an azacarbazolyl group, an azafluorenyl group, an azadibenzosilolyl group, an azadibenzothiophenyl group, an azadibenzofuranyl group, a pyrazolyl group, an imidazolyl group, a triazolyl group, a tetrazolyl group, an oxazolyl group, an isoxazolyl group, a thiazolyl group, an isothiazolyl group, an oxadiazolyl group, a thiadiazolyl group, a benzopyrazolyl group, a benzimidazolyl group, a benzoxazolyl group, a benzothiazolyl group, a benzoxadiazolyl group, a benzothiadiazolyl group, an imidazopyridinyl group, an imidazopyrimidinyl group, an imidazotriazinyl group, an imidazopyrazinyl group, an imidazopyridazinyl group, an indenocarbazolyl group, an indolocarbazolyl group, a benzofurocarbazolyl group, a benzothienocarbazolyl group, a benzosilolocarbazolyl group, a benzoindolocarbazolyl group, a benzocarbazolyl group, a benzonaphthofuranyl group, a benzonaphthothiophenyl group, a benzonaphthosilolyl group, a benzofurodibenzofuranyl group, a benzofurodibenzothiophenyl group, a benzothienodibenzothiophenyl group, and/or the like. As used herein, the term “divalent non-aromatic condensed heteropolycyclic group” refers to a divalent group that has substantially the same structure as the monovalent non-aromatic condensed heteropolycyclic group.

As used herein, the term “C₆-C₆₀ aryloxy group” refers to -OA₁₀₂ (wherein, A₁₀₂ is a C₆-C₆₀ aryl group), and the term “C₆-C₆₀ arylthio group” refers to -SA₁₀₃ (wherein, A₁₀₃ is a C₆-C₆₀ aryl group).

As used herein, the term “C₇-C₆₀ arylalkyl group” refers to -A₁₀₄A₁₀₅ (wherein, A₁₀₄ is a C₁-C₅₄ alkylene group and A₁₀₅ is a C₆-C₅₉ aryl group), and as used herein, the term “C₂-C₆₀ heteroarylalkyl group” refers to -A₁₀₆A₁₀₇ (wherein, A₁₀₆ is a C₁-C₅₉ alkylene group and A₁₀₇ is a C₁-C₅₉ heteroaryl group).

As used herein, “R₁₀ₐ” may be, deuterium (-D), —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, which is substituted or unsubstituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁), —S(═O)₂(Q₁), —P(═O)(Q₁)(Q₁₂), or any combination thereof;
a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, which is substituted or unsubstituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂).

As used herein, Q₁ to Q₃, Q₁₁ to Q₁₃, Q₂₁ to Q₂₃, and Q₃₁ to Q₃₃ may each independently be: hydrogen; deuterium; —F; —C₁; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, which is substituted or unsubstituted with deuterium, —F, a cyano group, a C₁-C₆₀ alkyl group, a C₁-C₆₀ alkoxy group, a phenyl group, a biphenyl group, or any combination thereof; a C₇-C₆₀ arylalkyl group; or a C₂-C₆₀ heteroarylalkyl group.

As used herein, the term “heteroatom” refers to any atom other than a carbon atom or a hydrogen atom. Non-limiting examples of the heteroatom include O, S, N, P, Si, B, Ge, Se, or any combination thereof.

As used herein, the term “transition metal” include hafnium (Hf), tantalum (Ta), tungsten (W), rhenium (Re), osmium (Os), iridium (Ir), platinum (Pt), and gold (Au), and/or the like.

As used herein, the term “Ph” refers to a phenyl group, the term “Me” refers to a methyl group, the term “Et” refers to an ethyl group, the term “tert-Bu” or “Bu^{t}” refers to a tert-butyl group, and the term “OMe” refers to a methoxy group.

As used herein, the term “biphenyl group” refers to “phenyl group substituted with a phenyl group.” The “biphenyl group” belongs to a “substituted phenyl group” whose substituent is a “C₆-C₆₀ aryl group.”

As used herein, the term “terphenyl group” refers to “phenyl group substituted with a biphenyl group.” The “terphenyl group” belongs to a “substituted phenyl group” in which the substituent is a “C₆-C₆₀ aryl group substituted with a C₆-C₆₀ aryl group.”

As used herein, * and *′, unless otherwise defined, refers to a binding site to an adjacent atom in a corresponding formula or moiety.

As used herein, the terms “x-axis,” “y-axis,” and “z-axis” are not limited to, however may be interpreted in a broad sense to include three axes in a Cartesian coordinate system. For example, the x-axis, y-axis, and z-axis may be orthogonal to one another, however, may also refer to different directions that are not orthogonal to each other.

Hereinafter, the quantum dot and the light-emitting element according to one or more embodiments will be described in more detail with reference to synthetic examples and examples. In the following synthesis examples, in the expression “B was used instead of A,” the molar equivalents of A and B may be substantially the same.

### EXAMPLE

### Example 1: Preparation of CuInGaS₂/ZnS Quantum Dot TMSS+N₂

### Synthesis of CuInGaS₂ Core

0.005 mmol of CuBr, 0.02 mmol of InBr₃, and 0.0325 mmol of GaBr₃ were placed in a three-neck flask and mixed with 10 mL of 1-octadecene and 5 mL of oleylamine, and then degassed and stirred at 120° C. for 60 minutes to remove oxygen and moisture inside, thereby forming a first-1 composition. Thereafter, 50 mmol of 1-dodecanethiol and 10 mmol of bis(trimethylsilyl)sulfide (TMSS) were added to the first-1 composition in a nitrogen atmosphere to form a first-2 composition, and then nitrogen was passed through the inside of the reactor (e.g., the flask) and discharged to the outside. The temperature was raised to 280° C. and reacted for 30 minutes, then reacted at 240° C. for 30 minutes, cooled to 200° C., and 9 mmol of trioctylphosphine (TOP) was injected and reacted for a certain period of time to synthesize the core.

### Synthesis of ZnS Shell

15 mL of trioctylamine (TOA) was degassed in a three-neck flask for 60 minutes, followed by an injection of CuInGaS₂ core, 1.92 mmol of zinc oleate, 1.92 mmol of sulfur-containing trioctylphosphate (TOP-S), and 167 μl of HF in water (48 wt %). After an additional vacuum treatment of 30 minutes to remove unnecessary solvents and gases included in the precursor and core, a N₂ atmosphere was formed and a shell was synthesized by reacting while maintaining it at 280° C. for 20 minutes.

### Example 2: Preparation of CuInGaS₂/ZnS Quantum Dot (TMSS+N₂+DC(Double Container)

### Synthesis of CuInGaS₂ Core

In a first three-neck flask, 0.02 mmol of InBr₃, 0.0325 mmol of GaBr₃, 8 mL of 1-octadecene (ODE), and 4 mL of oleylamine were added and subjected to degassing and stirring at 120° C. for 60 minutes to remove internal oxygen and moisture. After that, the atmosphere was maintained in a nitrogen atmosphere. In a second three-neck flask, 0.005 mmol of CuBr, 2 mL of ODE, and 1 mL of oleylamine were added, followed by degassing and stirring at 120° C. for 60 minutes. Subsequently, the atmosphere was changed to a nitrogen atmosphere, and 10 mmol of 1-dodecanethiol (DDT) was added, reacting at 120° C. for 60 minutes before being injected into the first flask. Thereafter, 50 mmol of 1-dodecanethiol and 10 mmol of TMSS were added to the reaction solution in a nitrogen atmosphere, and then nitrogen was allowed to pass through the inside of the reactor (i.e., the first flask) and discharged to the outside. The temperature of the reaction solution was raised to 280° C. and reacted for 30 minutes, then reacted at 240° C. for 30 minutes, and then cooled to 200° C., and 9 mmol of TOP was injected and reacted for a certain period of time to synthesize the core.

### Synthesis of ZnS Shell

The ZnS shell was prepared in substantially the same manner as Example 1.

### Example 3: Preparation of CuInGaS₂/ZnS Quantum Dot TMSS+N₂

### Synthesis of CuInGaS₂ Core

The core was prepared in substantially the same manner as Example 1, except for the addition of bis(trimethylsilyl)sulfide and the reaction at 280° C. for 0 minutes.

### Synthesis of ZnS Shell

The ZnS shell was prepared in substantially the same manner as Example 1.

### Example 4: Preparation of CuInGaS₂/ZnS Quantum Dot TMSS+N₂

### Synthesis of CuInGaS₂ Core

The core was prepared in substantially the same manner as Example 1, except for the addition of bis(trimethylsilyl)sulfide and the reaction at 280° C. for 10 minutes.

### Synthesis of ZnS Shell

The ZnS shell was prepared in substantially the same manner as Example 1.

### Example 5: Preparation of CuInGaS₂/ZnS Quantum Dot TMSS+N₂

### Synthesis of CuInGaS₂ Core

The core was prepared in substantially the same manner as Example 1, except for the addition of bis(trimethylsilyl)sulfide and the reaction at 280° C. for 20 minutes.

### Synthesis of ZnS Shell

The ZnS shell was prepared in substantially the same manner as Example 1.

### Comparative Example 1: Preparation of CuInGaS₂/ZnS Quantum Dot (S-OLA)

### Synthesis of CuInGaS₂ Core

0.005 mmol of CuBr, 0.02 mmol of InBr₃, and 0.0325 mmol of GaBr₃ were placed in a three-neck flask and mixed with 10 mL of 1-octadecene and 5 mL of oleylamine, and then degassed and stirred at 120° C. for 60 minutes to remove oxygen and moisture inside, thereby forming a reaction solution. Thereafter, 50 mmol of 1-dodecanethiol and 10 mmol of sulfur-containing oleylamine (S-OLA) were added to the reaction solution in a nitrogen atmosphere, the temperature was raised to 280° C., and reacted for 10 minutes, then reacted at 240° C. for 2 hours, and then cooled to 200° C., and 9 mmol of trioctylphosphine (TOP) was injected and reacted for a certain period of time to synthesize the core.

### Synthesis of ZnS Shell

The ZnS shell was prepared in substantially the same manner as Example 1.

### Comparative Example 2: Preparation of CuInGaS₂/ZnS Quantum Dot (TMSS Only, 280° C., 10-Minute Reaction)

### Synthesis of CuInGaS₂ Core

0.005 mmol of CuBr, 0.02 mmol of InBr₃, and 0.0325 mmol of GaBr₃ were placed in a three-neck flask and mixed with 10 mL of 1-octadecene and 5 mL of oleylamine, and then degassed and stirred at 120° C. for 60 minutes to remove oxygen and moisture inside, thereby forming a reaction solution. Thereafter, 50 mmol of 1-dodecanethiol and 10 mmol of TMSS were added to the reaction solution in a nitrogen atmosphere, the temperature was raised to 280° C., and reacted for 10 minutes, then reacted at 240° C. for 30 minutes, and then cooled to 200° C., and 9 mmol of trioctylphosphine (TOP) was injected and reacted for a certain period of time to synthesize the core.

### Synthesis of ZnS Shell

The ZnS shell was prepared in substantially the same manner as Example 1.

### Comparative Example 3: Preparation of CuInGaS₂/ZnS Quantum Dot TMSS Only, 280° C., 20-Minute Reaction

### Synthesis of CuInGaS₂ Core

The core was prepared in substantially the same manner as Comparative Example 2, except for the addition of bis(trimethylsilyl)sulfide and the reaction at 280° C. for 20 minutes.

### Synthesis of ZnS Shell

The ZnS shell was prepared in substantially the same manner as Example 1.

### Comparative Example 4: Preparation of CuInGaS₂/ZnS Quantum Dot TMSS Only, 280° C., 0-Minute Reaction

### Synthesis of CuInGaS₂ Core

The core was prepared in substantially the same manner as Comparative Example 2, except for the addition of bis(trimethylsilyl)sulfide and the reaction at 280° C. for 0 minutes.

### Synthesis of ZnS Shell

The ZnS shell was prepared in substantially the same manner as Example 1.

### Evaluation Example 1: ICP Characteristics Analysis

An atomic ratio of sulfur (S) to silicon (Si) in the quantum dot core according to each of Example 1, Comparative Example 1, and Comparative Example 2 was measured using Inductively Coupled Plasma-Optical Emission spectroscopy (ICP-OES) with a Perkin-Elme OPTIMA-4300DV, and the results are shown in Table 1.

In this study, the following Example 1-1, Example 1-2, and Example 1-3 show the results of quantum dot core that were subjected to repeated experiments of Example 1, respectively, and the following Comparative Example 2-1, Comparative Example 2-2, and Comparative Example 2-3 show the results of quantum dot core that were subjected to repeated experiments of Comparative Example 2, respectively.

TABLE 1

/S

| Core | Cu | Ga | In | S | Si |
|---|---|---|---|---|---|
| Example 1-1 | 0.221 | 0.628 | 0.283 | 1.000 | 0.010 |
| Example 1-2 | 0.229 | 0.765 | 0.426 | 1.000 | 0.005 |
| Example 1-3 | 0.230 | 0.691 | 0.178 | 1.000 | 0.017 |
| Comparative | 0.264 | 0.530 | 0.275 | 1.000 | 0.000 |
| Example 1 | | | | | |
| Comparative | 0.205 | 0.562 | 0.280 | 1.000 | 0.055 |
| Example 2-1 | | | | | |
| Comparative | 0.283 | 0.619 | 0.212 | 1.000 | 0.072 |
| Example 2-2 | | | | | |
| Comparative | 0.253 | 0.795 | 0.225 | 1.000 | 0.068 |
| Example 2-3 | | | | | |

According to Table 1, the quantum dot according to Example 1-1 to Example 1-3 showed a decrease in residual TMS upon treatment with an inert gas, confirming that the Si content (e.g., amount) in the quantum dot core was within the numerical range of the application.

### Evaluation Example 2: Confirmation of Optical Characteristics

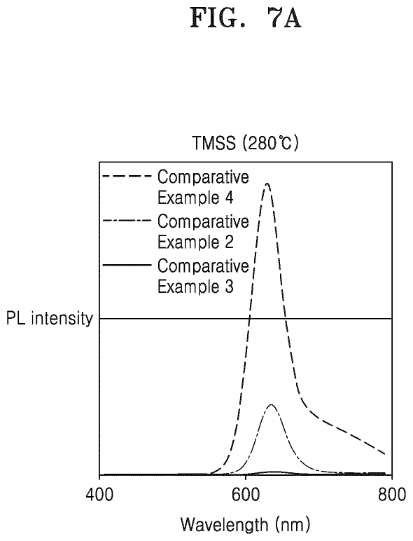

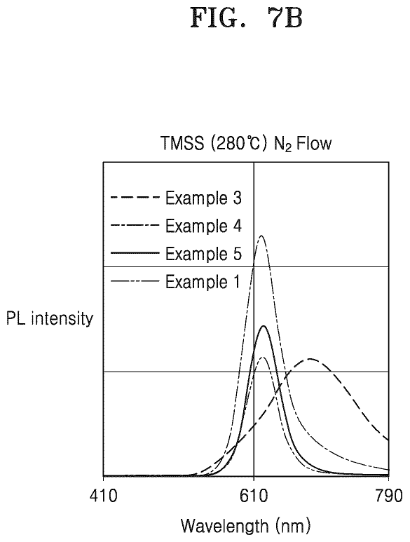

Whether the optical properties of the quantum dot core according to Example 1, Example 3, Example 4, Example 5, Comparative Example 2, Comparative Example 3, and Comparative Example 4 were each maintained over the reaction time was confirmed by examining the PL spectrum of the quantum dot core using a PL spectrometer, and the results are shown in FIG. 7A and FIG. 7B.

Referring to FIG. 7A and FIG. 7B, as can be seen in the PL spectra of Comparative Example 2, Comparative Example 3, and Comparative Example 4, it was confirmed that the optical properties of the quantum dot core cannot be maintained when the reaction time is longer than 20 minutes without treating the inert gas.

In contrast, the quantum dot core according to Example 1 was confirmed to maintain its optical properties even with a reaction time of 30 minutes.

### Evaluation Example 3: Confirmation of Quantum Dot Characteristics

450 nm excitation was performed using Shimadzu UV-1800, the photoluminescence spectrum of the quantum dot of each of Examples 1 and 2 and Comparative Examples 1 and 2, with an absorption set at 0.1, was recorded to measure the peak wavelength and FWHM in the photoluminescence spectrum, and the quantum yield of the quantum dot of each of Examples 1 and 2 and Comparative Examples 1 and 2 was measured using Horiba FluoroMax-4, and the results are shown in Table 2. In this study, the QY retention rate was confirmed by examining the change in QY after exposure to 200 nit light at 450 nm for about 2 hours.

TABLE 2

| | Peak | | | | | |
|---|---|---|---|---|---|---|
| | emission | | | | | |
| | wavelength | | | | | QY |
| | (nm) in PL | FWHM | | QY | FWHM | Retention |
| Core | spectrum | (nm) | Shell | (%) | (nm) | Rate |
| Example 1 | 632 | 44.8 | ZnS | 94 | 46.2 | 91 |
| Example 2 | 632 | 42.7 | | 96 | 43.9 | 90 |
| Comparative | 630 | 55.1 | | 91 | 59.0 | 65 |
| Example 1 | | | | | | |
| Comparative | 631 | 48.2 | | — | 50.7 | 75 |
| Example 2 | | | | | | |

According to Table 2, it may be confirmed that the quantum dots of Examples 1 and 2 each have superior quantum yield, narrow FWHM, and superior QY retention rate compared to the quantum dot of Comparative Examples 1 and 2.

The quantum dot and the method of preparing the same according to the disclosure provide quantum dots with excellent or suitable quantum yield (QY), a narrow full width at half maximum (FWHM), and excellent or suitable quantum yield retention rate, while maintaining stability through the treatment of precursors and inert gases in the method of preparing the quantum dot, and thus by utilizing these quantum dots, high-quality optical members and electronic apparatuses may be provided. For example, this is achieved while maintaining stability through the treatment of precursors and inert gases in the method of preparing the quantum dot. The results from Examples 1 and 2 demonstrate that the quantum dots exhibit superior optical properties compared to those in Comparative Examples 1 and 2. Specifically, the quantum dots in Examples 1 and 2 show higher quantum yields, narrower FWHM, and better QY retention rates, indicating their potential for high-performance applications.

In Example 1, the CuInGaS₂ core was synthesized by mixing CuBr, InBr₃, and GaBr₃ with 1-octadecene and oleylamine, followed by degassing and stirring at 120° C. Bis(trimethylsilyl)sulfide (TMSS) and 1-dodecanethiol were then added, and the mixture was reacted at elevated temperatures to form the core. The ZnS shell was synthesized by reacting the core with zinc oleate and sulfur-containing trioctylphosphate (TOP-S) in a nitrogen atmosphere.

Example 2 followed a similar procedure but utilized a double container method, where the precursors were initially treated in separate flasks before being combined. This method also involved the use of TMSS and 1-dodecanethiol, with reactions carried out at elevated temperatures to form the core and shell.

Comparative Examples 1 and 2 used different sulfur sources and reaction conditions, highlighting the advantages of the methods described in Examples 1 and 2. The comparative examples demonstrated lower quantum yields and wider FWHM, underscoring the superior performance of the quantum dots prepared using the disclosed methods.

By utilizing these quantum dots, high-quality optical members and electronic apparatuses may be provided. The enhanced properties of the quantum dots, such as improved photoluminescence and stability, make them suitable for various applications, including display technologies, lighting, and other optoelectronic devices. The examples provided herein support the claims of the invention, demonstrating the effectiveness of the disclosed methods in producing quantum dots with desirable characteristics. This ensures that the invention can be effectively utilized in practical applications.

In the present disclosure, when dot, dots, or dot particles are spherical, “diameter” indicates a particle diameter or an average particle diameter, and when the particles are non-spherical, the “diameter” indicates a major axis length or an average major axis length. The diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter is referred to as D50. D50 refers to the average diameter of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

In the context of the present application and unless otherwise defined, the terms “use,” “using,” and “used” may be considered synonymous with the terms “utilize,” “utilizing,” and “utilized,” respectively.

Throughout the present disclosure, when a component such as a layer, a film, a region, or a plate is mentioned to be placed “on” another component, it will be understood that it may be directly on another component or that another component may be interposed therebetween. In some embodiments, “directly on” may refer to that there are no additional layers, films, regions, plates, etc., between a layer, a film, a region, a plate, etc. and the other part. For example, “directly on” may refer to two layers or two members are disposed without utilizing an additional member such as an adhesive member therebetween.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

The light-emitting element, the light-emitting apparatus, the display device, the electronic apparatus, the electronic device, a device of manufacturing the same, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the disclosure has been described with reference to one or more embodiments, these are only for example, and those skilled in the art pertaining to the disclosure will understand that one or more suitable modifications and equivalent one or more embodiments are possible therefrom. Therefore, the technical scope of protection of the disclosure should be determined by the technical idea of the appended claims and equivalents thereof.

It should be understood that embodiments described herein should be considered in a descriptive sense only and not for purposes of limitation. Descriptions of features or aspects within each embodiment should typically be considered as available for other similar features or aspects in one or more embodiments. While one or more embodiments have been described with reference to the drawings, it will be understood by those of ordinary skill in the art that one or more suitable changes in form and details may be made therein without departing from the spirit and scope as defined by the appended claims and equivalents thereof.

What is claimed is:

1. A quantum dot comprising:
a core comprising copper (Cu), A¹, and B¹; and
a first shell covering the core and comprising A³ and B²,
wherein an atomic ratio of silicon (Si) to B¹ comprised in the core is about 0.001 to about 0.05,
wherein A¹ is a Group III element,
wherein A³ is a Group II element or Group III element, and
wherein B¹ and B² are each independently a Group VI element.

2. The quantum dot of claim 1,
wherein the atomic ratio of Si to B¹ in the core is about 0.003 to about 0.03.

3. The quantum dot of claim 1,
wherein the core further comprises A², and
A² is a Group III element.

4. The quantum dot of claim 1,
wherein the Group III element is aluminum (Al), gallium (Ga), indium (In), thallium (Tl), nihonium (Nh), or any combination thereof.

5. The quantum dot of claim 1,
wherein the Group II element is magnesium (Mg), calcium (Ca), zinc (Zn), cadmium (Cd), mercury (Hg), or any combination thereof.

6. The quantum dot of claim 1,
wherein the Group VI element is oxygen (O), sulfur (S), selenium (Se), tellurium (Te), or any combination thereof.

7. The quantum dot of claim 1,
wherein the core comprises copper (Cu), indium (In), gallium (Ga), and sulfur (S).

8. The quantum dot of claim 1,
wherein the first shell comprises a Group II-VI semiconductor compound, and
the Group II-VI semiconductor compound is CdS, CdSe, CdTe, ZnS, ZnSe, ZnTe, ZnO, ZnMgO, HgS, HgSe, HgTe, MgSe, MgS, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, CdZnSeS, CdZnSeTe, CdZnSTe, CdHgSeS, CdHgSeTe, CdHgSTe, HgZnSeS, HgZnSeTe, HgZnSTe, or any combination thereof.

9. The quantum dot of claim 1,
wherein the first shell comprises zinc (Zn) and sulfur (S).

10. The quantum dot of claim 1,
wherein the quantum dot is to emit light with a peak emission wavelength of about 600 nm to about 650 nm.

11. The quantum dot of claim 1,
wherein a quantum yield (QY) of the quantum dot is about 90% to about 95%.

12. The quantum dot of claim 1,
wherein a full width at half maximum (FWHM) of an emission spectrum of the quantum dot is 50 nm or less.

13. An optical member comprising the quantum dot of claim 1.

14. An electronic apparatus comprising a quantum dot, wherein
the quantum dot comprises:
a core comprising copper (Cu), A¹, and B¹; and
a first shell covering the core and comprising A³ and B²,
wherein an atomic ratio of silicon (Si) to B¹ comprised in the core is about 0.001 to about 0.05,
wherein A¹ is a Group III element,
wherein A³ is a Group II element or Group III element, and
wherein B¹ and B² are each independently a Group VI element.

15. The electronic apparatus of claim 14, comprising:
a light source; and
a color conversion member arranged in a path of light emitted from the light source,
wherein the color conversion member comprises the quantum dot.

16. The electronic apparatus of claim 14, comprising
a light-emitting element comprising:
a first electrode;
a second electrode opposite the first electrode; and
an emission layer between the first electrode and the second electrode,
wherein the light-emitting element comprises the quantum dot.

17. A method, comprising:
preparing a first-1 composition comprising a copper (Cu)-containing precursor and an A¹-containing precursor;
preparing a core comprising copper (Cu), A¹, and B¹ by utilizing a first-2 composition comprising the first-1 composition and a B¹-containing precursor; and
preparing a first shell covering the core and comprising A³ and B² by utilizing a second composition comprising the core, an A³-containing precursor, and a B²-containing precursor,
wherein an atomic ratio of silicon (Si) to B¹ comprised in the core is about 0.001 to about 0.05,
wherein the preparing of the core comprising copper (Cu), A¹, and B¹ by utilizing the first-2 composition further comprises treating the first-2 composition with an inert gas,
wherein A¹ is a Group III element,
wherein A³ is a Group II element,
wherein B¹ and B² are each independently a Group VI element, and
wherein the method is a method of preparing a quantum dot.

18. The method of claim 17,
wherein the preparing of the first-1 composition comprising the copper (Cu)-containing precursor and the A¹-containing precursor further comprises:
preparing a first-1-1 composition comprising the copper (Cu)-containing precursor; and
preparing a first-1-2 composition comprising the A¹-containing precursor.

19. The method of claim 17,
wherein the inert gas is nitrogen (N₂).

20. The method of claim 17,
wherein the first-1 composition further comprises an A²-containing precursor.
